(19) United States
(12) Patent Application Publication
(10) Pub. No.: US 2016/0253652 A1
(43) Pub. Date: Sep. 1, 2016

(54) ELECTRONIC DEVICE PROVIDING ELECTRONIC PAYMENT FUNCTION AND OPERATION METHOD THEREOF

(71) Applicant: Samsung Electronics Co., Ltd., Suwon-si (KR)

(72) Inventors: Seong-Min JE, Suwon-si (KR); Byoungtack ROH, Suwon-si (KR); Suyoung PARK, Uiwang-si (KR); Seon Sook LEE, Gumi-si (KR)

(21) Appl. No.: 15/056,113

(22) Filed: Feb. 29, 2016

Related U.S. Application Data
(60) Provisional application No. 62/126,121, filed on Feb. 27, 2015.

(30) Foreign Application Priority Data
Feb. 4, 2016 (KR) 10-2016-0014389

(51) Int. Cl. G06Q 20/32; G06Q 20/34

(52) U.S. Cl. CPC G06Q 20/325; G06Q 20/34

(57) ABSTRACT

An electronic device, an electronic payment function, and an operation method are provided. The electronic device includes a display, a communication interface, and a processor, wherein the processor is configured to transmit a user identifier to a server through the communication interface, receive information of at least one card associated with the user identifier from the server through the communication interface and display the received information on a display, select one piece of card information from the displayed information of the at least one card, and request, through the communication interface, the server to issue a token for payment, using at least a part of the selected card information.

### CROSS-REFERENCE TO RELATED APPLICATION(S)

This application claims the benefit under 35 U.S.C. §119(e) to a U.S. provisional patent application filed on Feb. 27, 2015 in the U.S. Patent and Trademark Office and assigned Ser. No. 62/126,121, and under 35 U.S.C. §119(a) of a Korean patent application filed on Feb. 4, 2016 in the Korean Intellectual Property Office and assigned Serial number 10-2016-0014389, the entire disclosure of each of which is hereby incorporated by reference.

### TECHNICAL FIELD

The present disclosure relates to an electronic device and an operation method thereof. More particularly, the present disclosure relates to an electronic device for providing an electronic payment function, and an operation method thereof.

### BACKGROUND

With the development of mobile communication technologies, an electronic device can perform various data communication functions as well as voice call functions. The electronic device, for example, a mobile device or a user device may provide various services through various applications. The electronic device may provide network-based communication services, such as multimedia services, for example, a music service, a dynamic image service, a digital broadcasting service, a call, wireless Internet, a short message service (SMS), a multimedia messaging service (MIMS), and the like. Further, the electronic device has evolved from a simple communication medium to a device having various functions, such as a communication function, a circulation function, an Internet function, or a payment function, and may be used in the whole of the social, cultural, financial, or circulation industrial field.

The electronic device may provide, for example, a mobile payment scheme through the electronic device by the payment function. The electronic device may enable, for example, payment using the electronic device from a payment scheme using cash or a plastic card. The electronic device may provide, for example, a function of paying for, using the electronic device, a service or purchase of goods through on-line or off-line (in the case of proceeding payment after buying a product or food in an actual shop or restaurant) using a mobile payment service. Further, the electronic device may have, for example, a communication function for receiving or transmitting payment information.

When registering a new card in the electronic device as described above, a user should input all card information. Such an input of all card information by the user may cause inconvenience to the user.

Therefore, a need exists for an electronic device and an operation method thereof, which can improve the convenience in registering a new card.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device and an operation method thereof, which can improve the convenience in registering a new card.

In accordance with an aspect of the present disclosure, a method of operating an electronic device is provided. The method includes transmitting a user identifier to a server, receiving information of at least one card associated with the user identifier from the server and displaying the received information on a display, selecting one piece of card information from the displayed information of the at least one card, and requesting the server to issue a token for payment, using at least a part of the selected card information.

In accordance with another aspect of the present disclosure, a method of operating a plurality of electronic devices is provided. The method includes performing management of or establishing a wired or wireless connection through a user identifier by the plurality of electronic devices, transmitting the user identifier to a server by a first electronic device among the plurality of electronic devices, receiving information of at least one card associated with the user identifier from the server by a second electronic device among the plurality of electronic devices, and requesting, by the second electronic device, the server to issue a token for payment, using at least a part of the received information of the at least one card.

In accordance with another aspect of the present disclosure, an electronic device is provided. The electronic device includes a display, a communication interface, and a processor, wherein the processor is configured to transmit a user identifier to a server through the communication interface, receive information of at least one card associated with the user identifier through the communication interface and display the received information on a display, select one piece of card information from the displayed information of the at least one card, and request, through the communication interface, the server to issue a token for payment, using at least a part of the selected card information.

Therefore, various embodiments may provide an electronic device and an operation method thereof, which can improve the convenience in registering a new card.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a network environment system according to various embodiments of the present disclosure;

FIG. 2 is a block diagram illustrating an electronic device according to various embodiments of the present disclosure;

FIG. 3 is a block diagram illustrating a programming module according to various embodiments of the present disclosure;

FIG. 4 is a block diagram illustrating a plurality of execution environments operated in an electronic device according to various embodiments of the present disclosure;

FIGS. 5A to 5C illustrate block diagrams of hardware structures of a trusted execution environment (TEE) according to various embodiments of the present disclosure;

FIG. 6 is a block diagram illustrating a payment system according to various embodiments of the present disclosure;

FIG. 7 is a block diagram illustrating a payment system for performing payment according to various embodiments of the present disclosure;

FIG. 8 is a block diagram illustrating a hardware structure of an electronic device according to various embodiments of the present disclosure;

FIG. 9 is a block diagram illustrating a program module to be executed in an execution environment of an electronic device according to various embodiments of the present disclosure;

FIG. 10 is a block diagram illustrating a payment system according to various embodiments of the present disclosure;

FIG. 11 is a block diagram illustrating a payment server according to various embodiments of the present disclosure;

FIG. 12 is a block diagram illustrating a method of generating a token cryptogram according to various embodiments of the present disclosure;

FIG. 13 is a signal flow diagram illustrating a communication method for payment between an electronic device and a point of sale (POS) device according to various embodiments of the present disclosure;

FIG. 14 is a block diagram illustrating a token payment flow in a payment system according to various embodiments of the present disclosure;

FIG. 15 is a block diagram illustrating a signal flow of an operation of a payment system according to various embodiments of the present disclosure;

FIGS. 16A to 16C illustrate screen configurations for registering a card associated with a user account in an electronic device according to various embodiments of the present disclosure;

FIG. 17 illustrates a screen configuration for transmitting card information in an electronic device according to various embodiments of the present disclosure;

FIGS. 18A to 18C illustrate screen configurations for registering a card associated with a user account in an electronic device according to various embodiments of the present disclosure;

FIG. 19 illustrates a signal flow diagram illustrating a token issuance operation in an electronic device according to various embodiments of the present disclosure;

FIG. 20 illustrates a signal flow diagram illustrating a process of registering a card relating to a user account in a payment system according to various embodiments of the present disclosure;

FIG. 21 is a flowchart illustrating a process of registering a card relating to a user account by an electronic device according to various embodiments of the present disclosure;

FIG. 22 is a flowchart illustrating a process of registering a card relating to a user account by a payment server according to various embodiments of the present disclosure;

FIG. 23 is a flowchart illustrating a process of registering a card relating to a user account by a token server according to various embodiments of the present disclosure;

FIGS. 24 to 26 are signal flow diagrams illustrating a process of registering a card in a payment system according to various embodiments of the present disclosure; and

FIGS. 27 and 28 are signal flow diagrams illustrating a process of registering a card relating to a user account in a payment system according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In an embodiment of the present disclosure, the expression “have”, “may have”, “include” or “may include” refers to existence of a corresponding feature (e.g., numerical value, function, operation, or components, such as elements), and does not exclude existence of additional features.

In an embodiment of the present disclosure, the expression “A or B,” “at least one of A or/and B,” or “one or more of A or/and B” may include all possible combinations of the items listed. For example, the expression “A or B,” “at least one of A and B,” or “at least one of A or B” refers to all of (1) including at least one A, (2) including at least one B, or (3) including all of at least one A and at least one B.

The expression “a first,” “a second,” “the first,” or “the second” used in various embodiments of the present disclosure may modify various components regardless of the order and/or the importance but does not limit the corresponding components. For example, a first electronic device and a second electronic device may indicate different user devices, regardless of order or importance thereof. For example, a first element may be interchangeably referred to as a second element, and similarly, a second element may be interchangeably referred to as a first element without departing from the scope of the present disclosure.

It should be understood that when an element (e.g., the first element) is referred to as being (operatively or communicatively) “connected” or “coupled” to another element (e.g., the second element), it may be directly connected or coupled directly to the other element. In such a situation, alternatively, any other element (e.g., a third element) may be interposed between them. In certain embodiments of the present disclosure, it may be understood that when an element (e.g., the first element) is referred to as being “directly connected,” or “directly coupled” to another element (e.g., the second element), there are no element (e.g., the third element) interposed between them (while there can be a connecting element, such as an adhesive or a connector between them).

The expression “configured to” used in embodiments of the present disclosure may be interchangeably used with, for example, “suitable for,” “having the capacity to,” “designed to,” “adapted to,” “made to,” or “capable of,” depending on the context. The term “configured to” may not necessarily imply “specifically designed to” in hardware. Alternatively, in some situations, the expression “device configured to” may mean that the device, together with other devices or components, “is able to.” For example, the phrase “processor adapted (or configured) to perform A, B, and C” may mean a dedicated processor (e.g., an embedded processor) only for performing the corresponding operations or a generic-purpose processor (e.g., a central processing unit (CPU) or an application processor (AP)) that can perform the corresponding operations by executing one or more software programs stored in a memory device.

Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in embodiments of the present disclosure. In some cases, even the term defined in embodiments of the present disclosure should not be interpreted to exclude embodiments of the present disclosure.

An electronic device according to various embodiments of the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a moving picture experts group phase 1 or phase 2 (MPEG-1 or MPEG-2) audio layer-3 (MP3) player, a mobile medical device, a camera, a wearable device, and the like. According to various embodiments of the present disclosure, the wearable device may include at least one of an accessory type (e.g., a watch, a ring, a bracelet, an anklet, a necklace, a glasses, a contact lens, or a head-mounted device (HMD)), a fabric or clothing integrated type (e.g., an electronic clothing), a body-mounted type (e.g., a skin pad, or tattoo), a bio-implantable type (e.g., an implantable circuit), and the like.

According to various embodiments of the present disclosure, the electronic device may be a home appliance. The home appliance may, for example, include at least one of a television, a digital versatile disc (DVD) player, an audio player, a refrigerator, an air conditioner, a cleaner, an oven, a microwave oven, a washing machine, an air purifier, a set-top box, a home automation control panel, a television (TV) box (e.g., HomeSync™ of Samsung, Apple TV™, or Google TV™), a game console (e.g., Xbox™, PlayStation™), an electronic dictionary, an electronic key, a camcorder, an electronic frame, and the like.

According to another embodiment of the present disclosure, the electronic device may include at least one of various medical devices (e.g., various portable medical measuring devices (e.g., a blood glucose measuring device, a heart rate measuring device, a blood pressure measuring device, a body temperature measuring device, and the like), a magnetic resonance angiography (MRA), a magnetic resonance imaging (MRI), a computed tomography (CT) machine, and an ultrasonic machine), a navigation device, a global navigation satellite system (GNSS) receiver, an event data recorder (EDR), a flight data recorder (FDR), a vehicle infotainment devices, an electronic devices for a ship (e.g., a navigation device for a ship, and a gyro-compass), avionics, security devices, an automotive head unit, a robot for home or industry, an automatic teller's machine (ATM) in banks, a point of sale (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, and the like).

According to various embodiments of the present disclosure, the electronic device may include at least one of a part of furniture or a building/structure, an electronic board, an electronic signature-receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to various embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

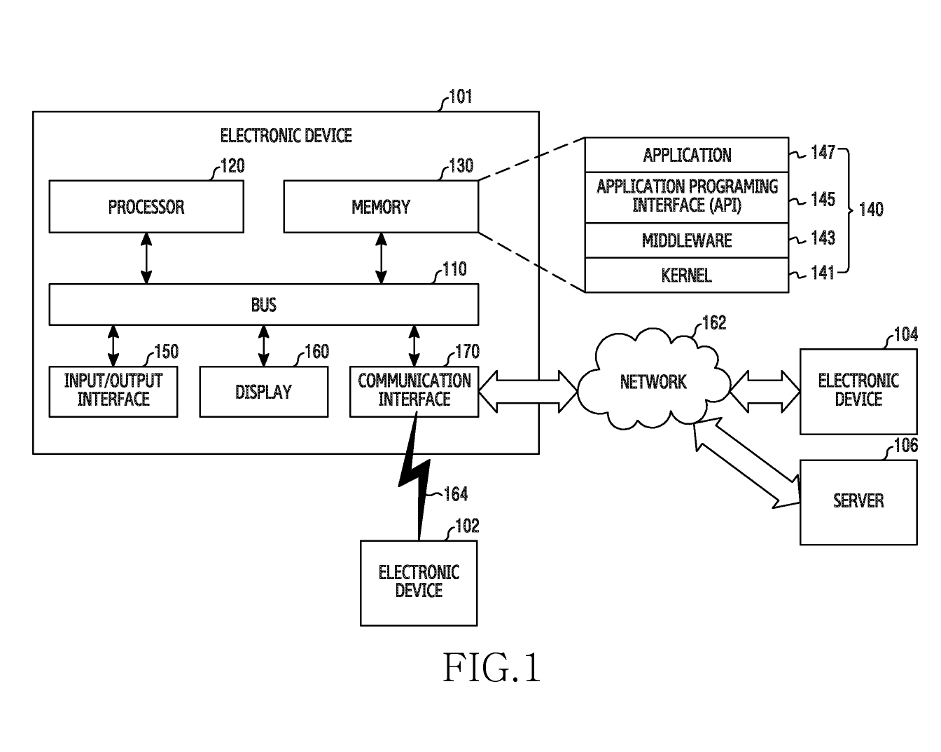

FIG. 1 is a block diagram illustrating a network environment according to various embodiments of the present disclosure.

Referring to FIG. 1, an electronic device 101, a first external electronic device 102, or a second external electronic device 104 or a server 106 may be connected to each other through a network 162 or a short range wireless communication 164. The electronic device 101 may include a bus 110, a processor 120, a memory 130, an input/output interface 150, a display 160, and a communication interface 170. In various embodiments of the present disclosure, the electronic device 101 may omit at least one of the above elements or may further include other elements.

The bus 110 may include, for example, a circuit for interconnecting the elements 110 to 170 and transferring communication (e.g., control messages and/or data) between the elements.

The processor 120 may include one or more of a CPU, an AP, or a communication processor (CP). The processor 120, for example, may carry out operations or data processing relating to control and/or communication of at least one other element of the electronic device 101.

The memory 130 may include a volatile memory and/or a non-volatile memory. The memory 130 may store, for example, instructions or data relevant to at least one other element of the electronic device 101. According to an embodiment of the present disclosure, the memory 130 may store software and/or a program 140. The program 140 may include, for example, a kernel 141, middleware 143, an application programming interface (API) 145, and/or application programs (or “applications”) 147. At least some of the kernel 141, the middleware 143, and the API 145 may be referred to as an operating system (OS).

The kernel 141 may control or manage system resources (e.g., the bus 110, the processor 120, or the memory 130) used for performing an operation or function implemented by the other programs (e.g., the middleware 143, the API 145, or the application programs 147). Furthermore, the kernel 141 may provide an interface through which the middleware 143, the API 145, or the application programs 147 may access the individual elements of the electronic device 101 to control or manage the system resources.

The middleware 143, for example, may function as an intermediary for allowing the API 145 or the application programs 147 to communicate with the kernel 141 to exchange data.

In addition, the middleware 143 may process one or more task requests received from the application programs 147 according to priorities thereof. For example, the middleware 143 may assign priorities for using the system resources (e.g., the bus 110, the processor 120, the memory 130, and the like) of the electronic device 101, to at least one of the application programs 147. For example, the middleware 143 may perform scheduling or loading balancing on the one or more task requests by processing the one or more task requests according to the priorities assigned thereto.

The API 145 is an interface through which the applications 147 control functions provided from the kernel 141 or the middleware 143, and may include, for example, at least one interface or function (e.g., an instruction) for file control, window control, image processing, or text control.

The input/output interface 150, for example, may function as an interface that may transfer instructions or data input from a user or another external device to the other element(s) of the electronic device 101. In addition, the input/output interface 150 may output, to the user or another external device, commands or data received from the element(s) other than the input/output interface 150 within the electronic device 101.

Examples of the display 160 may include a liquid crystal display (LCD), a light-emitting diode (LED) display, an organic LED (OLED) display, a microelectromechanical systems (MEMS) display, and an electronic paper display. The display 160, for example, may display various types of contents (e.g., a text, images, videos, icons, symbols, and the link) for the user. The display 160 may include a touch screen and receive, for example, a touch, gesture, proximity, or hovering input by using an electronic pen or the user's body part.

The communication interface 170, for example, may set communication between the electronic device 101 and an external device (e.g., the first external electronic device 102, the second external electronic device 104, or the server 106). For example, the communication interface 170 may be connected to a network 162 through wireless or wired communication to communicate with the external device (e.g., the second external electronic device 104 or the server 106).

The wireless communication may use at least one of, for example, long term evolution (LTE), LTE-advance (LTE-A), code division multiple access (CDMA), wideband CDMA (WCDMA), universal mobile telecommunications system (UMTS), wireless broadband (WiBro), and global system for mobile communications (GSM), as a cellular communication protocol. In addition, the wireless communication may include, for example, short range communication 164. The short-range communication 164 may include at least one of, for example, Wi-Fi, Bluetooth, Bluetooth low energy (BLE), near field communication (NFC), magnetic stripe transmission (MST), or Zigbee. The wireless communication may also utilize a global navigation satellite system (GNSS).

The MST may generate a pulse according to transmission data using an electromagnetic signal and the pulse may generate a magnetic field signal. The electronic device 101 may transmit the magnetic field signal to a POS device, and the POS device may detect the magnetic field signal using an MST reader and convert the detected magnetic field signal to an electric signal to restore the data.

The GNSS may include at least one of, for example, a GPS, a global navigation satellite system (Glonass), a Beidou navigation satellite system (hereinafter, referred to as “Beidou”), and European global satellite-based navigation system (Galileo). Hereinafter, in an embodiment of the present disclosure, the “GPS” may be interchangeably used with the “GNSS”. The wired communication may include, for example, at least one of a universal serial bus (USB), a high definition multimedia interface (HDMI), recommended standard 232 (RS-232), and a plain old telephone service (POTS). The network 162 may include at least one of a communication network, such as a computer network (e.g., a local area network (LAN) or a wide area network (WAN)), the internet, and a telephone network.

Each of the first external electronic device 102 and the second external electronic device 104 may be of a type identical to or different from that of the electronic device 101. According to an embodiment of the present disclosure, the server 106 may include a group of one or more servers. According to various embodiments of the present disclosure, all or some of the operations performed in the electronic device 101 may be performed in another electronic device or a plurality of electronic devices (e.g., the first external electronic device 102 and the second external electronic device 104 or the server 106). According to an embodiment of the present disclosure, when the electronic device 101 has to perform some functions or services automatically or in response to a request, the electronic device 101 may make a request for performing at least some functions relating thereto to another device (e.g., the first external electronic device 102 or the second external electronic device 104 or the server 106) instead of performing the functions or services by itself or in addition. Another electronic device (e.g., the first external electronic device 102 or the second external electronic device 104) or the server 106 may execute the requested functions or the additional functions, and may deliver a result of the execution to the electronic device 101. The electronic device 101 may provide the received result as is or process it further, thereby performing the requested functions or services. To this end, for example, cloud computing, distributed computing, or client-server computing technology may be used.

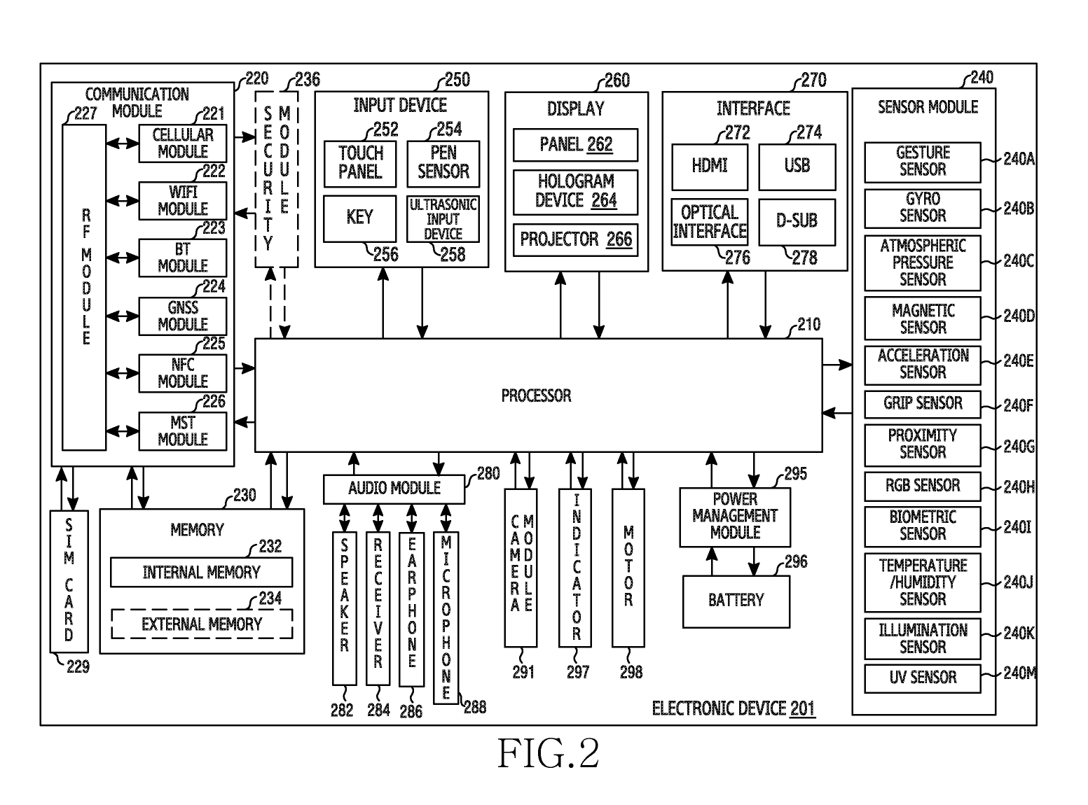

FIG. 2 is a block diagram illustrating an electronic device according to various embodiments of the present disclosure.

Referring to FIG. 2, for example, an electronic device 201 may include the whole or part of the electronic device 101 illustrated in FIG. 1. The electronic device 201 may include at least one AP 210, a communication module 220, a subscriber identification module (SIM) card 229, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an OS or an application program and perform processing of various pieces of data and calculations. The processor 210 may be implemented by, for example, a system on chip (SoC). According to an embodiment of the present disclosure, the processor 210 may further include a graphics processing unit (GPU) and/or an image signal processor (ISP). The processor 210 may include at least some (e.g., a cellular module 221) of the elements illustrated in FIG. 2. The processor 210 may load, into a volatile memory, instructions or data received from at least one (e.g., a non-volatile memory) of the other elements and may process the loaded instructions or data, and may store various data in a non-volatile memory.

The communication module 220 may have a configuration equal or similar to that of the communication interface 170 of FIG. 1. The communication module 220 may include, for example, the cellular module 221, a Wi-Fi module 222, a Bluetooth module 223, a GNSS module 224 (e.g., a GPS module, a Glonass module, a Beidou module, or a Galileo module), an NFC module 225, an MST module 226, and a radio frequency (RF) module 227.

The cellular module 221 may provide a voice call, image call, a text message service, or an Internet service through, for example, a communication network. According to an embodiment of the present disclosure, the cellular module 221 may distinguish between and authenticate electronic devices 201 within a communication network using a subscriber identification module (e.g., the SIM card 229). According to an embodiment of the present disclosure, the cellular module 221 may perform at least some of the functions that the processor 210 may provide. According to an embodiment of the present disclosure, the cellular module 221 may include a CP.

Each of the Wi-Fi module 222, the BT module 223, the GNSS module 224, the NFC module 225 and the MST module 226 may include, for example, a processor for processing data transmitted and received through the relevant module. According to various embodiments of the present disclosure, at least some (e.g., two or more) of the cellular module 221, the Wi-Fi module 222, the BT module 223, the GNSS module 224, the NFC module 225, and the MST module 226 may be included in one integrated chip (IC) or IC package.

The RF module 227 may transmit/receive, for example, a communication signal (e.g., an RF signal). The RF module 227 may include, for example, a transceiver, a power amp module (PAM), a frequency filter, a low noise amplifier (LNA), and/or an antenna. According to another embodiment of the present disclosure, at least one of the cellular module 221, the Wi-Fi module 222, the Bluetooth module 223, the GNSS module 224, the NFC module 225, or the MST module 226 may transmit and receive RF signals through a separate RF module(s).

The subscriber identification module 229 may include, for example, a card including a subscriber identity module and/or an embedded SIM, and may contain unique identification information (e.g., an integrated circuit card identifier (ICCID)) or subscriber information (e.g., an international mobile subscriber identity (IMSI)).

The memory 230 (e.g., the memory 130) may include, for example, an internal memory 232 or an external memory 234. The internal memory 232 may include at least one of, for example, a volatile memory (e.g., a dynamic random access memory (DRAM), a static RAM (SRAM), a synchronous dynamic RAM (SDRAM), and the like) and a non-volatile memory (e.g., a one time programmable read only memory (OTPROM), a programmable ROM (PROM), an erasable and programmable ROM (EPROM), an electrically erasable and programmable ROM (EEPROM), a flash memory (e.g., a NAND flash memory or a NOR flash memory), a hard driver, or a solid state drive (SSD).

An external memory 234 may further include a flash drive, for example, a compact flash (CF), a secure digital (SD), a Micro-SD, a Mini-SD, an extreme digital (xD), a multi-media card (MMC), a memory stick, and the like. The external memory 234 may be functionally and/or physically connected to the electronic device 201 through various interfaces.

The security module 236 is a module including a storage space having a higher security level than that of the memory 230 and may be a circuit guaranteeing safe data storage and a protected execution environment. The security module 236 may be implemented by a separate circuit and may include a separate processor. The security module 236 may exist in, for example, a detachable smart chip or SD card, or may include an embedded secure elements (eSE) embedded in a fixed chip of the electronic device 201. Further, the security module 236 may be operated by an OS that is different from the OS of the electronic device 201. For example, the security module may operate based on a java card open platform (JCOP) OS.

The sensor module 240 may measure a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red, green, blue (RGB) sensor), a biometric sensor 240I, a temperature/humidity sensor 240J, a light sensor 240K, and a ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors included therein. In various embodiments of the present disclosure, an electronic device 201 may further include a processor configured to control the sensor module 240 as a part of or separately from the processor 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may use at least one of, for example, a capacitive scheme, a resistive scheme, an infrared scheme, and an ultrasonic scheme. In addition, the touch panel 252 may further include a control circuit. The touch panel 252 may further include a tactile layer and provide a tactile reaction to the user.

The (digital) pen sensor 254 may include, for example, a recognition sheet which is a part of the touch panel or is separated from the touch panel. The key 256 may include, for example, a physical button, an optical key, a keypad, and the like. The ultrasonic input device 258 may detect ultrasonic wave generated by an input tool through a microphone (e.g., a microphone 288) and identify data corresponding to the detected ultrasonic waves.

The display 260 (e.g., the display 160) may include a panel 262, a hologram device 264, or a projector 266. The panel 262 may include a configuration identical or similar to that of the display 160 illustrated in FIG. 1. The panel 262 may be implemented to be, for example, flexible, transparent, or wearable. The panel 262 and the touch panel 252 may be configured by one module. The hologram device 264 may show a three dimensional image in the air by using an interference of light. The projector 266 may display an image by projecting light onto a screen. The screen may be located, for example, inside or outside the electronic device 201. According to an embodiment of the present disclosure, the display 260 may further include a control circuit for controlling the panel 262, the hologram device 264, or the projector 266.

The interface 270 may include, for example, an HDMI 272, a USB 274, an optical interface 276, or a D-subminiature (D-sub) 278. The interface 270 may be included in, for example, the communication interface 170 illustrated in FIG. 1. Additionally or alternatively, the interface 270 may include, for example, a mobile high-definition link (MHL) interface, a SD card/MMC interface, or an infrared data association (IrDA) standard interface.

The audio module 280 may bilaterally convert, for example, a sound and an electrical signal. At least some elements of the audio module 280 may be included in, for example, the input/output interface 145 illustrated in FIG. 1. The audio module 280 may process sound information which is input or output through, for example, a speaker 282, a receiver 284, earphones 286, the microphone 288, and the like.

The camera module 291 is a device which may photograph a still image and a dynamic image. According to an embodiment of the present disclosure, the camera module 291 may include one or more image sensors (e.g., a front sensor or a back sensor), a lens, an ISP or a flash (e.g., an LED or a xenon lamp).

The power management module 295 may manage, for example, power of the electronic device 201. According to an embodiment of the present disclosure, the power management module 295 may include a power management integrated circuit (PMIC), a charger integrated circuit (IC), or a battery or fuel gauge. The PMIC may use a wired and/or wireless charging method. Examples of the wireless charging method may include, for example, a magnetic resonance method, a magnetic induction method, an electromagnetic method, and the like, and may further include additional circuits (e.g., a coil loop, a resonance circuit, a rectifier, and the like) for wireless charging. The battery gauge may measure, for example, a residual quantity of the battery 296, and a voltage, a current, or a temperature during the charging. The battery 296 may include, for example, a rechargeable battery or a solar battery.

The indicator 297 may indicate a particular state (e.g., a booting state, a message state, a charging state, and the like) of the electronic device 201 or a part (e.g., the processor 210) of the electronic device 2201. The motor 298 may convert an electrical signal into mechanical vibration, and may generate vibration, a haptic effect, and the like. Although not illustrated, the electronic device 201 may include a processing unit (e.g., a GPU) for supporting a mobile TV. The processing unit for supporting mobile TV may, for example, process media data according to a certain standard, such as digital multimedia broadcasting (DMB), digital video broadcasting (DVB), or mediaFLO™.

Each of the components of the electronic device according to the present disclosure may be implemented by one or more components, and the name of the corresponding component may vary depending on the type of the electronic device. The electronic device according to various embodiments of the present disclosure may include at least one of the aforementioned elements. Some elements may be omitted or other additional elements may be further included in the electronic device. In addition, some of the hardware components according to various embodiments may be combined into one entity, which may perform functions identical to those of the relevant components before the combination.

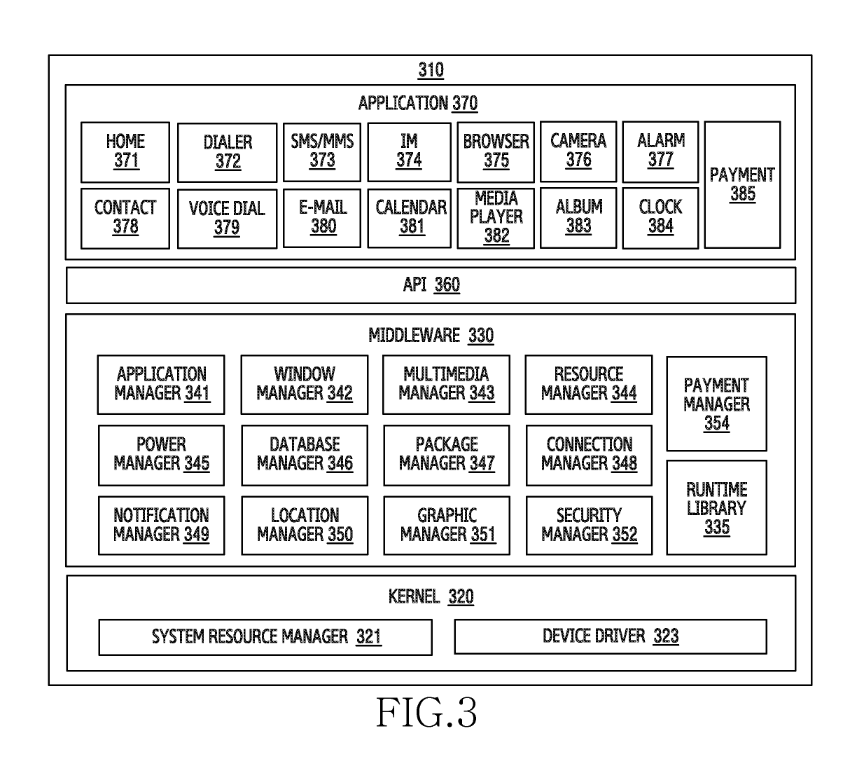

FIG. 3 is a block diagram illustrating a program module according to various embodiments of the present disclosure.

Referring to FIG. 3, according to an embodiment of the present disclosure, a program module 310 (e.g., the program 140) may include an OS for controlling resources related to the electronic device (e.g., the electronic device 101) and/or various applications (e.g., the application programs 147) executed in the OS. The OS may be, for example, Android, iOS, Windows, Symbian, Tizen, Bada, and the like.

The program module 310 may include a kernel 320, middleware 330, an API 360, and/or an application 370. At least some of the program module 310 may be preloaded on the electronic device, or may be downloaded from an external electronic device (e.g., the first external electronic device 102 or the second external electronic device 104, or the server 106).

The kernel 320 (e.g., the kernel 141) may include, for example, a system resource manager 321 and/or a device driver 323. The system resource manager 321 may perform the control, allocation, retrieval, and the like, of system resources. According to an embodiment of the present disclosure, the system resource manager 321 may include a process manager, a memory manager, a file system manager, and the like. The device driver 323 may include, for example, a display driver, a camera driver, a Bluetooth driver, a shared memory driver, a USB driver, a keypad driver, a Wi-Fi driver, an audio driver, or an inter-process communication (IPC) driver.

The middleware 330 may provide a function required by the applications 370 in common or provide various functions to the applications 370 through the API 360 so that the applications 370 can efficiently use limited system resources within the electronic device. According to an embodiment of the present disclosure, the middleware 330 (e.g., the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and a payment manager 354.

The runtime library 335 may include a library module which a compiler uses in order to add a new function through a programming language while the applications 370 are being executed. The runtime library 335 may perform input/output management, memory management, the functionality for an arithmetic function, and the like.

The application manager 341 may manage, for example, a life cycle of at least one of the applications 370. The window manager 342 may manage graphical user interface (GUI) resources used for the screen. The multimedia manager 343 may determine a format required to reproduce various media files, and may encode or decode a media file by using a coder/decoder (codec) appropriate for the corresponding format. The resource manager 344 may manage resources, such as a source code, a memory, a storage space, and the like, of at least one of the applications 370.

The power manager 345 may operate together with a basic input/output system (BIOS) to manage a battery or power, and may provide power information required for the operation of the electronic device. The database manager 346 may generate, search for, and/or change a database to be used by at least one of the applications 370. The package manager 347 may manage the installation or update of an application distributed in the form of a package file.

The connectivity manager 348 may manage a wireless connection, such as, for example, Wi-Fi or Bluetooth. The notification manager 349 may display or notify of an event, such as an arrival message, an appointment, a proximity notification, and the like, in such a manner as not to disturb the user. The location manager 350 may manage location information of the electronic device. The graphic manager 351 may manage a graphic effect, which is to be provided to the user, or a user interface (UI) related to the graphic effect. The security manager 352 may provide various security functions required for system security, user authentication, and the like. According to an embodiment of the present disclosure, when the electronic device (e.g., the electronic device 101) has a telephone call function, the middleware 330 may further include a telephony manager for managing a voice call function or a video call function of the electronic device. The payment manager 354 may relay information for payment from the application 370 to the application 370 or kernel 320. Further, the payment manager may store information related to the payment, which has been received from an external device, in the electronic device 200 or transfer the internally stored information to an external device.

The middleware 330 may include a middleware module that forms a combination of various functions of the above-described elements. The middleware 330 may provide a module specialized for each type of OS in order to provide a differentiated function. In addition, the middleware 330 may dynamically delete some of the existing elements, or may add new elements.

The API 360 (e.g., the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 (e.g., the application programs 147) may include, for example, one or more applications which can provide functions, such as a home application 371, a dialer application 372, a short message service (SMS)/multimedia messaging service (MIMS) application 373, an instant message (IM) application 374, a browser application 375, a camera application 376, an alarm application 377, contacts application 378, a voice dialer application 379, an email application 380, a calendar application 381, a media player application 382, an album application 383, a clock application 384, a payment application 385, a health care application (e.g., measure exercise quantity or blood sugar), or environment information (e.g., atmospheric pressure, humidity, or temperature information).

According to an embodiment of the present disclosure, the applications 370 may include an application (hereinafter, referred to as an “information exchange application” for convenience of description) supporting information exchange between the electronic device (e.g., the electronic device 101) and an external electronic device (e.g., the first external electronic device 102 or the second external electronic device 104). The information exchange application may include, for example, a notification relay application for transferring specific information to an external electronic device or a device management application for managing an external electronic device.

For example, the notification relay application may include a function of transferring, to the external electronic device (e.g., the first external electronic device 102 or the second external electronic device 104), notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

For example, the device management application may manage (e.g., install, delete, or update) at least one function of an external electronic device (e.g., the second external electronic device 104) communicating with the electronic device (e.g., a function of turning on/off the external electronic device itself (or some components) or a function of adjusting luminance (or a resolution) of the display), applications operating in the external electronic device, or services provided by the external electronic device (e.g., a call service and a message service).

According to an embodiment of the present disclosure, the applications 370 may include applications (e.g., a health care application of a mobile medical appliance, and the like) designated according to attributes of the first external electronic device 102 or the second external electronic device 104. According to an embodiment of the present disclosure, the application 370 may include an application received from the external electronic device (e.g., the server 106, or the first external electronic device 102 or the second external electronic device 104). According to an embodiment of the present disclosure, the application 370 may include a preloaded application or a third party application which can be downloaded from the server. Names of the elements of the program module 310, according to the above-described embodiments of the present disclosure, may change depending on the type of OS.

According to various embodiments of the present disclosure, at least some of the program module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

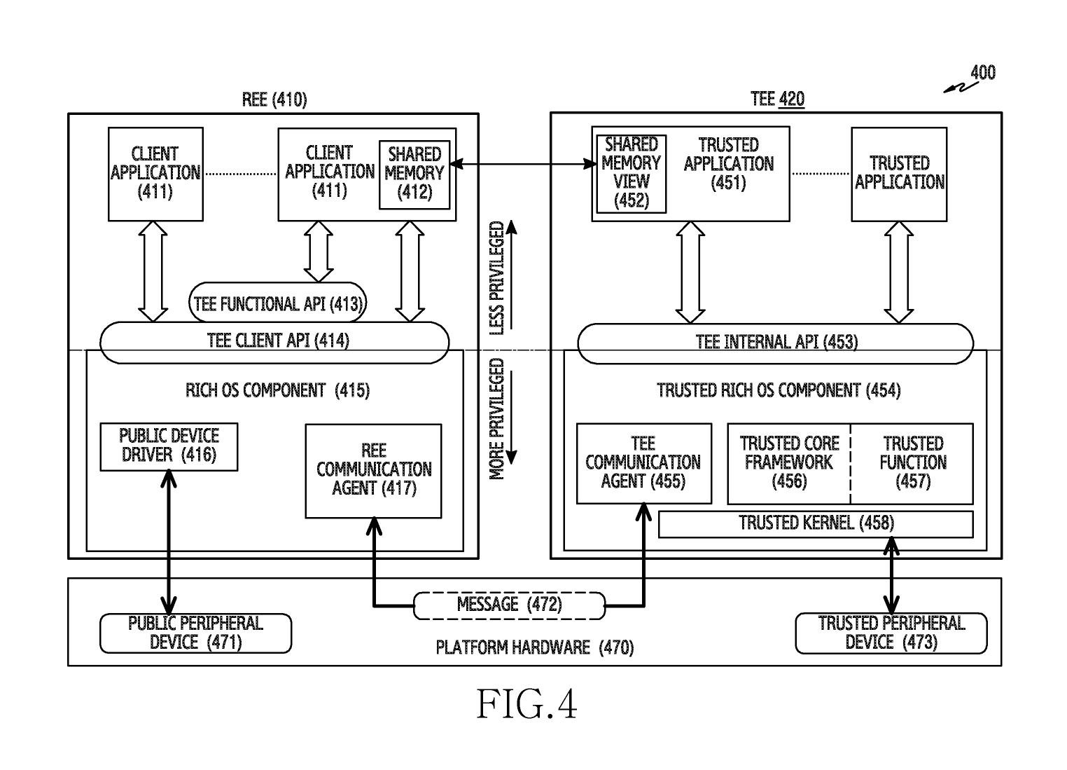

FIG. 4 is a block diagram illustrating a plurality of execution environments operated in an electronic device according to various embodiments of the present disclosure.

Referring to FIG. 4, the electronic device 101 may operate a plurality of execution environments 400 having security levels in order to reinforce the security. The plurality of execution environments may include, for example, a rich execution environment (REE) 410 and a trusted execution environment (TEE) 420.

The REE 410 may be, for example, a first execution environment having a first security level. The TEE 420 may be, for example, a second execution environment having a second security level different from (e.g., higher than) the first security level. According to an embodiment of the present disclosure, the electronic device 101 may include another execution environment (e.g., a third execution environment) having a third security level, without being limited thereto.

The REE 410 may include, for example, a client application 411, a shared memory 412, a TEE functional API 413, a TEE client API 414, a rich OS component 415, a public device driver 416, or an REE communication agent 417. The client application 411 (e.g., the application 370 or application program 147) may include at least one application capable of performing functions, including a phone call, messaging, payment, alarm, browser, or camera. The client application 411 may include the shared memory 412 and may access a shared memory view 452 of the TEE 420 using the shared memory 412. The shared memory 412 may be a memory accessible by applications of the REE 410 and the TEE 420.

The TEE functional API 413 and/or the TEE client API 414 are APIs allowed to access the TEE 420 and can perform functions similar to those of the API 145 or the API 360. The TEE functional API 413 may be an application interface designed to access some services of the TEE 420. The TEE client API 414 may be an interface designed to allow exchange of data between applications of the REE 410 and the TEE 420. The rich OS component 415 may include, for example, a public device driver 416 or an REE communication agent 417. The public device driver 416 may be a system driver for driving a public peripheral device 471 in the REE 410. The REE communication agent 417 may perform a role of processing a message communication between the client application 411 and a trusted application 451. The client application 411 may transfer a message 472 from the REE communication agent 417 to a TEE communication agent 455 of the TEE 420, using the TEE functional API 413 and/or the TEE client API 414. The message 472 may be, for example, implemented to be transferred to only the TEE 420 in view of hardware. The REE communication agent 417 may, for example, receive a result of processing associated with the message 472 from the TEE communication agent 455 and transfer the result to the client application 411.

The TEE 420 may store data requiring a relatively high security level and perform related operations in a safe environment. The TEE 420 may operate on an AP of the electronic device 101 and operate based on a reliable hardware structure determined in the process of manufacturing the electronic device 101. The TEE 420 may divide the AP or memory into a general area and a security area and operate in the security area. The TEE 420 may configure software or hardware requiring security, to operate in only the security area. The electronic device 101 may operate the TEE 420 through a physical change of hardware or a logical change of software. The TEE 420 may be separated from the REE 410 through hardware restrictions, or may be separated in view of software while operating in the same hardware.

The TEE 420 may include a trusted application 451, a shared memory view 452, a TEE internal API 453, a secure OS component 454, a TEE communication agent 455, a trusted core framework 456, a trusted function 457, or a trusted kernel 458. The trusted application 451 may include at least one application capable of performing functions of digital right management (DRM), security, payment, or biometric information. The shared memory view 452 may be a memory space capable of accessing the shared memory 412 of the REE 410.

The trusted application 451 may receive, for example, a message 472 from the REE communication agent 417 through the TEE communication agent 455, using the TEE internal API 453. The TEE client API 453 may be an interface provided to enable basic software of the TEE 420 to operate. The TEE communication agent 455 may receive the message 472 and transfer the message to the trusted application 451. The trusted application 451 may perform an operation associated with the message 472 and transfer a result of processing of the operation to the REE communication agent 417 through the TEE communication agent 455. The secure OS component 454 may include a TEE communication agent 455, a trusted core framework 456, a trusted function 457, and/or a trusted kernel 458.

The TEE communication agent 455 is one kind of framework API and may perform a role of processing a safe message communication between the client application 411 and the trusted application 451. The trusted core framework 456 may provide OS functions, such as scheduling, communication, and memory management, to be performed by the trusted application 451. The trusted function 457 may provide a function of trust including a password. The trusted kernel 458 may be a kernel for driving the TEE 420. The platform hardware 470 is a hardware element which transfers, for example, the message 472 from the REE communication agent 417 to the TEE communication agent 455. The platform hardware 470 may include a public peripheral device 471 and/or a trusted peripheral device 473. The public peripheral device 471 may communicate with the public device driver 416 of the REE 410. The trusted peripheral device 473 may communicate with the trusted kernel 458 of the TEE 420. The public peripheral device 471, which is a general peripheral device provided in an electronic device, may be, for example, a Gyro sensor or a GPS device. The trusted peripheral device 473 is a security (or password)-related peripheral device connected with the TEE 420 and may be, for example, a fingerprint sensor, an iris sensor, or a security display.

“More privileged” and “less privileged” relate to an authority capable of accessing the system, and “more privileged” may refer to a high system access authority and “less privileged” may refer to a low system access authority. For example, a low system authority may have a limited authority for access to the system (e.g., file writing, reading, and the like). The system access authority may have a concept equal or similar to the access authority in a general OS.

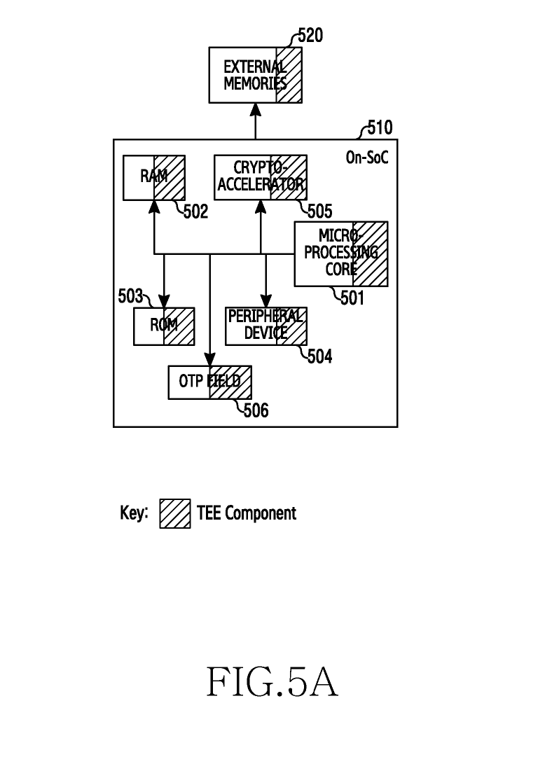

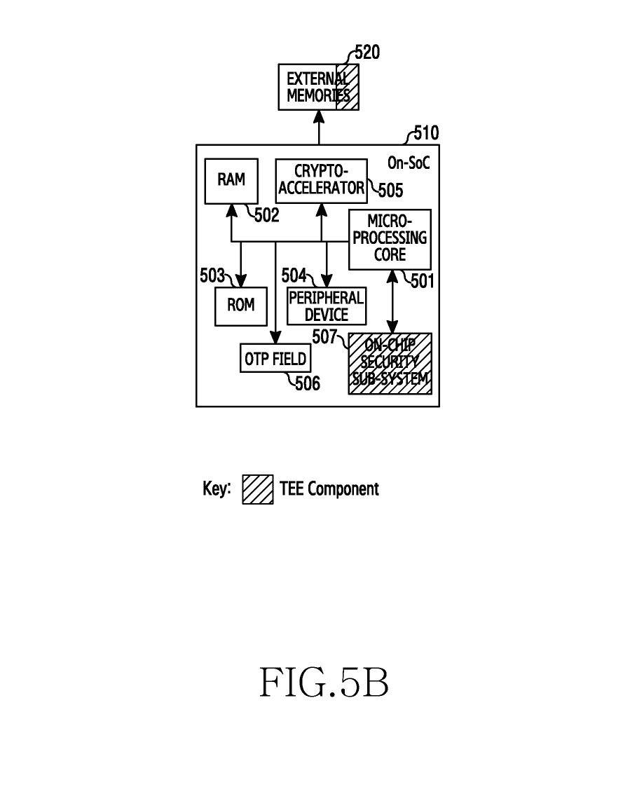

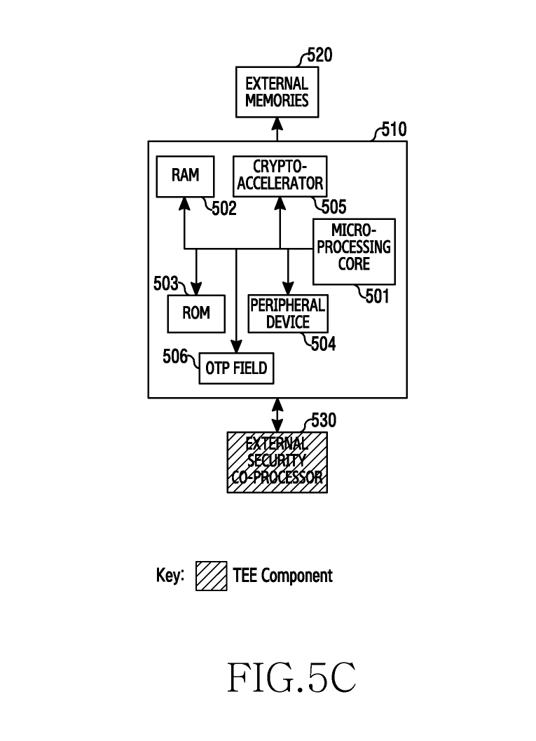

FIGS. 5A to 5C illustrate block diagrams of hardware structures of a TEE according to various embodiments of the present disclosure.

FIG. 5A illustrates an example (e.g., a trustzone (TZ) of ARM) of using one processor (e.g., the processor 120) and one memory (e.g., the memory 130) in a manner of dividing them into the REE 410 and the TEE 420 in view of hardware.

Referring to FIG. 5A, the hardware structure of the TEE 420 may include an on-system on chip (On-SoC) 510 and an external memory 520. The On-SoC 510 may include, for example, a micro-processing core 501, a RANI 502, a ROM 503, a peripheral device 504, a crypto-accelerator 505, or an OTP field 506. In order to operate two or more execution environments, the trust zone may temporally divide the processors to separately use the REE 410 and the TEE 420. Further, the trust zone may divide one memory into an area accessible in the REE 410 and an area accessible in the TEE 420 and separately use the areas. Therefore, the micro-processing core 501, the RAM 502, the ROM 503, the peripheral device 504, the crypto-accelerator 505, and the OTP field 506 may be divided, in use, into an REE area and a TEE area.

FIG. 5B illustrates a case where a processor (e.g., the processor 120) for the TEE 420 is implemented together with a processor for operating the REE 410 in the form of on-chip but is implemented in a separate processing core set. The processor for the TEE 420 according to various embodiments may have a configuration equal or similar to that of the above processor (e.g., the processor 120) due to an on-chip security sub-system 507 added thereto. Therefore, the following description omits description on the same elements as those of the above processor (e.g., the processor 120).

Referring to FIG. 5B, the On-SoC 510 may include an on-chip security sub-system 507 including at least one processor, in addition to a micro-processing core 501, a RAM 502, a ROM 503, a peripheral device 504, a crypto-accelerator 505, and an OTP field 506. In this case, the On-SoC 510 may be configured to operate the REE 410 while the on-chip security sub-system 507 is configured to operate the TEE 420. As in FIG. 5A, one memory may be divided in use into an area accessible in the REE 410 and an area accessible in the TEE 420 in the structure of FIG. 5B.

FIG. 5C illustrates an example in which a processor for the TEE 420 is implemented as a separate chip in view of hardware and is thus separated from a chip in which a processor for operating the REE 410 is implemented. The processor for the TEE 410 according to various embodiments may have a configuration equal or similar to that of the above processor (e.g., the processor 120) due to an external security co-processor 530 added thereto. Therefore, the following description omits description on the same elements as those of the above processor (e.g., the processor 120).

Referring to FIG. 5C, the On-SoC 510 may be configured to operate the REE 410 and one or more external security co-processors 530 disposed outside of the On-SoC 510 may be configured to operate the TEE 420.

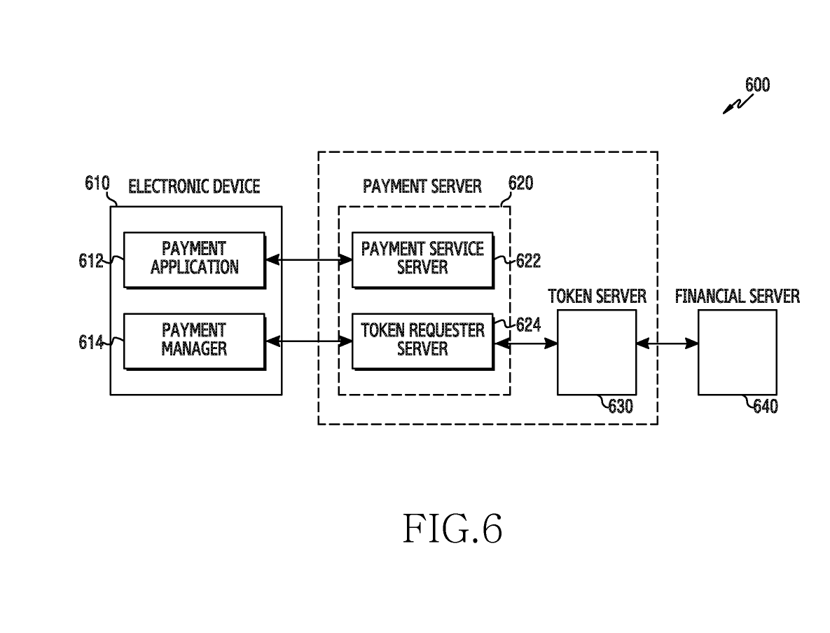

FIG. 6 is a block diagram illustrating a payment system according to various embodiments of the present disclosure.

Referring to FIG. 6, a payment system 600 may include an electronic device 610 (e.g., the electronic device 101) and/or server. For example, the server may include a payment server 620, a token server (e.g., a token service provider (TSP)) 630, or a financial server (issuer) 640. The electronic device 610 may include, for example, a payment application (e.g., a wallet application) 612 and/or a payment manager 614. The payment server 620 may include, for example, a payment service server 622 and/or a token requester server 624.

According to various embodiments of the present disclosure, the payment application 612 may include a payment application 612 (e.g., a Samsung Pay™ application). The payment application 612 may provide, for example, a UI or user experience (UX) related to payment. The UI related to payment may include a wallet UI/UX. For example, the payment application 612 may provide, for example, a UI related to card registration, payment, or transaction. The payment application 612 may provide, for example, an interface related to card registration through an external input (e.g., a user input) or a text reader (e.g., optical character reader/recognition (OCR)). Further, the payment application 612 may provide, for example, an interface related to user Identification through identification and verification (ID&V).

According to various embodiments of the present disclosure, the payment application 612 may perform payment transaction. For example, the payment application 612 may provide a user with a payment function through execution of Simple Pay, Quick Pay, or a designated application. Using the payment application 612, a user may perform a payment function and receive information associated with the payment function.

According to various embodiments of the present disclosure, the payment manager 614 may include information associated with a card company. For example, the payment manager 614 may include a card company software development kit (SDK).

According to various embodiments of the present disclosure, the payment server 620 may include a management server for electronic payment or mobile payment. The payment server 620 may, for example, receive information related to payment from the electronic device 610 and transmit the information to the outside or process the information in itself.

According to various embodiments of the present disclosure, the payment server 620 may transmit or receive information between the electronic device 610 and the token server 630, using the payment service server 622 and/or the token requester server 624. The payment service server 622 may include, for example, a payment server (e.g., a Samsung payment server) 620. The payment service server 622 may manage, for example, card information linked to a service account (e.g., a Samsung account) or user account. Further, the payment service server 622 may include an API server related to the payment application 612. Further, the payment service server 622 may provide, for example, an account management module (e.g., account integration or Samsung account integration).

According to various embodiments of the present disclosure, the token requester server 624 may provide an interface for processing information relating to payment. For example, the token requester server 624 may perform issuance, deletion, or activation of information (e.g., token) related to payment. In addition, the token requester server may be functionally connected to the payment manager 614 to control the information required for the payment.

According to various embodiments of the present disclosure, the payment application 612 included in the electronic device 610 and the payment service server 622 included in the payment server 620 may be functionally connected with each other. For example, the payment application 612 may transmit or receive information relating to payment to or from the payment server 620.

According to various embodiments of the present disclosure, the payment manager 614 included in the electronic device 610 and the token requester server 624 included in the payment server 620 may be functionally connected with each other. For example, the payment manager 614 may transmit or receive information relating to payment to or from the token requester server 624.

According to various embodiments of the present disclosure, the token server 630 may issue or manage information (e.g., token) relating to payment. For example, the token server 630 may control the operation cycle (like cycle) of a token and the operation cycle may include a generation, revision, or deletion function. Further, the token server 630 may include, for example, a token management server and perform token provisioning, ID&V, replenishment, or life cycle management. Further, the token server may integrate information relating to the financial server.

According to various embodiments of the present disclosure, the payment server 620 and/or the token server 630 may be located in an identical area, similar areas, or separated areas. For example, the payment server 620 may be included in a first server while the token server 630 is included in a second server. Further, for example, the payment server 620 and/or the token server 630 may be distinguishably implemented in one server (e.g., the first server or second server).

According to various embodiments of the present disclosure, the financial server 640 may perform issuance of a card. For example, the financial server 640 may include a card issuing bank. Further, the financial server 640 may generate information required for the payment provided to the user. The user may store, in the electronic device 610, the information required for the payment generated in the financial server 640, using the payment application 612. In addition, the financial server 640 may be functionally connected to the token server 630 to transmit or receive the information required for the payment.

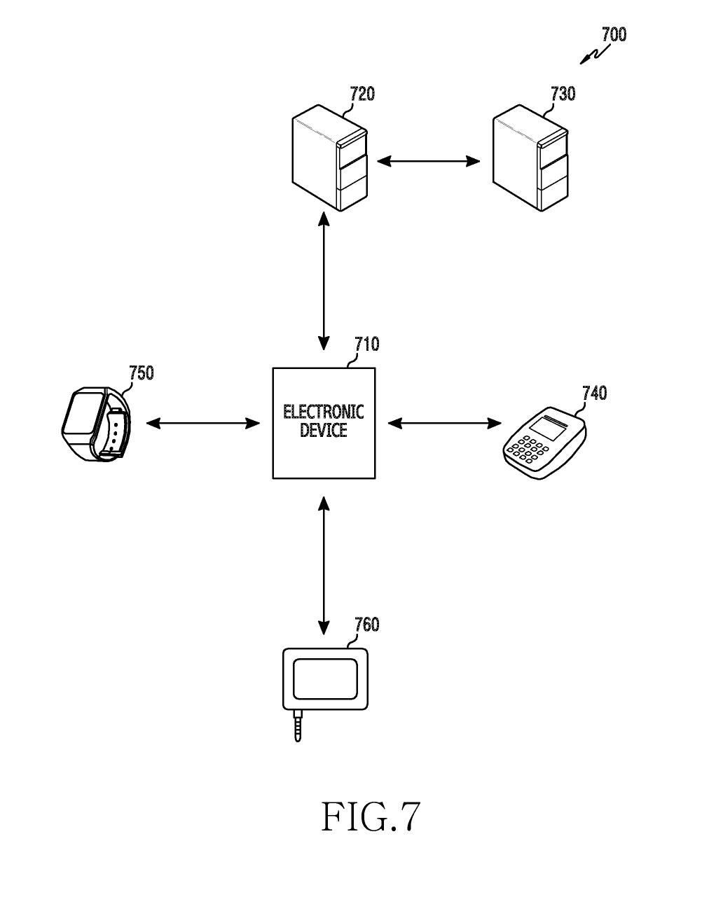

FIG. 7 is a block diagram illustrating a payment system for performing payment according to various embodiments of the present disclosure.

Referring to FIG. 7, a payment system 700 may include an electronic device 710 (e.g., the electronic device 101), a payment server 720 (e.g., the server 106), a TSP 730 (e.g., the server 106 or another server (not shown)), and a POS device 740 (e.g., the first external electronic device 102). According to an embodiment of the present disclosure, the payment system 700 may include one or more additional electronic device 750 or 760. The one or more additional electronic device 750 or 760 may include a wearable device 750 (e.g., a smart watch) or an accessory device 760 (e.g., a fob type device of the LoopPay™ company), which can be functionally connected with the electronic device 710. According to an embodiment of the present disclosure, the fob type device of the LoopPay™ company may include an external payment module connected to the electronic device 710 through a microphone.

According to an embodiment of the present disclosure, the electronic device 710 may perform a payment function. The electronic device 710 may register a card (e.g., a credit card, such as a master card, a visa card, and the like) in the electronic device 710 or the payment server 720 in order to perform the payment function. The payment server 720 may manage information on a plurality of registered cards including a card registered through another electronic device (e.g., the electronic device 750) of the user corresponding to the electronic device 710 or another card registered through an electronic device of another user as well as a card registered through the electronic device 710.

According to an embodiment of the present disclosure, the payment server 720 may acquire token information corresponding to registered card information from the TSP 730 and transfer the acquired information to the electronic device 710. The payment server 720 may include, for example, a payment service server or token requester server. The payment service server may manage card information of the user. The payment server may provide a service related to payment based on an account. The token requester server may request the TSP 730 to provide token information necessary for the payment operation and acquire the token information.

The TSP 730 may issue a token used in a payment process. According to an embodiment of the present disclosure, the token may have a value replacing a primary account number (PAN), which is information of a card. According to an embodiment of the present disclosure, a token may be generated using a bank identification number (BIN). Further, the generated token may be encrypted by the TSP 730, or may be encrypted by the payment server 720 after being transmitted to the payment server 720 without being encrypted. The encrypted token information may be transferred to the electronic device 710 through the payment server 720 and decrypted by the electronic device 710. According to an embodiment of the present disclosure, the token may be generated and encrypted in the TSP 730 and may be transferred to the electronic device 710 without passing through the payment server 720. According to another embodiment of the present disclosure, the payment server 720 may include a token generation function. In this instance, the payment system may omit a separate TSP 730.

The electronic device 710 may perform payment using, for example, at least one electronic device among one or more other electronic devices 750 or 760 functionally connected thereto based on a short range communication (e.g., Bluetooth or Wi-Fi). According to an embodiment of the present disclosure, the at least one electronic device 750 may be a wearable device (e.g., a smart watch) and, in this instance, the electronic device 710 may transmit the token received from the TSP 730 to the wearable device. According to an embodiment of the present disclosure, the at least one electronic device 760 may be an accessory device (e.g., a fob type device of the LoopPay™ company) and, in this instance, the electronic device 710 may be functionally connected with the accessory device (e.g., a fob type device of the LoopPay™ company) through its input/output interface 150 (e.g., the earphone 286).

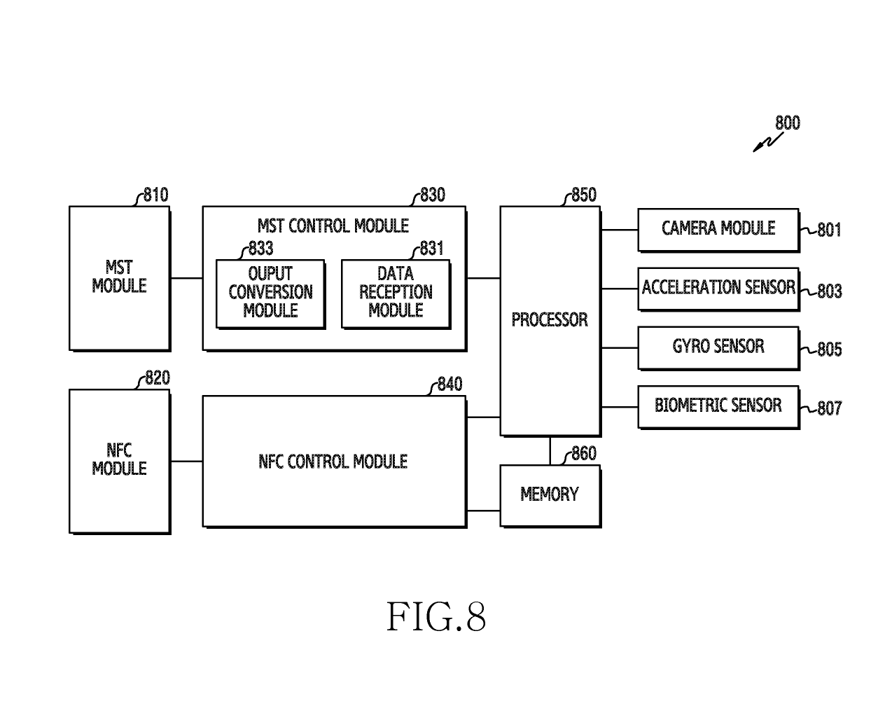

FIG. 8 is a block diagram illustrating a hardware structure of an electronic device according to various embodiments of the present disclosure.

Referring to FIG. 8, an electronic device 800 may include, for example, a camera module 801, an acceleration sensor 803, a gyro sensor 805, a biometric sensor 807, an MST module 810, an NFC module 820, an MST control module 830, an NFC control module 840, a processor 850, and a memory 860.

The camera module 801 may photograph a card required for payment to acquire card information. The camera module 801 may recognize, through an OCR function, card information (e.g., card company, card number, card expiration date, or card owner) recorded in the card. Otherwise, a user may input necessary card information to the electronic device 800, using an input device (e.g., a touch panel, a pen sensor, a key, an ultrasonic input device, or a microphone input device) included in the electronic device 800.

The acceleration sensor 803 or gyro sensor 805 may acquire location state of the electronic device 800 at the time of payment. The acquired location state of the electronic device 800 may be transferred to the processor 850. The processor 850 may adjust the intensity (current intensity) of a magnetic field transmitted to the POS device 740 from one of the MST module 810 or the NFC module 820 based on the acquired location state of the electronic device 800 or select a coil antenna to be used when there are a plurality of coil antennas.

The biometric sensor 807 may acquire biometric information. The acquired biometric information may be transferred to the processor 850. The processor 850 may authenticate a user by comparing the acquired biometric information and pre-stored biometric information of the user.

At least one of the MST control module 830 and the NFC control module 840 may transmit payment information. The MST control module 830 may transmit payment information to a POS device 740 through the MST module 810. The NST control module 840 may transmit payment information to the POS device 740 through the NST module 820.

According to an embodiment of the present disclosure, the MST control module 830 may include a data reception module 831 and an output conversion module 833. The data reception module 831 may receive a pulse signal in the form of logical low/high, which includes payment information transmitted from the processor 850 or the security module 236 (e.g., an eSE). The output conversion module 833 may include a circuit for converting data recognized by the data reception module 831 into necessary types in order to transfer the data to the MST module 810. The circuit may include an H-Bridge for controlling the direction of the voltage supplied to opposite ends of the MST module 810. The H-Bridge may include a circuit structure connected in a shape like H using four switch structures.

According to an embodiment of the present disclosure, based on the card information input through the camera module 801 or an input device (e.g., a touch panel or a pen sensor), the electronic device 800 may receive the payment information (e.g., track 1/2/3 or token information) included in the magnetic stripe of a magnetic card from a card company/bank server through a communication module (not shown) and store the received information in a necessary form in a separate security module 236 (e.g., an eSE).

According to an embodiment of the present disclosure, the electronic device 800 may transmit the payment information to the POS device 740 using at least one of the MST module 810 and the NFC module 820. For example, the electronic device 800 may transmit the payment information to the POS device 740 using all of the MST module 810 and the NFC module 820 to elevate recognition rate. Another example, the electronic device 800 may transmit the payment information using the MST module 810, and transmit the payment information using the NFC module 820 when the payment is failed. A method for recognizing a failure of the payment may include that the electronic device 800 may receive a notification from the POS device 740 or a 3rd party (e.g., a financial institution), or a defined time is exceeded.

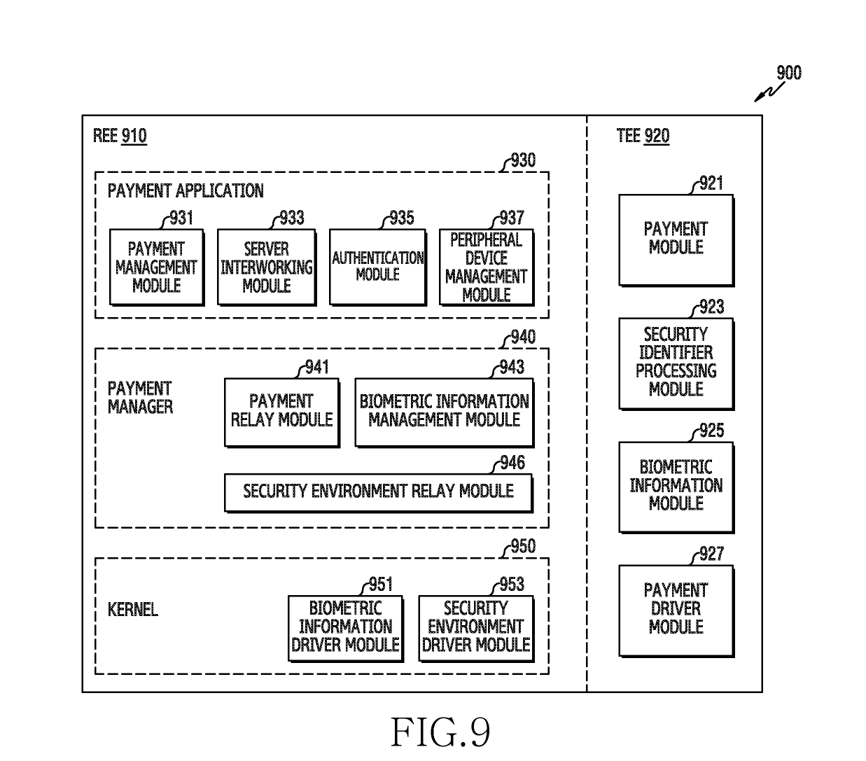

FIG. 9 is a block diagram illustrating a program module to be executed in an execution environment of an electronic device according to various embodiments of the present disclosure.

Referring to FIG. 9, a program module 900 may include, for example, an REE 910 and a TEE 920.

According to an embodiment of the present disclosure, the REE 910 may include, for example, a payment application 930 (e.g., the payment application 385), a payment manager 940 (e.g., the payment manager 354 or 614), and a kernel 950 (e.g., the kernel 320).

According to an embodiment of the present disclosure, the payment application 930 may include, for example, a payment management module 931, a server inter-working module 933, an authentication module 935, and a peripheral device management module 937.

According to an embodiment of the present disclosure, the payment management module 931 may perform operations for card registration, card authentication, card de-registration, and payment. The payment management module 931 may register a user's card. The electronic device 800 may receive a card registration request from a user. The electronic device 800 may acquire a card image, using the camera module 801. The payment management module 931 may acquire a card image through an OCR module. The payment management module 931 may receive a user's input of information (e.g., a secret code, a home address, an e-mail address, a phone number, an account ID, and the like) associated with the card information or acquire the information from the payment server 720.

According to an embodiment of the present disclosure, the payment management module 931 may display a registered card to the user through the display 160. The user may revise at least a part of the information (e.g., a card name, a home address, a phone number, the number of times of payment trials, or information on whether payment notification information has been received or not) of the registered card. The payment management module 931 may display transaction details of each card. The payment management module 931 may display the registered card information in a wearable device (e.g., a smart watch) functionally connected to the electronic device.

According to an embodiment of the present disclosure, the payment management module 931 may perform a payment operation using a registered card. The user may select one card among a plurality of registered card. The user may take the electronic device 800 to the POS device 740. The payment management module 931 may display product information (e.g., price) received from the POS device 740 through the display 160. The payment management module 931 may perform user authentication (e.g., fingerprint authentication) through the authentication module 935 for payment. When the authentication has been completed, the payment management module 931 may display notification information reporting completion of payment through the display 160.

According to an embodiment of the present disclosure, the electronic device 800 may transmit payment information to the POS device 740, using at least one module among the MST module 810 and the NFC module 820. In order to raise the recognition rate, the electronic device 800 may transmit the payment information to the POS device 740, simultaneously using the MST module 810 and the NFC module 820. Otherwise, the electronic 800 may use the MST module 810 in transmission and may use the NFC module 820 in the transmission when the payment has failed. A method of recognizing a case wherein the payment has failed may include reception, by the electronic device 800, of a notification from the POS device 740 or a 3rd party (e.g., financial institution) or lapse of a certain time. Various embodiments are not limited to the sequence described above and allows an opposite sequence.

According to an embodiment of the present disclosure, an electronic device 800 may receive a request for removal of at least one card among already registered cards from a user. The payment management module 931 may delete information corresponding to the at least one card from the memory 860. The payment management module 931 may request the payment server 720 to delete the information corresponding to the at least one card.

According to an embodiment of the present disclosure, the payment management module 931 may determine whether the owner of the card is identical to the user performing the card registration. The payment management module 931 may include, for example, an ID&V module. The payment management module 931 may perform user authentication through text messages, e-mail, ARS, or phone call. Further, the authentication may be performed through an application issued by a card company or bank. The card registered through the payment management module 931 may be used after being authenticated.

According to an embodiment of the present disclosure, the payment management module 931 may include an OCR module. The OCR module may acquire, through a scanner, an image of a letter written by a human or printed by a machine and convert the image to a machine-readable letter. The electronic device 800 may acquire an image of a card possessed by a user, through a camera module 801. The OCR module may convert an image, a letter, or a number written in a card, obtained from a card image, to a machine-readable letter. The OCR module may acquire card information (e.g., card number, user name, or valid period) of the user from converted letters. The electronic device 800 may acquire the card information of the user through the OCR module and perform a card registration process.

According to an embodiment of the present disclosure, the payment management module 931 may display a bar code generated for payment through the display 160. For example, the payment management module 931 may receive a command indicating generation of a bar code for payment through a bar code reader. The payment management module 931 may generate a bar code based on the command.

According to an embodiment of the present disclosure, the server interworking module 933 may receive a payment-related message, a device-related message, or a service-related message from the payment server 720 or the TSP 730. The server interworking 933 may transfer the message to the payment management module 931.

According to an embodiment of the present disclosure, the server interworking module 933 may include, for example, a push management module and an account management module. For example, a message received from the payment server 720 may be processed by the push management module when the message is in the form of a push notification associated with a token, and may be processed by the account management module when the message relates to account-related information (e.g., Samsung account).

According to an embodiment of the present disclosure, the push management module may calculate or handle the push notification or push message information received from the payment server 720. The push message may be transferred to the server interworking module 933 within the payment application 930 through a payment relay module 941 within the payment manager 940 or 354 or directly transferred to the payment application 930. At least some messages among transferred push messages may be transferred to the payment management module 931 to update card-related information and be synchronized with the payment server 720.

According to an embodiment of the present disclosure, the payment server 720 may include an account server for managing account-related information or a token requester server for providing payment-related information. The account server and the token requester server may be implemented as a separate device (e.g., the server 106) and may be included in a single device.

According to an embodiment of the present disclosure, the message information received by the push management module may include token and payment related information, such authority configuration (e.g., token provisioning), suspension (e.g., token suspension), disposal (e.g., token disposal), state change (e.g., token status change), additional issuance (e.g., token replenishment), and payment identification (e.g., transaction notification), as shown in Table 1 below.

The messages transmitted/received by the account management module may include at least a part of electronic device-related information, a lost electronic device identification function (e.g., lost device, find my mobile), remote blocking (e.g., remote lock/unlock), membership management (e.g., loyalty/membership cards), a web-linked function (e.g., website portal-on-line).

TABLE 1

| Push | | |
|---|---|---|
| management | Use case | details |
| Token | Token provisioning | Card information for identification or verification is |
| | with ID & V | sent down for installation and authentication of a |
| | | token from an external server to a push management |
| | | module within an electronic device |
| | Token suspension | Transferred, for interruption of use of a token, from |
| | | an external server to a push management module |
| | | within an electronic device |
| | Token resume | Transferred from an external server to a push |
| | | management module within an electronic device, for |
| | | restart of use of a token |
| | Token disposal | Transferred from an external server to a push |
| | | management module within an electronic device, for |
| | | removal of a token |
| | Token status change | Transferred from an external server to a push |
| | | management module within an electronic device, for |
| | | card state change |
| | Token Replenishment | Transferred from an external server to a push |
| | | management module within an electronic device, for |
| | | additional issuance of a token |
| | Transaction | Token payment details are transferred from an |
| | Notification | external server (payment server) to a push |
| | | management module within an electronic device |
| Device | Lost Device (Find my | Transfer of loss history information between an |
| | mobile) | external server (service server) and an account |
| | | management module within an electronic device |
| | Remote lock/unlock | Transfer of a remote device blocking command |
| | | between an external server (service server) and an |
| | | account management module within an electronic |
| | | device |
| | Loyalty/Membership | Transfer of membership information between an |
| | cards | external server (service server) and an account |
| | | management module within an electronic device |
| | Website (online) | Support of a Web-linked function between an |
| | | external server (service server) and an account |
| | | management module within an electronic device |

According to an embodiment of the present disclosure, when token provisioning ID&V information acquired by the payment management module 931 is successfully transferred through the payment server 720 to an external server and the transferred token-related information is valid, the server interworking module 933 may receive, for example, a “push token {id} status changed” message and transfer the received message to the payment management module 931.

According to an embodiment of the present disclosure, in regard to card information temporal suspension information (e.g., token suspension) acquired by the payment management module 931 of the electronic device 800, a use stop command of the payment server 720 may be transferred to the payment application 930 to switch the card configuration state for mobile payment from the active state to the inactive state.

According to an embodiment of the present disclosure, when the electronic device 800 is lost, the payment server 720 may delete or temporarily stop all token information stored in the payment server 720. In order to synchronize this with the payment application 930, the payment server 720 may transmit a push message. The payment server 720 may transfer the push message to the payment application 930 through the payment relay module 931 or the server interworking module (e.g., a Push management module or an account management module) 933.

Referring to Table 2, showing contents of push APIs supported by the electronic device 800 and the payment relay module 931, the APIs may be distinguishably and separately implemented according to the payment relay module 931.

TABLE 2

| API | Description | type | validation |
|---|---|---|---|
| device.push | Contains push platform | Json | required |
| device.push.spp.id | Samsung Push Id. | String | required |
| device.push.gcm.id | Google Push Id. | String | optional |

According to an embodiment of the present disclosure, the account management module may manage, in the payment application, information including a user-specific identifier (e.g., a Samsung account ID or a device ID), card, or membership which the module exchanges with the payment server 720. The user identifier may include an account, which a user has joined in order to manage cards (e.g., a VISA™ card or a MASTER Card™) of various business providers, a portal account associated with an electronic device, or a unique identifier (e.g., a model name, a MAC address, an international mobile equipment identity (IMEI), a serial number, a universally unique ID (UUID), an ID, and the like) of an electronic device. In addition, the unique identifier may have a value which has been generated by and transferred from the payment server 720 through the account.

The account management module may manage registration, addition, deletion, repeated registration, use suspension, or use restart of a card, using the account of the user or the identifier of the electronic device 800. Moreover, in the case of transmitting (importing/exporting) card information between the electronic device 800 and a wearable device also, registration, addition, deletion, repeated registration, use suspension, or use restart of a card may be managed based on the generated account or an identifier of the electronic device 800. Here, a management method based on an account may manage a plurality of electronic devices 800 or a plurality of users sharing one account to use a unique account (e.g., a Samsung account) for each electronic device 800 or synthetically manage a plurality of electronic devices 800 by one account.

According to an embodiment of the present disclosure, information of a first card (e.g., a VISA™ card) and a second card (e.g., MASTER™ card) generated through an OCR module of the payment management module 931 may be used to register the cards based on an account (e.g., registration02@samsung.com) generated at the time of joining the Samsung account. The registered information may be synchronized with the payment server 720 based on the generated account.

According to an embodiment of the present disclosure, membership information generated through a bar code interface may be used to register the first card (e.g., a Samsung point card) and the second card (e.g., CJ membership point card) based on an account (e.g., registration01@samsung.com) generated at the time of joining the Samsung account. The registered information may be synchronized with the payment server 720 based on the generated account. Further, a user may determine the active/inactive states of a card based on an account after logging-in through the payment application and transfer the determination to the payment server 720 using the account management module, and on the contrary, may change the management of the card state based on an account in a server management web page (e.g., server portal). Further, the account management module manage, while interworking with the server, the card information (e.g., a VISA™ card ID&V) and membership information (e.g., membership points, registraion001@Cj.com) associated with a service account (e.g., registration01@samsung.com). The membership information may be automatically linked, at the time of card payment, to payment processing information (e.g., payment amount) and membership accumulation information (e.g., points or mileage) to automatically accumulate or subtract the points or mileage.

When an application including an account management module is installed, the configuration state of a part or all of an existing registered card may be continuously linked and used by only one time of an account login (or sign-in) process of a user even in any device. Further, even membership information having a relatively low authentication security level may be registered and linked based on an account of the user to reduce additional authentication processes.

According to an embodiment of the present disclosure, the authentication module 935 may display a UI for authentication of a user or a card for payment through the display 160. The authentication module 935 may include, for example, a biometric information module.

According to an embodiment of the present disclosure, the biometric information module may acquire biometric information of a user. The biometric information of a user may include, for example, information of, a fingerprint, an iris, a face image, voice, cardiac impulse, or blood pressure. The electronic device 800 may acquire biometric information of a user through a sensor module. For example, the electronic device may acquire fingerprint information of a user through a fingerprint sensor. Meanwhile, the electronic device 800 may acquire information of an iris of a user through the camera module 801. The biometric information module may display a UI for acquiring biometric information of a user through the display 160.

According to an embodiment of the present disclosure, when a user tries payment using card information registered in the electronic device 800, the biometric information module may perform an authentication in order to acquire security data (e.g., token) from a security memory (e.g., eSE or memory accessible in a secure environment) functionally connected to the electronic device 800. The electronic device 800 may acquire biometric information (e.g., fingerprint or iris) of the user through the biometric information module for user authentication. The acquired biometric information may be transferred to a biometric information management module 943 of the payment manager 940. According to an embodiment of the present disclosure, the security memory may be a memory including data stored by encryption key.

According to an embodiment of the present disclosure, the biometric information module may proceed with payment, using card information and biometric information registered in the electronic device 800, when the user proceeds with electronic payment on an Internet web page. In order to acquire security data (e.g., token) from a memory or security module (e.g., an eSE or a memory accessible in a secure environment) functionally connected to the electronic device 800, the user may perform an authentication. When user authentication has successfully progressed in the electronic device 800, the electronic device is linked to an external server to enable fast automatic authentication (e.g., fast identity online (FIDO)) without electronic payment on a separate Internet web page. For example, instead of an authentication process required at the time of on-line payment, a fast authentication may be performed by liking to the biometric information module.

According to an embodiment of the present disclosure, the electronic device 800 may previously appoint a fingerprint of a user and a card to be used for payment. For example, when the user performs authentication using a fingerprint in the payment application, the user may appoint his or her right hand thumb to VISA™ card and his or her right hand index finger to MASTER™ card, so that payment through a corresponding card can be achieved as soon as the user performs authentication using a corresponding finger.

According to an embodiment of the present disclosure, the peripheral device management module 937 may manage an external device functionally connected to the electronic device 800. The peripheral device management application 937 may include, for example, an MST peripheral device module and a wearable device module.

According to an embodiment of the present disclosure, the MST peripheral device module may output information on whether an MST accessory (e.g., fob type device of LoopPay™) and the electronic device 800 are connected or not wirelessly or wiredly, and may provide a UI proper for the user on the basis thereof. The UI may progress and output card registration or deletion, or payment in a state where the MST accessory has been connected thereto. The MST peripheral device module may store various card information necessary for payment in the electronic device 800 or a separate memory within the MST accessory, in a state where it is connected to the MST accessory. As a result, the electronic device 800 or MST accessory can independently progress the payment in a state where the MST accessory is not connected.

The wearable device module may output information on whether a wearable device (e.g., watch, headset, glasses, or ring) and the electronic device 800 are connected or not wirelessly or wiredly, and may provide a UI proper for the user on the basis thereof. The wired or wireless connection may include various interfaces, such as BT, BLE, Wi-Fi, Zigbee, or Z-wave, and may be implemented by applying a particular accessory protocol (Samsung accessory protocol (SAP)). The UI may progress and output card registration or deletion, or payment in a state where the wearable device has been connected thereto. In the process of card registration, deletion, or payment, the wearable device module may output information on whether to generate a secure session with the wearable device, and transmit or receive and display a user input value on the electronic device 800 or wearable device. The input of the user may include various card information required for payment and other additional authentication information (e.g., PIN, user-specific pattern-related data, fingerprint recognition-related data, a touch input value of the display 160 or wearable device bezel unit).

According to an embodiment of the present disclosure, the electronic device 800 may share one piece of payment information with the wearable device or accessory. For example, information on one VISA™ card may be stored in both the wearable device and the electronic device 800. According to an embodiment of the present disclosure, the electronic device 800 may store different pieces of card information generated from one piece of card information in the wearable device and the accessory, respectively. For example, among different tokens issued from one piece of VISA™ card information, one token may be stored in the electronic device while the other token is stored in the accessory or wearable device. According to an embodiment of the present disclosure, when a different token issued from one piece of card information is stored in the electronic device while the other token is stored in the accessory or wearable device, if a payment module of one device is activated, a payment module of the other device may be deactivated. For example, among different tokens issued from one piece of VISA™ card information, if one token is stored in the electronic device 800 while the other token is stored in the accessory or wearable device, payment of the electronic device 800 may be deactivated when the payment is performed by the wearable device. In addition, when the payment is performed by the electronic device 800, payment by the wearable device may be deactivated.

According to an embodiment of the present disclosure, the payment manager 940 may include, for example, a payment relay module 941, a biometric information management module 943, and a security environment relay module 946. According to an embodiment of the present disclosure, the payment relay module 941 may relay a card or information (e.g., token) corresponding to the card to the payment application 930, the kernel 950, or the payment server 720. The payment relay module 941 may perform off-line payment through a communication module (e.g., NFC module or MST module). A payment method using the NFC module 820 can be operated through the POS device 740, and a payment method using the MST module 810 can be operated by a user input. Further, the payment relay module 941 may perform on-line payment through a communication module (e.g., cellular module, RF module, or Wi-Fi module).

According to an embodiment of the present disclosure, the payment relay module 941 may perform state management (e.g., card/token life cycle management) of a card or information (e.g., token) corresponding to the card. The payment relay module 941 may provide at least one API associated with payment to the payment application 930.

According to an embodiment of the present disclosure, the payment relay module 941 may further include at least one interface provided by system services associated with payment, and system service interfaces, which provide security UIs for a payment service for access to a payment module 921, trustzone-based integrity measurement architecture (TIMA) for kernel integrity authentication, fingerprint recognition result inquiry (e.g., supporting both the security and non-security mode), and PIN or PAN input. The payment relay module 941 may include an encryption library in order to transfer a message or command to the TEE 920. The payment relay module 941 may transmit or receive a message or command with the TEE 920 through the encryption library.

According to an embodiment of the present disclosure, the payment relay module 941 may include a card management function which provides addition, deletion, or update of a card, as a general card management function. The payment relay module 941 may include a first payment SDK or a second payment SDK. The first payment SDK (e.g., a Samsung SDK) may be embedded in the electronic device 800. The second payment SDK may be provided by a card company or bank and may be installed in the electronic device 800. From the first payment SDK or second payment SDK, the payment relay module 941 may select a payment SDK corresponding to card information. Further, the payment relay module 941 may set a basic card or select another card other than the basic card.

According to an embodiment of the present disclosure, the payment relay module 941 may transmit messages, such as token provisioning, token replenishment, token suspension, token resume, and token disposal, as a general token and key management function, to the payment server 720.

According to an embodiment of the present disclosure, the payment module 921 may acquire a token and a token cryptogram from the electronic device 800 or another external electronic device. A key (e.g., limited used key (LUK) or single used key) capable of generating the token or token cryptogram may be stored in the REE 910 or TEE 920. Moreover, when the token and the key are stored in the REE 910, the payment module 921 of the TEE 920 may encrypt and store the token and key, using the key (e.g., device root key (DRK)) of the TEE 920. When the electronic device 800 performs payment, the payment relay module 941 may acquire the encrypted token in a decrypted state through the payment module. When the token or key capable of generating the token cryptogram is stored in the TEE 920, the electronic device 800 may store the token or key in an encrypted form, using the key of the TEE 920.

According to an embodiment of the present disclosure, the payment relay module 941 may receive a push message from the TSP 730 and transfer the push message to the payment application.

According to an embodiment of the present disclosure, when the first payment SDK (provided by a card company or bank) provides a self-token management function, the payment relay module 941 may further include a function of relaying a token management function request to the second payment SDK when receiving the request. For example, the payment relay module 941 having acquired a token or key, using an SDK of VISA™ card, may transfer the token or key to the payment module 921 within the TEE 920, using a Samsung™ SDK. According to an embodiment of the present disclosure, the payment relay module 941 may further include, on a payment framework, a host card emulation (HCE) function which enables a virtual card to be used in the electronic device 800 by only software without a separate hardware device (e.g., a security module or a secure element (SE)) at the time of payment. The HCE function may transfer a token and a token cryptogram through a communication module (e.g., an NFC), using a message standard (e.g., application protocol data unit (APDU)) associated with the POS 740.

According to an embodiment of the present disclosure, the payment relay module 941 may include a function of processing a message received from the POS device 740. The POS-related message processing function may include a function of managing payment data to be transmitted to the POS device 740 as a response. The POS-related message analysis function may include a function of, when the first payment SDK provides a self POS-related message processing function, relaying the POS-related message to the first payment SDK. According to an embodiment of the present disclosure, the payment relay module 941 may include at least one database for storing the card data, token data, or transaction data.

According to an embodiment of the present disclosure, the payment relay module 941 may select at least one method among a method using NFC and a method using MST. For example, the methods may include a method of first performing payment using NFC and performing payment using MST, a method of first performing payment using MST and performing payment using NFC, and a method of performing payment simultaneously using NFC and MST. According to an embodiment of the present disclosure, in the case of first performing payment through one communication module and performing payment through another communication module, the payment relay module 941 may perform payment through the another communication module when there is no response to a result of payment performance from the communication module having first performed the payment or after passage of a certain time.

According to an embodiment of the present disclosure, in the case of having both token information and PAN information for one card, the payment relay module 941 may use at least one of them for payment. The payment relay module 941 may determine whether the POS device 740 can perform payment using PAN or using a token. For example, the electronic device 800 may receive payable information through a back light unit (BLE), and the payment relay module 941 may identify the information. Based on the identified information, the payment relay module 941 may perform the payment using a toke when the token is available for the payment and using PAN when the PAN is available for the payment.

According to an embodiment of the present disclosure, the payment relay module 941 may further include an SDK provided by a payment network. The SDK may further include token management, POS-related message processing, or token/card databases.

According to an embodiment of the present disclosure, the security environment relay module 946 may further include a function enabling a payment application to access a biometric information driver module 951 or a security environment driver module 953 in order to use functions provided by the payment module 921 or a biometric information module 925. The payment relay module 941 may include an encryption library in order to transfer a message or command to the security environment relay module 946. The payment relay module 941 may transmit or receive a message or command with the security environment relay module 946 through the encryption library.

Various embodiments of the present disclosure may further include a security environment relay module 946 connected to enable the payment application 930 to use functions of a security identifier processing module 923 of the TEE 920, in the payment manager 940. According to an embodiment of the present disclosure, the payment relay module 941 may include a function of relaying an authentication request through a PIN input by the payment application 930 to the security identifier processing module 923 of the TEE 920. When there is a request for fingerprint recognition, a general application may acquire information on whether the recognition is success or failure. The security payment application (payment trusted app) may acquire a security biometric result (secure fingerprint result). The security biometric result may have a form encrypted by combining a disposable random number and information of success/failure. The disposable random number may be encrypted through a hardware key (e.g., DRK) of the TEE 920.

According to an embodiment of the present disclosure, the payment relay module 941 may transfer a message requiring execution of payment to the payment module 921 through the security environment driver module 953 in order to perform payment. The payment module 921 may notify the payment relay module 941, through the security environment driver module 953, that an authentication operation is necessary. The payment relay module 941 may issue a command requiring the biometric sensor 807 to acquire biometric information through the biometric information management module 943 and the biometric information driver module 951. In addition, the payment relay module 941 may transfer an authentication identification message to the biometric information module 925 of the TEE 920 through the biometric information management module 943 and the security environment driver module 953. The biometric sensor 807 may be included in the biometric information module 925 of the TEE 920. The biometric information module 925 may identify a user's identity by comparing pre-stored biometric information of the user and information acquired by the biometric sensor. Based on the identified information, the biometric information module 925 may transfer success or failure of authentication to the biometric information management module 943 through the security environment driver module 953, and the biometric information management module 943 may transfer the received information to the payment relay module 941. The payment relay module 941 and the biometric information management module 943 may be configured to be integrated in a single construction or configured as separate modules.

According to an embodiment of the present disclosure, the payment relay module 941 may perform an authentication through an external device. For example, the electronic device 800 may request the payment server (e.g., a Samsung account server or token requester server) 720 to authenticate biometric information (e.g., fingerprint or iris). The payment server 720 may perform authentication of biometric information of a user and transfer a result of the authentication to the electronic device 800. When the authentication has been completed, the payment relay module 941 may perform a token provisioning process by transferring data including information that the authentication has been completed to the TSP. Further, according to a result of the authentication, the electronic device 800 may perform payment when the authentication is successfully completed, or may not perform payment when the authentication fails or is not completed.

According to an embodiment of the present disclosure, the kernel 950 may include, for example, the biometric information driver module 951 and the security environment driver module 953. The biometric information driver module 951 may transfer a message transferred from the biometric information management module 943 of the payment manager 940 to the biometric sensor 807. The biometric information obtained by the biometric sensor 807 may be transferred to the biometric information module 925 within the TEE 920 instead of being transferred to a module within the REE 910 through the biometric information driver module 951.

According to an embodiment of the present disclosure, the security environment driver module 953 may perform as an interface for transfer from a module in the REE 910 to a module in the TEE 920. For example, in the case of the trust zone of ARM corresponding to an embodiment of the TEE 920, the AP time-divisionally performs operations of the REE 910 and the TEE 920. Here, a separate data path for transferring a message from the REE 910 to the TEE 920 may implemented by hardware. In this event, a driver module for accessing the hardware may be the security environment driver module 953. The security environment driver module 953 may transfer a message relating to an operation of a module in the TEE 920 to a module in the REE 910.

According to an embodiment of the present disclosure, the TEE 920 may include, for example, the payment module 921, the security identifier processing module 923, the biometric information module 925, and a payment driver module 927. The electronic device 800 may store data requiring a relatively high security and perform related operations in a safe environment through the TEE 920. The TEE 920 may operate on an AP of the electronic device 800, and a reliable TEE 920 determined in the operation of manufacturing an electronic device 800 may refer to a security area within the electronic device 800. The electronic device 800 may store data requiring a relatively high security and perform related operations based on a safe hardware structure through the TEE 920. The TEE 920 may enable the AP and the memory area to operate in a state of being divided into a general area and a security area. Further, the TEE 920 may configure software or hardware requiring security, to operate in only the security area. When the REE 910 of an electronic device is required to perform an operation related to sensitive information, the electronic device may be allowed to access the TEE 920 only through an API and a driver capable of accessing the TEE 920. The TEE 920 may hand over limited data on related information to the REE 910. The TEE 920 may encrypt internally stored data through a hardware key (e.g., DRK). Without a separate decryption process, the REE 910 may unable to interpret data within the TEE 920.

An application (e.g., a security application or payment module) within the TEE 920 may transfer a message to another electronic device (e.g., the TSP 730) outside of the electronic device 800.

According to an embodiment of the present disclosure, the TEE 920 may include a trusted OS and a security application. In addition, the TEE 920 may include an encryption module related to the security, a driver capable of collecting data in hardware requiring security, and the like. The security application may include the payment module 921. In addition, the TEE 920 may transfer payment information to the outside through a communication module. For example, the TEE may transmit payment information to the POS device 740 by transferring the payment information to the MST module 810 through the MST control module 830 or transferring the payment information to the NFC module 820 through the NFC control module 840.

According to an embodiment of the present disclosure, the trusted application may determine whether the REE 910 has an integrity. The electronic device 800 may store, in the TEE 920, information on whether the REE 910 has an integrity. Booting of the REE 910 supporting the TEE 920 may follow a sequence in which a boot loader is first executed, the TEE 920 is booted, and the REE 910 is booted. When the TEE 920 has been booted, integrity information of the REE 910 is identified in the TEE 920, and the identified information may be notified to a user after the booting. According to an embodiment of the present disclosure, when the image of the REE 910 has been damaged due to hacking or rooting, it may be determined that the integrity of the REE 910 is problematic. When the integrity is problematic, the REE may be prohibited to access the TEE 920. For example, when the payment relay module 941 tries to transfer a message or command to the TEE 920 through the security environment driver module 953, the kernel 950 of the TEE 920 may disregard the message or command or deny to receive the message.

According to an embodiment of the present disclosure, the payment module 921 may be an application installed by a bank or card company (e.g., a VISA™ card or a MASTER™ card). There may be at least one payment module 921. When a user accesses, in the electronic device 800, the payment server (e.g., mobile application platform, payment gateway, token requester, TSP, trusted service manager, or bank server) 720 or the token provider 730, using the payment management module 931, and approves to install the payment module 921, the TSP 730 may perform operations associated with the installation. For example, the payment management module 931 may acquire a card number and valid term information of a plastic card through OCR, and perform a card registration operation for installing the payment module 921 in the payment server 720. The payment management module may connect to the TSP 730 in the network through the payment relay module 941 having connection information of the TSP 730 according to each card/bank company to receive an installation file, and the payment relay module 941 may transfer the information to the TEE 920 to install the payment module 921. The process described above may be called a provisioning process or card registration process. There may be a plurality of payment modules 921 of the TEE 920. Each payment module 921 is unable to exchange data within the TEE 920 and may be configured in an isolated form.

According to an embodiment of the present disclosure, the payment module 921 may be an application to be used for data communication with the payment server 720. The payment module 921 may include information of a credit card, a debit card, a membership card, and the like. The payment module 921 may communicate with another external electronic device through encryption. The encryption process may be different according to the card manufacturing company having transferred the payment module 921. The payment server 720 may control the state of the payment module 921. For example, the payment server 720 may activate, temporarily suspend, resume, or delete (dispose) the payment module 921.

According to an embodiment of the present disclosure, the payment module 921 may store information related to the card information. For example, the stored information may include at least one among a token, a token reference ID, a part of a PAN, a PAN product ID, a token requester ID, a token assurance level, token assurance data, a valid term of a token, an encryption key, and a value (e.g., one time password (OTP)) provided by the TSP 730, which correspond to the card information (e.g., PAN). The token may be controlled by the state of the TSP 730. For example, the token may be activated, temporarily suspended, resumed, or deleted (disposed). The token may be static information basically corresponding to the card information (e.g., PAN).

According to an embodiment of the present disclosure, the payment module 921 may determine a card to be used for payment. For example, a payment module 921 corresponding to a card selected by the user in at least one payment management module 931 may be determined according to a user's selection. The payment management module 931 may transfer the determined card to the payment relay module 941. The payment relay module 941 may transfer the determined card information to the payment module 921 through the security environment driver module 953. The payment module 921 may manage a list of cards actually used in the payment among possessed cards. The payment module 921 may change the list of cards actually used in the payment, based on the determined card information. The changing may include a method of raising the priority of the determined card information in the card list or a method of deleting the other card information except for the determined card information.

According to an embodiment of the present disclosure, the payment module 921 may generate information used for the payment based on the information associated with the card information when the payment is executed. Referring to Table 3, the information used for the payment may include a token, a token reference ID, a part of a PAN, a PAN product ID, a token requester ID, a token assurance level, token assurance data, a valid term of a token, a token cryptogram, a POS entry mode, a token requester indicator, and the like.

TABLE 3

| Field Name | Comment |
|---|---|
| Payment | The Payment Token number refers to a surrogate value for a PAN that is a |
| Token | 13 to 19-digit numeric value that passes basic validation rules of an account |
| | number, including the Luhn check digit. Payment Tokens are generated |
| | within a BIN range or Card range that has been designated as a Token BIN |
| | Range and flagged accordingly in all appropriate BIN tables. Payment |
| | Tokens are generated such that they will not have the same value as or |
| | conflict with a real PAN. |
| | Transaction messages |
| | The Payment Token number will be passed through the authorization, |
| | capture, clearing, and exception messages in lieu of the PAN. |
| | The Payment Token number may optionally be passed from the Token |
| | Service Provider to the Card Issuer as part of the authorization request. |
| Token Expiry | The expiration date of the Payment Token that is generated by and |
| Date | maintained in the Token Vault. The Token Expiry Date field carries a 4- |
| | digit numeric value that is consistent with the ISO 8583 format. |
| | Transaction messages |
| | The Token Expiry Date is passed in lieu of PAN Expiry Date. |
| | The value is replaced by the Token Service Provider with the PAN Expiry |
| | Date which is then passed to the Card Issuer as part of the authorization |
| | request. |
| Last 4 Digits | The last four digits of the PAN to be provided optionally through the |
| of PAN | Acquirer to the Merchant for customer service usage, such as being printed |
| | on the consumer receipt. |
| PAN Product | The last four digits of the PAN to be provided optionally through the |
| ID | Acquirer to the Merchant for customer service usage, such as being printed |
| | on the consumer receipt. |
| PAN Product | The PAN Product ID is an optional identifier used for determining the type |
| ID | of Card product that was tokenized. It may be included in cases where |
| | transparency of this information is necessary. |
| | Transaction messages |
| | The PAN Product ID may optionally be passed from the Token Service |
| | Provider to the Acquirer as part of the authorization response. |
| POS Entry | This specification uses the POS Entry Mode field to indicate the mode |
| Mode | through which the Payment Token is presented for payment. Each Payment |
| | Network will define and publish any new POS Entry Mode values as part |
| | of its existing message specifications and customer notification procedures. |
| | Transaction messages |
| | POS Entry Mode is an existing field that will be passed through the |
| | authorization, capture, clearing, and exception messages. |
| Token | This value uniquely identifies the pairing of Token Requestor with the |
| Requestor ID | Token Domain. Thus, if a given Token Requestor needs Tokens for |
| | multiple domains, it will have multiple Token Requestor IDs, one for each |
| | domain. It is an 11-digit numeric value assigned by the Token Service |
| | Provider and is unique within the Token Vault: |
| | Positions 1-3: Token Service Provider Code, unique to each Token Service |
| | Provider |
| | Positions 4-11: Assigned by the Token Service Provider for each |
| | requesting entity and Token Domain |
| | Transaction messages |
| | Token Requestor ID can be optionally passed through the authorization, |
| | capture, clearing, and exception messages. |
| Token | Token Assurance Level is a value that allows the Token Service Provider |
| Assurance | to indicate the confidence level of the Payment Token to PAN/Cardholder |
| Level | binding. It is determined as a result of the type of ID&V performed and the |
| | entity that performed it. |
| | The Token Assurance Level is set when issuing a Payment Token and may |
| | be updated if additional ID&V is performed. It is a two-digit value ranging |
| | from 00 which indicates the Payment Token has no ID&V that has been |
| | performed to a value of 99 indicating the highest possible assurance. The |
| | specific method to produce the value is defined by the Token Service |
| | Provider. |
| | Transaction messages |
| | Token Assurance Level will be provided by the Token Service Provider. |
| | The value may be optionally passed to the Card Issuer as part of the |
| | authorization request. |
| | The value may optionally be passed to the Acquirer/Merchant in the |
| | authorization response, capture, clearing, and exception processing |
| | messages. |
| Token | This data provided by the Token Service Provider contains supporting |
| Assurance | information for the Token Assurance Level. |
| Data | Transaction messages |
| | This data may be optionally passed to the Card Issuer as part of the |
| | authorization request. |
| Token | This cryptogram is uniquely generated by the Token Requester to validate |
| Cryptogram | authorized use of the Token. The cryptogram will be carried in different |
| | fields in the transaction message based on the type of transaction and |
| | associated use case: |
| | NFC contactless transactions will carry the Token Cryptogram in existing |
| | chip data fields. |
| | Other transactions, such as those originating from a digital wallet, may |
| | carry the Token Cryptogram in an existing field. |
| | Transaction messages |
| | The Token Cryptogram will be passed in the authorization request and |
| | validated by the Token Service Provider and/or the Card Issuer. |
| Token | An indicator used to indicate that the message is intended to authenticate |
| Request | the Cardholder during a Payment Token Request. |
| Indicator | |

According to an embodiment of the present disclosure, the payment module 921 may receive a key (e.g., LUK or single used key), by which a token cryptogram can be generated, through the TSP 730 or the payment server 720 (e.g., a payment service server or a token requester server). The key may be transferred and received through a data network or an SMS. The key may be exchanged using a security channel between the electronic device 800 and the TSP 730. The security channel may be a logical channel for encrypting data, which is exchanged by a separate key (e.g., a method using a public key or private key) different from the key described above. Moreover, the payment module 921 may include a module for generating a key capable of generating a token cryptogram. The electronic device 800 may receive the module for generating the key, through the TSP 730 or the payment server 720. Otherwise, the key may be included in the electronic device 800 in the stage of manufacturing the electronic device 800.

According to an embodiment of the present disclosure, the payment module 921 may generate a token cryptogram, using a key (e.g., a limited used key or a single used key) capable of generating the token cryptogram. The payment module 921 may use different keys according to a certain rule, for example, in each transaction, in a certain number of times of transaction, or a transaction within a particular time. The TSP 730 may possess a key paired with the above-described key. The TSP 730 may decrypt the encrypted token cryptogram through the paired key.

According to an embodiment of the present disclosure, the payment module 921 may generate a token cryptogram, using a key capable of generating the token cryptogram.

According to an embodiment of the present disclosure, when the payment is performed, the electronic device 800 may transfer a message reporting that the payment application will perform the payment, to the payment relay module 941. The payment relay module 941 may determine whether to use MST or NFC for the payment. In the case of using MST for the payment, the payment relay module may acquire information (e.g., token, token cryptogram, a part of PAN information, token valid period, and the like) necessary for payment from the payment module 921 of the TEE 920 and transfer the information to the payment driver module 927 in the TEE 920. The payment driver module 927 may transfer the information to the payment controller. The MST module 810 may transmit the information in order to perform payment.

According to an embodiment of the present disclosure, when using the NFC for the payment, the electronic device 800 may transfer the information necessary for the payment to the payment driver module 927 of the TEE 920. The payment driver module 927 may transfer information required for performing the payment to the NFC module 820. The NFC module 820 may perform the payment based on the information.

According to an embodiment of the present disclosure, in the case of using the NFC for the payment, the electronic device 800 may perform the payment when receiving a certain message from the POS device 740. For example, when the NFC module 820 detects a certain message transferred from the POS device 740, the NFC module 820 may transfer the message to the payment driver module 927. The payment driver module 927 may transfer information that the message has been received from the POS device 740, to the payment relay module 941 of the REE 910. The payment relay module 941 may generate a token cryptogram in order to perform payment. The token cryptogram may be generated in the payment module 921 of the TEE 920, using a key (e.g., a limited used key or a single used key) capable of generating the token cryptogram. The generated token cryptogram may be transferred to the REE 910. The payment relay module 941 may transfer payment-related information including the token and token cryptogram through a network module (e.g., an NFC-related host card emulation module). The network module may transfer the payment-related information to the POS device 740 through the NFC module 820.

According to an embodiment of the present disclosure, the payment module 921 may transfer information including the token, token valid period, token requester ID, and token cryptogram to an external electronic device. For example, the payment module 921 may transfer the payment information to the POS device 740 through the MST communication module. Further, the payment module 921 may transfer the payment information to the POS device 740 through the NFC communication module 820.

According to an embodiment of the present disclosure, the payment module 921 may transmit or receive certain information to or from the POS device 740 in the payment operation. In the case of NFC, the POS device 740 may first receive the information to perform the payment. In the case of MST, payment-related information including the token and token cryptogram may be transmitted, based on an explicit input from a user or an internal algorithm of the electronic device 800, to the POS device 740.

According to an embodiment of the present disclosure, the biometric information module 925 may store biometric information of a user of the electronic device 800 and compare the biometric information with information obtained by the biometric sensor to authenticate the user. The biometric information module 925 may include a fingerprint information module or an iris information module. The biometric information module may collect information from the biometric sensor 807. When the payment application 930 shows, through the display 160, contents requiring authentication of the biometric information of the user, the user may transfer the biometric information through the biometric sensor 807. The authentication module 935 of the payment application 930 may transfer, through the biometric information management module 943, a message requiring collection of biometric information to the biometric information driver module 951. The biometric information driver module 951 may transfer the message to the biometric sensor 807. The biometric sensor 807 may collect biometric information and transfer the collected information to the TEE 920. The biometric information module 925 of the TEE 920 may compare the collected biometric information with the stored biometric information of the user to determine whether to authenticate the biometric information, and may transfer a result of the determination to the authentication module 935 of the payment application 930 through the security environment driver module 953 and the biometric information management module 943 of the REE 910. The payment application 930 may show, to the display 160, whether to authenticate. The biometric information of the user may be stored in the TEE 920, stored in the REE 910 in an encrypted state, or stored in the security module (e.g., an eSE) 236.

According to an embodiment of the present disclosure, the security identifier processing module 923 may acquire, through a user input, an input value, which is necessary for the electronic device 800 or is associated with payment or authentication. For example, the input value may be a personal identification number (PIN) during payment. In addition, the input value may include information related to the card. For example, the information may include a PAN, a card valid term (expiration date), or card verification value (CVV). In addition, the information may include a Chip PIN or automated teller machine (ATM) PIN. The security identifier processing module 923 may be indicated in the form of an application. A graphic library necessary for illustration of the application of the security identifier processing module 923 on a screen may be stored in the TEE 920. The graphic library stored in the TEE 920 may be different from a graphic library in the REE 910. The security identifier processing module 923 may perform user authentication by an input value, such as a PIN, and may transfer a result of the authentication to the payment management module 931 through the payment relay module 941.

According to an embodiment of the present disclosure, the security identifier processing module 923 may receive an encrypted disposable random number (e.g., nonce) transferred through the security environment driver module 953 by the security environment relay module 946. The security identifier processing module 923 may encrypt the disposable random number and the input value acquired through the user input, using an encryption key (e.g., device root key) in the TEE 920, and transfer them to the security environment relay module 946. The security environment relay module 946 may transfer the encrypted input value and disposable random number to the payment module 921 through the security environment driver module 953. The payment module 921 may decrypt the input value and disposable random number, using a hardware key in the TEE 920. The payment module 921 may identify that the input value transferred through the REE 910 has an integrity, based on the point that the generated value and the received value of the disposable random number are the same. The payment module 921 may perform user authentication through the input value, based on the point that the input value has an integrity. The payment module 921 may perform payment through user authentication.

According to an embodiment of the present disclosure, a factory reset refers to an operation of returning a software image of the electronic device 800 to the original state at the time when the electronic device is shipped from a factory. This operation may be performed as an explicit operation of a user through an application. Moreover, a module for determining and monitoring a hacking by a certain condition (e.g., when it is determined that the system has been hacked) may perform a factory reset. When the operation is performed, data stored in the electronic device 800 is reset and the payment-related information of the user also may be thus reset. The payment-related information may be stored in the payment server 720. When the user accesses the payment server 720 based on an account, the user may be allowed to perform operations of registering a card and installing a payment module 921 again based on the payment-related information. When the data is reset, the payment-related module stored in the electronic device 800 may notify the TSP 730 of the resetting through the payment server 720 to deactivate the TSP. When a network of the electronic device 800 has been deactivated, it may be impossible to perform the operation of notification. In this event, the electronic device 800 may perform the factory reset and access the account of the payment server 720 based on an account. The electronic device 800 may identify a list of pre-registered cards through the payment server 720, and may deactivate a card module or token of the electronic device 800 pre-registered in the TSP 730 through the payment server 720. In addition, based on the card list of the payment server 720, the electronic device 800 may perform card registration again and receive a payment module 921, token, and the like.

According to an embodiment of the present disclosure, an electronic device includes a display, a communication interface, and a processor, wherein the processor is configured to transmit a user identifier to a server through the communication interface, receive information of at least one card associated with the user identifier from the server through the communication interface and display the received information on a display, select one piece of card information from the displayed information of the at least one card, and request, through the communication interface, the server to issue a token for payment, using at least a part of the selected card information.

According to an embodiment of the present disclosure, an electronic device includes a communication interface, and a processor, wherein the processor is configured to connect to another electronic device through the communication interface, using a user identifier, receive information of at least one card associated with the user identifier from the server through the communication interface as a response to a card information request from the electronic device through another electronic device, and request the server to issue a token for payment, using at least a part of the received information of the at least one card.

According to an embodiment of the present disclosure, an electronic device includes a communication interface, and a processor, wherein the processor is configured to connect to another electronic device through the communication interface, using a user identifier, receive information of at least one card associated with the user identifier from the another electronic device through the communication interface as a response to a card information request from the electronic device through the another electronic device, and request the server to issue a token for payment, using at least a part of the received information of the at least one card.

According to an embodiment of the present disclosure, the server may include a communication interface, and a processor, wherein the processor is configured to receive a user identifier from an electronic device through the communication interface, identify a card identifier associated with the user identifier, request, through the communication interface, an external device to provide information of at least one card associated with the card identifier, receive the information of the at least one card from the external device through the communication interface, and transmit the information of the at least one card to the electronic device through the communication interface.

According to an embodiment of the present disclosure, the external device may be a token server.

According to an embodiment of the present disclosure, the server may be a payment server.

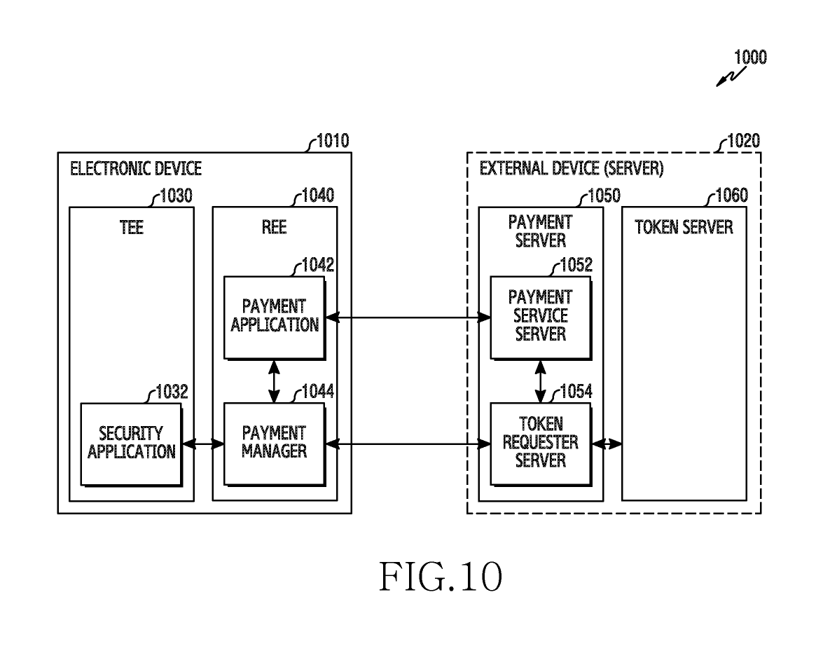

FIG. 10 is a block diagram illustrating a payment system according to various embodiments of the present disclosure.

Referring to FIG. 10, a payment system 1000 may include an electronic device 1010 and/or an external device 1020 (e.g., server). The electronic device 1010 may include, for example, a TEE 1030 and/or a REE 1040. The external device 1020 may include, for example, a server, and the server may include, for example, a payment server 1050 and/or a token server 1060. The payment server 1050 may include, for example, a payment service server 1052 or token requester server 1054.

According to various embodiments of the present disclosure, the TEE 1030 may include a security system related to the electronic device 1010. For example, the electronic device 1010 may protect information included or stored in the TEE 1030 from a control related to a request, a revision, or an input from the outside, using the TEE 1030.

According to an embodiment of the present disclosure, the TEE 1030 may include, for example, a program mode, the security of which has been reinforced. For example, using the TEE 1030, a normal area (world) and a security area (world) may be distinguished. The normal world may be referred to as the REE 1040. Further, the TEE 1030 may, for example, execute a reliable application or manage encrypted information. For example, the encrypted information may include token or key information.

According to an embodiment of the present disclosure, the TEE 1030 may protect the encrypted information from the outside. The token or key information may be used to encrypt the card information. For example, in relation to the token or key information, when the card information is provided to a device for payment, the card information may be at least partly changed rather than being directly provided to the device for payment. In changing the card information, the token or key information may be used. The key may be acquired from, for example, a service provider who provides a payment service. Further, the key may be managed by the electronic device 1010 or the server. According to an embodiment of the present disclosure, the TEE 1030 may include, for example, a security application (trusted application) 1032. The TEE 1030 may provide, for example, an environment in which the security application 1032 can be executed.

According to various embodiments of the present disclosure, the security application 1032 may include, for example, information related to a card company included in the TEE 1030. The information related to the card company may include, for example, an application related to the card company, and the application may be provided in a packaged form. The packaged form may be provided by a SDK.

According to various embodiments of the present disclosure, the security application 1032 may include, for example, an application or applet which should be executed in a mode, the security of which has been reinforced, likewise in the TEE 1030. Further, the security application 1032 may include, for example, an encryption-related function. For example, the security application 1032 may perform functions of generating, revising, or deleting a cryptogram related to the payment.

According to various embodiments of the present disclosure, the REE 1040 may include an application layer. For example, the REE 1040 may include an application and/or framework. The REE 1040 may allow access thereto from the outside or control thereof, differently from the TEE 1030. The REE 1040 may include, for example, a payment application (e.g., a wallet application) 1042 and/or a payment manager 1044. The payment application 1042 may perform, for example, functions of identification, OCR, or interfacing for payment by the payment application 1042. For example, the payment application 1042 may perform, for example, functions related to card registration or payment.

According to various embodiments of the present disclosure, the payment manager 1044 may include, for example, information related to a card company included in the REE 1040. The information related to the card company may include, for example, an application related to the card company, and the application may be provided in a packaged form. The packaged form may be provided by an SDK. The payment manager 1044 may include, for example, an encryption-related function. For example, the payment manager 1044 may perform functions of token ID management or card company channel establishment. Further, the payment manager 1044 may perform, for example, interfacing with the external device (e.g., a server) 1020. For example, the payment manager 1044 may provide an interface with a server (e.g., the payment server 1050) for a tokenization service.

According to various embodiments of the present disclosure, the payment manager 1044 may be functionally connected with and share information with the security application 1032. For example, the payment manager 1044 may perform interfacing with the security application 1032 for using (e.g., storing) the token or the key. Further, the security application 1032 may include information associated with a network service provider.

According to various embodiments of the present disclosure, the payment application 1042 and the payment manager 1044 may be functionally connected with each other, and the security application 1032 and the payment manager 1044 may be functionally connected with each other. For example, the payment manager 1044 may transfer information received from the outside to the payment application 1042 or the security application 1032 or transfer information received from the payment application 1042 or the security application 1032 to the outside. According to an embodiment of the present disclosure, the payment manager 1044 may share information related to payment with the security application 1032 or the payment application 1042.

According to various embodiments of the present disclosure, the electronic device 1010 may include an additional configuration or module, as well as the TEE 1030, the security application 1032, the REE 1040, the payment application 1042, and the payment manager 1044.

According to various embodiments of the present disclosure, the payment server 1050 is a management server for electronic payment or mobile payment and may transmit or receive information (e.g., token or key) related to payment to or from the electronic device 1010. Further, the payment service server 1052 and the token requester server 1054 included in the payment server 1050 are functionally connected with each other to share information relating to payment.

According to various embodiments of the present disclosure, the token server 1060 may be functionally connected to the token requester server 1054 to transmit or receive the information related to payment. For example, the token requester server 1054 and the token server 1060 may provide an interface for transfer of the token or the key.

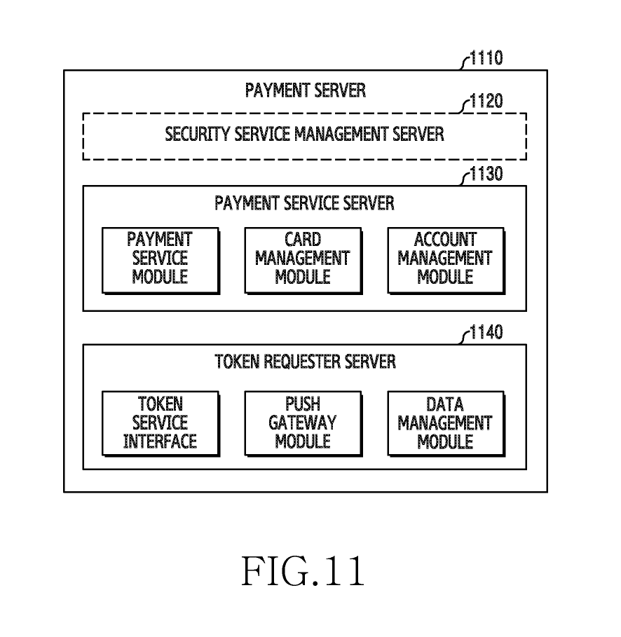

FIG. 11 is a block diagram illustrating a payment server according to various embodiments of the present disclosure.

Referring to FIG. 11, according to various embodiments of the present disclosure, a management server for payment, for example, a payment server 1110, may include a security service (e.g. a trusted service) management server 1120, a payment service server 1130, or a token requester server 1140. The payment service server 1130 may include, for example, at least one of a payment service module, a card management module, or an account management module. The account management module may include, for example, a Samsung account integration. According to an embodiment of the present disclosure, the token requester server 1140 may include at least one module among a payment service interface, a message gateway, or a data management module. The payment service interface may include, for example, a token service interface, and the message gateway may include, for example, a push gateway module. Further, the data management module may include, for example, a data management module.

According to various embodiments of the present disclosure, the security service management server 1120 may manage information relating to payment. For example, the security service management server 1120 may manage the information relating to the payment according to the kind (e.g., a security area or a non-security area) and/or configuration (e.g., a logical configuration or physical configuration) of the area in which the information related to the payment is stored. For example, when the area in which the information related to payment, for example, a token, is stored is a security module (e.g., an eSE) or an embedded subscriber identity module (eSIM), the security service management server 1120 may perform management of the token stored in the security module or eSIM. For example, the security module or eSIM may be included in the electronic device 800 or an external device (e.g., the first external electronic device 102, the second external electronic device 104, or the server 106 of FIG. 1).

According to various embodiments of the present disclosure, the security service management server 1120 may perform functions of the payment service server 1130 and/or the token requester server 1140. Further, the security service management server 1120 may be implemented separately from the payment service server 1130 and/or the token requester server 1140. For example, the payment service server 1130 and/or the token requester server 1140 may be included in a first server, while the security service management server 1120 may be included in a second server.

According to various embodiments of the present disclosure, the security service management server 1120 may control a storage area (e.g., memory) for storing the information (e.g., token or key) relating to payment in order to manage the information relating to payment. The storage area for storing the information relating to payment may include a key management module.

According to various embodiments of the present disclosure, the security service management server 1120 may manage, using the key management module, the token stored in the security module or eSIM. The storage area included in the security module or eSIM may include, for example, a supplementary secure domain (SSD). The SSD may be included in, for example, the electronic device 800 and may be generated using a key management module agent or client. The key management module agent or client may be functionally connected with the key managing module to perform a payment function.

According to various embodiments of the present disclosure, the electronic device 800 may include a certain key when the electronic device 800 is produced or processed. For example, the electronic device 800 may generate a master key in a certain area (e.g., security module or eSIM), using the certain key.

According to various embodiments of the present disclosure, the electronic device 800 may generate the SSD in the certain area, using the master key, in response to a request from the security service management server 1120. According to an embodiment of the present disclosure, the SSD may include a profile or an application (e.g., SDK) required for each bank or financial company to perform a payment function. The profile or application may be installed in the SSD through, for example, the security service management server 1120.

According to various embodiments of the present disclosure, the payment service module may be functionally connected to the payment application included in the electronic device 800 to provide an API for transmitting or receiving information related to payment. Further, the payment service module may record, for example, flows of information (e.g., data) related to payment. For example, the flows related to the payment may include payment result storage, transmission of payment details to the electronic device, or inquiry to payment history.

According to various embodiments of the present disclosure, the card management module may generate information on a card received from the payment application. For example, the card management module may generate resource ID related to the card information received from the payment application. The resource ID may be recorded as “resour.ID”. The card information from the payment application may be received by the payment service server 1130, for example, in response to a command (e.g., registration request) indicating a card for payment from a user. The resource ID may include, for example, a token ID or token reference. Further, the resource ID may include, for example, a plurality of token IDs or token references, and the plurality of token IDs or token references may include information corresponding to information of each card.

According to various embodiments of the present disclosure, the card management module may transfer the token ID or token reference to the token requester server 1140 included in the payment server 1110. For example, the card management module may transfer a request for registration of the card information to a token service interface included in the token requester server 1140.

According to various embodiments of the present disclosure, the card management module may manage an operation cycle (life cycle) of a card corresponding to the token ID or token reference. For example, the operation cycle of the card may include at least one of card registration, token issuance, token activation, or token removal.

According to various embodiments of the present disclosure, the account management module may manage an account corresponding to a registered card, using the card management module. For example, the account management module may provide a payment service by linking a card registered in the payment server 1110 with a service account (e.g., a Samsung account). Further, the account management module may perform, for example, functions of account registration, login, authentication, or generation of a security area. Further, the account management module may manage, for example, at least one policy among policies according to countries, devices, or card companies.

According to various embodiments of the present disclosure, the token requester server 1140 may be functionally connected to the token server to perform at least one of issuance, removal, or activation of a token, and may interwork with the security service management server 1120 to store a token in the security area (e.g., TEE) of the electronic device 800. Further, the token requester server 1140 may manage, for example, a security channel with the token server, and perform data collection, ingestion, or service function of the information related to payment.

According to various embodiments of the present disclosure, the token service interface may transfer a request associated with the token received from the electronic device to the token server, and transfer a response to the request, received from the token server, to the electronic device. Further, the token service interface may manage, for example, the security of a channel functionally connected to the token server.

According to various embodiments of the present disclosure, the push gateway module may perform a path function for transferring a message associated with the token from the token server to the electronic device 800.

According to various embodiments of the present disclosure, the data management module may manage data (e.g., card information or user information) used in the token requester server 1140. Further, the data management module may provide, for example, a mapping table including card information (e.g., PAN), payment application information, a user, or an electronic device 800. For example, the data management module may store, in the form of a table, at least one of a PAN, payment application information, user information, device information, and token information.

According to various embodiments of the present disclosure, the token requester server 1140 may identify the mapping table related to the token, using the data management module. In addition, the payment service server 1130 may include information related to an electronic device 800 or account. For example, the payment system may perform user authentication, using the mapping table and the information related to an electronic device 800 or account.

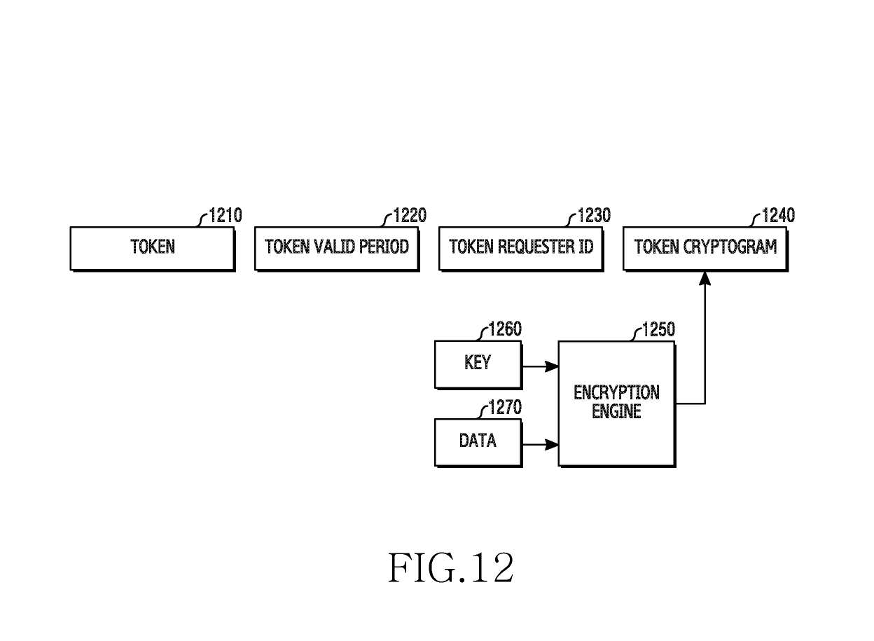

FIG. 12 is a block diagram illustrating a method of generating a token cryptogram according to various embodiments of the present disclosure.

Referring to FIG. 12, the payment module 921 may store a token 1210, a token valid period 1220, a token requester ID 1230, and a token cryptogram 1240 from the electronic device 800 or another external electronic device. The payment module 921 may generate the token cryptogram 1240, using a key 1260 and data 1270. For example, an encryption engine 1250 may encrypt the token cryptogram 1240, based on the key 1260 and the data 1270. The payment module 921 may use different keys 1260 according to a certain rule, for example, in each transaction, in a certain number of times of transaction, or a transaction within a particular time. The data 1270 and the encryption engine 1250 may change into a wide variety of types according to the encryption method (e.g., AES, TKIP, and the like).

The TSP 730 may possess a key paired with the above-described key 1260. The TSP 730 may decrypt the encrypted token cryptogram 1240 through the paired key.

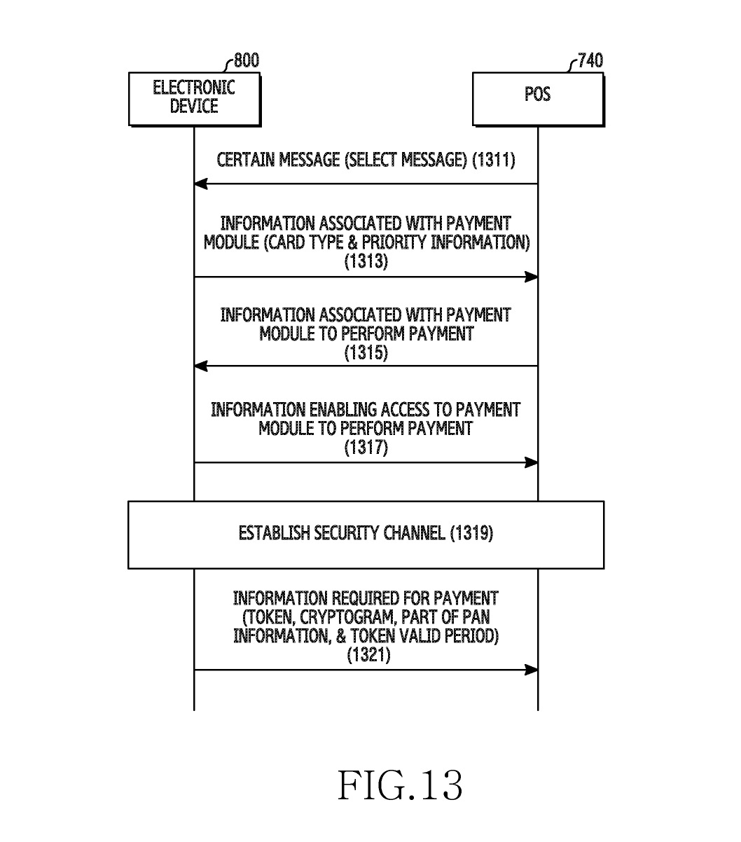

FIG. 13 is a signal flow diagram illustrating a communication method for payment between an electronic device and a POS device according to various embodiments of the present disclosure. For example, the electronic device may be an electronic device 800 of FIG. 8.

Referring to FIG. 13, the payment module 921 may transmit or receive certain information to or from the POS device 740 in the payment operation. In the case of NFC, the POS device 740 may first receive the information to perform the payment. In the case of MST, payment-related information including the token 1210 and token cryptogram 1240 may be transmitted, based on an explicit input from a user or an internal algorithm of the electronic device 800, to the POS device 740.

According to an embodiment of the present disclosure, in the case of using the NFC for the payment, the electronic device 800 may transmit or receive at least one message.

In operation 1311, the electronic device 800 may receive a message determined by the POS device 740.

In operation 1313, the electronic device 800 may transmit information (e.g., card type and priority information) associated with the payment module 921 to the POS device 740 based on the certain message.

In operation 1315, the POS device 740 may determine a payment module 921 to perform the payment, based on information associated with the payment module 921. The POS device 740 may transfer the information associated with the determined payment module 921 to the electronic device 800.

In operation 1317, the electronic device 800 may transfer the information enabling access to the determined payment module 921 to the POS device 740.

In operation 1319, the POS device 740 may establish a security channel between the electronic device 800 and the POS device 740 based on the information enabling the access. To this end, the electronic device 800 and the POS device 740 may exchange at least one key 1260 capable of establishing a security channel. The above process may be a process of exchanging at least one message.

In operation 1321, the electronic device 800 may transmit information (e.g., token 1210, token cryptogram 1240, a part of PAN information, or token valid period 1220) necessary for payment to the POS device 740 through the security channel.

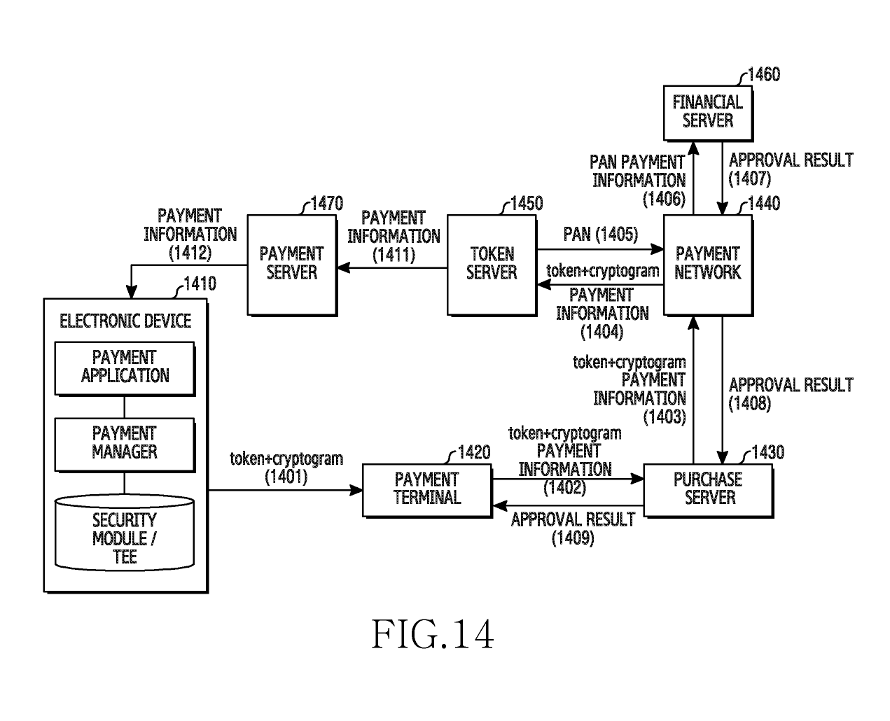

FIG. 14 is a block diagram illustrating a token payment flow in a payment system according to various embodiments of the present disclosure.

Referring to FIG. 14, the payment system may include an electronic device 1410, a payment server 1470, a token server 1450, a POS device 1420, a financial server 1460, a purchase server (acquirer) 1430, or a payment network 1440. The electronic device 1410 may include, for example, a payment application, a payment manager, or a security area (e.g., a security module or a TEE). The POS device 1420 may include, for example, a sales time point information management system. The POS device 1420 may be, for example, a combination of functions of a cash register and a computer electronic device, and a user can perform a payment function using the POS device 1420. The financial server 1460 may include, for example, a bank or financial company for issuing a card, and may perform identification of the card. Further, the financial server may proceed approval of the card at the time of payment. The purchase server 1430 may include, for example, a bank or financial company which purchases a transaction sheet for the card transaction paid in a shop (e.g., the POS device 1420). The payment network 1440 may include, for example, a card network.

According to various embodiments of the present disclosure, in operation 1401, the electronic device 1410 may transfer a token and/or encryption information (e.g., cryptogram) to a payment terminal (e.g., the POS terminal 1420). For example, the token may be stored in the electronic device 1410. Further, the token may be stored in an encrypted area of the electronic device 1410. For example, the electronic device 1410 may encrypt and store the token in the security module or the TEE 920. For example, the electronic device 1410 may generate encryption information, using a key received from the outside or a key generated by the electronic device 1410. The security information may include a cryptogram. Further, the electronic device 1410 may transfer the cryptogram and/or the token to the payment terminal 1420.

According to various embodiments of the present disclosure, the electronic device 1410 may use various communication connections in order to transfer the token and/or cryptogram to the payment terminal 1420. The communication connections may include, for example, NFC, MST, barcode, or quick response (QR) code.

According to various embodiments of the present disclosure, in operation 1402, the payment terminal 1420 may transfer at least one among the token, the encryption information, and the payment information to the purchase server 1430. For example, the payment terminal 1420 may transfer the token and/or the cryptogram received from the electronic device 1410 and the payment information (e.g., payment location, payment date, or payment amount) acquired from the payment terminal 1420 to the purchase server 1430. Further, the payment information may be, for example, acquired from the payment terminal 1420 or received from an external device, and may include payment details relating to a payment function requested by the user. Further, the payment information may include, for example, payment history performed using the payment system 700.

According to various embodiments of the present disclosure, in operation 1403, the purchase device 1430 may transfer, for example, at least one among the token, the encryption information, and the payment information to the payment network 1440. The purchase server 1430 may receive at least one among the token, the password information, and the payment information, and transfer at least one among the received token, password information, and payment information to the payment network 1440.

According to various embodiments of the present disclosure, in operation 1404, the payment network 1440 may transmit, for example, at least one among the token, the encryption information, and the payment information to the token server 1450. The payment network 1440 may include a network associated with a card company, for example, VISA™, Master Card™, or Amex™.

According to an embodiment of the present disclosure, the payment network 1440 may include or operate the token server 1450.

According to various embodiments of the present disclosure, the token server 1450 may receive at least one of the token, the encryption information, and the payment information from the payment network 1440. The token server 1450 may identify information on the received token. For example, the token server 1450 may use the token to identify card information (e.g., card number (PAN), expiration date) corresponding to the token. For example, the token server 1450 may identify a PAN corresponding to the financial server 1460, using information (e.g., Data) included in the token. The token server 1450 may, for example, identify a PAN corresponding to the financial server 1460 and use the PAN to get payment authentication from the financial server 1460.

According to various embodiments of the present disclosure, the token server 1450 may identify the PAN, using the received cryptogram.

According to various embodiments of the present disclosure, in operation 1405, the token server 1450 may transfer the PAN to the payment network 1440.

According to an embodiment of the present disclosure, the payment network 1440 may receive the PAN from, for example, the token server 1450.

In operation 1406, the payment network 1440 may transfer the PAN and/or the payment information to the financial server 1460. According to various embodiments of the present disclosure, the financial server 1460 may receive the PAN and/or the payment information from the payment network 1440.

For example, the financial server 1460 may determine whether to approve the payment, using the PAN and/or the payment information. For example, the financial server 1460 may use the PAN and/or the payment information to determine whether it coincides (e.g., valid PAN) with information included in the financial server 1460. The financial server 1460 may determine whether a database storing the PAN includes a PAN coinciding with the received PAN, and may identify payment restriction information (e.g., payment limit or foreign approval-or-not) associated with the coinciding PAN.

For example, the financial server 1460 may determine whether to approve the payment, by determining whether the payment information satisfies the identified payment restriction information. The financial server 1460 may approve the payment when the PAN and/or the payment information coincides with the information included in the financial server 1460. Meanwhile, the financial server 1460 may reject the payment when the PAN and/or the payment information does not coincide with the information included in the financial server 1460. The rejection of the payment may refer to unapproval of the payment (e.g., unapproval or rejection).

According to various embodiments of the present disclosure, in operation 1407, the financial server 1460 may transfer a result of the approval determination (e.g., approval or rejection) to the payment network 1440.

According to various embodiments of the present disclosure, in operation 1408, the payment network 1440 may transfer the approval result to the purchase server 1430. Further, the payment network 1440 may transfer the payment information to the token server 1450, when the approval result corresponds to approval.

According to various embodiments of the present disclosure, in operation 1409, the purchase server 1430 may transfer the approval result received from the payment network 1440 to the payment terminal 1420. In operation 1411, the token server 1450 may transfer, for example, the payment information to the payment server 1470.

According to various embodiments of the present disclosure, in operation 1412, the payment server 1470 may transfer, for example, the payment information to the electronic device 1410. For example, the payment server 1470 may transfer the payment information to the electronic device 1410, using a certain command (e.g., a push message). The payment information may include payment location, payment date, payment amount, and total payment amount.

Although the purchase server 1430, the token server 1450, the financial server 1460, and the payment server 1470 are separately illustrated and described in the above description, the purchase server 1430, the token server 1450, the financial server 1460, and the payment server 1470 may be configured in one unit according to embodiments of the present disclosure.

According to various embodiments of the present disclosure, the electronic device 1410 may display the payment information on the display 160. For example, the electronic device 1410 may display the payment information, using the payment application included in the electronic device 1410, or display the payment information through an interface associated with a payment function. The interface associated with the payment function may include a notification bar.

According to various embodiments of the present disclosure, the electronic device 1410 may display the payment information or information (e.g., payment state, payment history, or accumulated amount) associated with the payment through a display 160 functionally connected to the electronic device 1410. For example, the electronic device 1410 may use a notification module (e.g., the notification manager 349 of FIG. 3) of the electronic device 1410 to display payment information or the information associated with the payment. Further, in the electronic device 1410, the payment information or the information associated with the payment may be displayed using at least one among, for example, a notification, an indicator, a status bar, a task bar, an icon, a floating icon, a tile, and a widget, and may be displayed in a partial area of at least one among a home screen, a lock screen, and a curved display.

According to various embodiments of the present disclosure, the electronic device 1410 may output a sound notifying of the payment information or the information associated with the payment through an audio module (e.g., the audio module 280 of FIG. 2 and/or a motor (e.g., the motor 298 of FIG. 2, a tactile feedback device (not shown), a friction display (not shown)) functionally connected to the electronic device 1410, or generate vibration or haptic effect notifying of the information.

According to various embodiments of the present disclosure, a payment card industry (PCI) for a protocol for a payment card exists, and the payment terminal 1420 should satisfy the requirements by a PIN transaction security (PTS) for payment transaction. For example, the payment terminal 1420 should follow a contingency mechanism, which can monitor physically sensitive data (e.g., card information and signature information) in order to physically protect the physically sensitive data and, when an intrusion is deleted, can delete the data to preclude the possibility of restoration of the sensitive data. Further, the payment terminal 1420 should discriminate between applications in executing each application, and follow requirements that it should be impossible to monitor, collide with, or revise another application or OS. Further, as firmware is authenticated when the firmware is updated, the payment terminal 1420 should identify cryptological authentication of firmware in installing all applications in a corresponding terminal.

Further, an OS of the payment terminal 1420 may include only software necessary for an intended function. An OS of the payment terminal 1420 should be safely configured and be executed by least authority. An OS of the payment terminal 1420 should not allow an unauthenticated or unnecessary function for a security policy performed by a device. An OS of the payment terminal 1420 should disable or, if possible, delete an unrequired API or commands for supporting a special function.

Therefore, in order to use the electronic device 1410 as the payment terminal 1420, the requirements described above should be satisfied.

According to various embodiments of the present disclosure, the electronic device 1410 may implement an input of PIN, and the like, as a trusted input to safely read a physical signature or the PIN input, entering through a touch screen and a trust zone, and directly bring it into the trust zone. Meanwhile, at the time of processing the payment mode, the electronic device 1410 may configure a tone or screen displayed on a display 160 differently from a general mode, to enable a user to recognize the tone or screen. Hereinafter, an operation method for using the electronic device 1410 as the payment terminal 1420 will be described below. Hereinafter, an operation method for using the electronic device 1410 as a payment terminal 1420 will be described below.

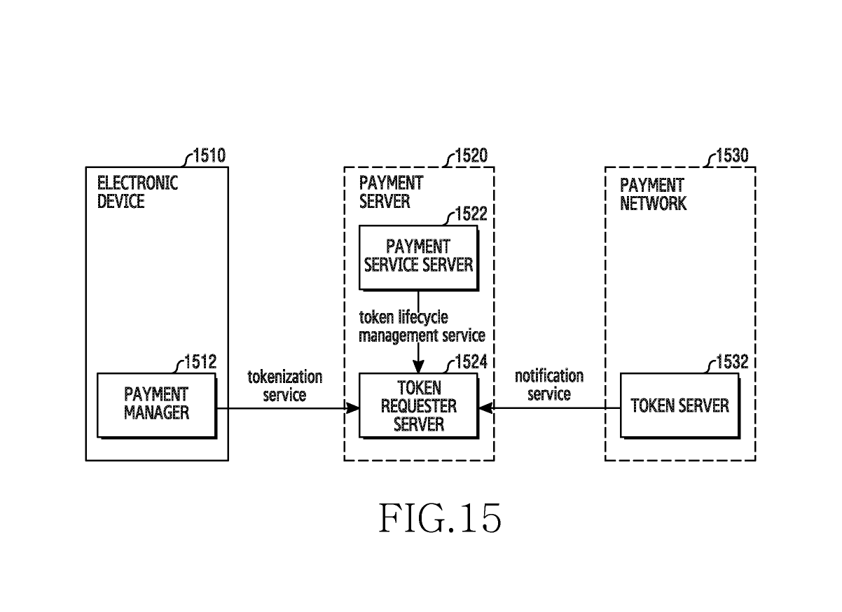

FIG. 15 is a block diagram illustrating a signal flow of an operation of a payment system according to various embodiments of the present disclosure.

Referring to FIG. 15, the payment system may include an electronic device 1510, a payment server 1520, and/or a payment network 1530. The electronic device 1510 may include, for example, a payment manager 1512. The payment server 1520 may include, for example, a payment service server 1522 or a token requester server 1524. The payment network 1530 may include, for example, a token server 1532. The payment system may use, for example, the token for the functions performed by each of the electronic device 1510, the payment server 1520, and/or the payment network 1530.

According to various embodiments of the present disclosure, the electronic device 1510 may provide a tokenization service associated with the token, using the payment manager 1512 included in the electronic device 1510 and the token requester server 1524 included in the payment server 1520.

According to various embodiments of the present disclosure, the payment management server 1522 may provide an operation cycle (e.g., token life management) associated with a token, using the token requester server 1524 included in the payment server 1520.

According to various embodiments of the present disclosure, the token server 1532 may provide a notification service associated with the token, using the token requester server 1524.

According to various embodiments of the present disclosure, the token requester server 1524 may provide a payment method to the electronic device 1510, using a payment network solution. For example, the token requester server 1524 may determine a payment method proper for the user, using the tokenization service, an operating cycle associated with the token, and/or a notification service associated with the token.

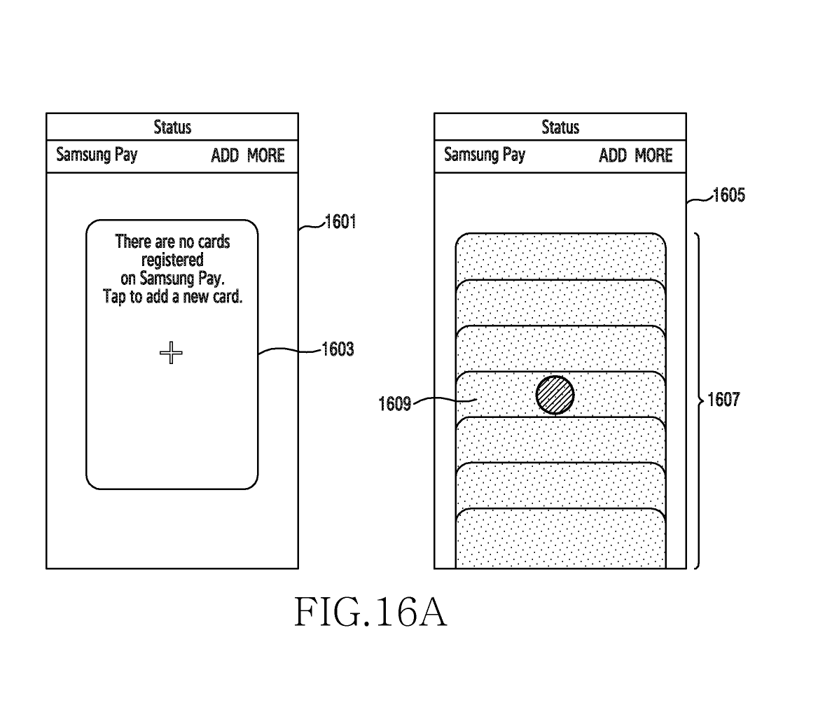

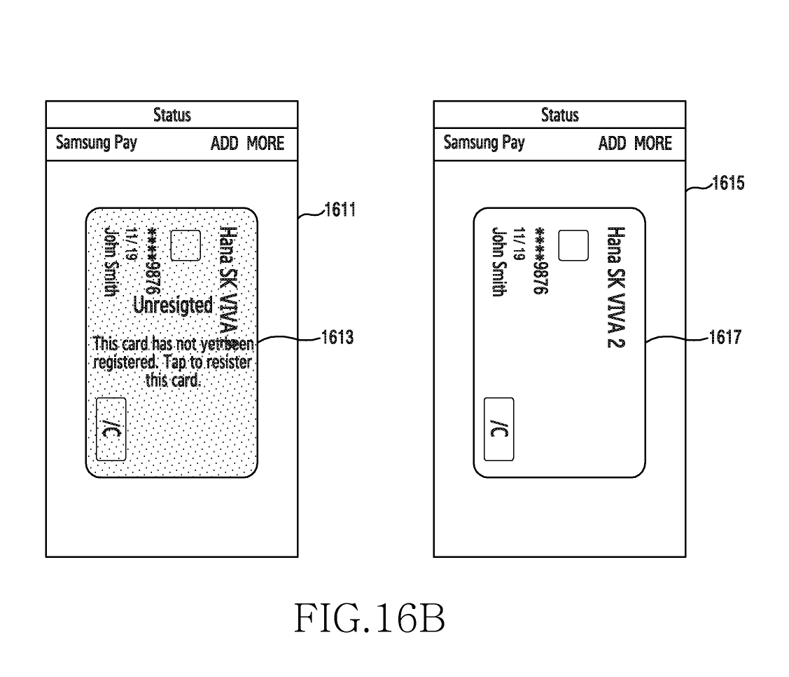

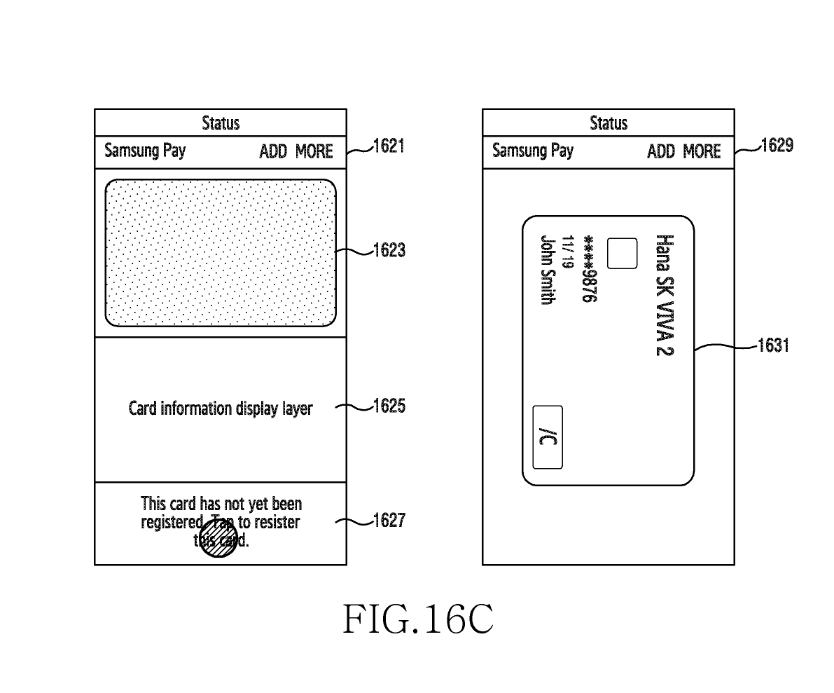

FIGS. 16A to 16C illustrate screen configurations for registering a card associated with a user account in an electronic device according to various embodiments of the present disclosure. For example, the electronic device may be the electronic device 710 illustrated in FIG. 7.

According to an embodiment of the present disclosure, when a user attempts to initially register a card in the electronic device 710, the electronic device 710 may transmit an input user account to the payment server 720. For example, the attempt of the initial card registration may refer to an attempt of registration of a card in the electronic device 710 in a state where no card has been stored therein.

Referring to FIG. 16A, for example, when there is no card registered in a payment application (e.g., Samsung Pay™), the electronic device 710 may display an image 1603 as shown in screen 1601 of FIG. 16A. For example, the image 1603 may include a message 1603 reading “No card has been registered in the payment application yet. Please tap the image 1603 in order to register a new card”. When the image 1603 is tapped by the user, the electronic device 710 may determine that the user is attempting to register a new card, and may transmit an input user account to the payment server 720.

According to an embodiment of the present disclosure, the electronic device 710 may receive and display at least one piece of card information from the payment server 720.

Referring to FIG. 16A, for example, the electronic device 710 may display a plurality of overlapping card images 1607 included in multiple pieces of card information as shown in the screen 1605 of FIG. 16A. For example, in order to express that a plurality of cards have not been registered yet, the electronic device 710 may display a plurality of card images 1607 in a particular color (e.g., gray color) or display the images to have at least one of a different color, a different transparency, a different size, and a different text from those of a registered card.

Referring to FIG. 16B, for example, when one card image 1609 is selected from a plurality of card images 1607 by a user, the electronic device 710 may display card information associated with the selected card image. For example, as shown in the screen 1611 of FIG. 16B, the electronic device 710 may display related card information on the selected card image 1613. As another example, as shown in the screen 1621 of FIG. 16C, the electronic device 710 may display a particular window 1625 including related card information, separately from the selected card image 1623.

According to an embodiment of the present disclosure, when the user selects a card to be registered, the electronic device 710 may proceed with a card registration procedure, based on card information associated with the selected card.

Referring to FIG. 16B, for example, as shown in the screen 1611 of FIG. 16B, when the card image 1613 has been tapped by the user, the electronic device 710 may determine a card corresponding to the card image 1613 as the card to be registered, and may perform a card registration process based on card information corresponding to the card image 1613.

Referring to FIG. 16C, as another example, as shown in the screen 1621 of FIG. 16C, when the card registration menu 1627 has been tapped by the user, the electronic device 710 may determine a card corresponding to the card image 1623 as the card to be registered, and may perform a card registration process based on card information corresponding to the card image 1623.

According to an embodiment of the present disclosure, when the card registration has been completed, the electronic device 710 may display an image of the registered card. For example, in order to express that a card has been registered in the electronic device 710, the electronic device 710 may display an image of the registered card in a particular color (e.g., a color different from that of unregistered cards) or display the image to have at least one of a different transparency, a different size, and a different text from those of the unregistered card.

Referring to FIG. 16C, for example, when the card registration has been completed, the electronic device 710 may display the image 1617 or 1631 of the registered card in the same color as that of the real card as shown in the screen 1615 of FIG. 16B or the screen 1629 of FIG. 16C.

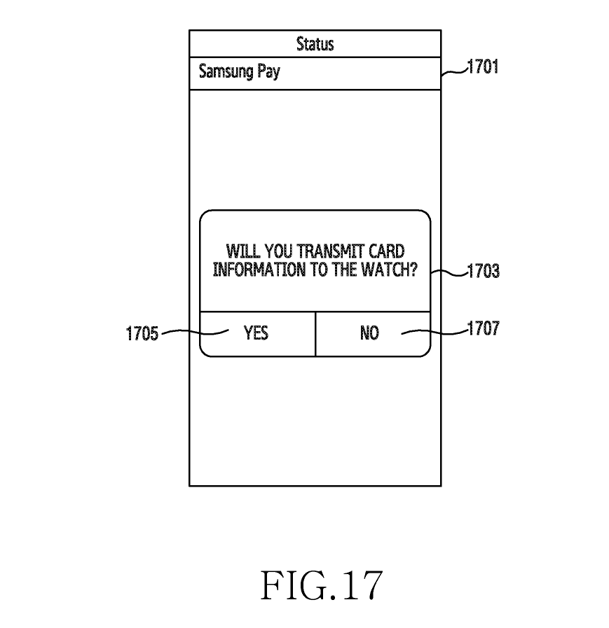

FIG. 17 illustrates a screen configuration for transmitting card information in an electronic device according to various embodiments of the present disclosure. For example, the electronic device may be the electronic device 710 illustrated in FIG. 7.

Referring to FIG. 17, according to an embodiment of the present disclosure, the user may use a plurality of electronic devices (e.g., the electronic device 710) and wearable devices 750. The plurality of electronic devices may be managed and used by a user through an identical user ID. The plurality of electronic devices may have been paired or connected with each other wiredly or wirelessly through BT, BLE, Wi-Fi, ZIGBEE, USB, IEE1394, and the like.

According to an embodiment of the present disclosure, the electronic device 710 may directly or indirectly transmit card information to another device according to a user's request. For example, the electronic device may receive, from a user, a determination on whether to transmit the card information or may automatically transmit the card information to another device without the user's determination.

For example, when card information is received from the payment server (e.g., the payment server 720), the electronic device 710 may display a message 1703 inquiring whether to transmit the received card information to the wearable device 750 (e.g., a watch device), as in a screen 1701 of FIG. 17.

For example, when a denial 1707 of the transmission of the card information is received from the user, the electronic device 710 may not transmit the card information to the wearable device 750.

For example, when an approval 1705 of the transmission of the card information is received from the user, the electronic device 710 may directly transmit the received card information to the wearable device 750. In this event, the electronic device 710 may directly transmit the card information through a communication network (e.g., 2G, 3G, 4G, or LTE) or a short-range wireless communication (e.g., BT, BLE, Wi-Fi, ZIGBEE, or Li-Fi).

As another example, when the approval 1705 of the transmission of the card information is received, the electronic device 710 may request, through the payment server 720, the card information from the token server 730. Thereafter, the token server 730 may directly or indirectly transmit the card information to the wearable device 750. For example, the token server 730 may transmit the card information to the wearable device 750 through the payment server 720. As another example, the token server 730 may directly transmit the card information to the wearable device 750. In this event, the token server 730 may directly transmit the card information through a communication network (e.g., 2G, 3G, 4G, or LTE).

According to an embodiment of the present disclosure, the wearable device 750 may receive and store the card information.

According to an embodiment of the present disclosure, after the card issuance in the electronic device 710 is completed, the token server 730 may directly or indirectly transmit the card information to the wearable device 750.

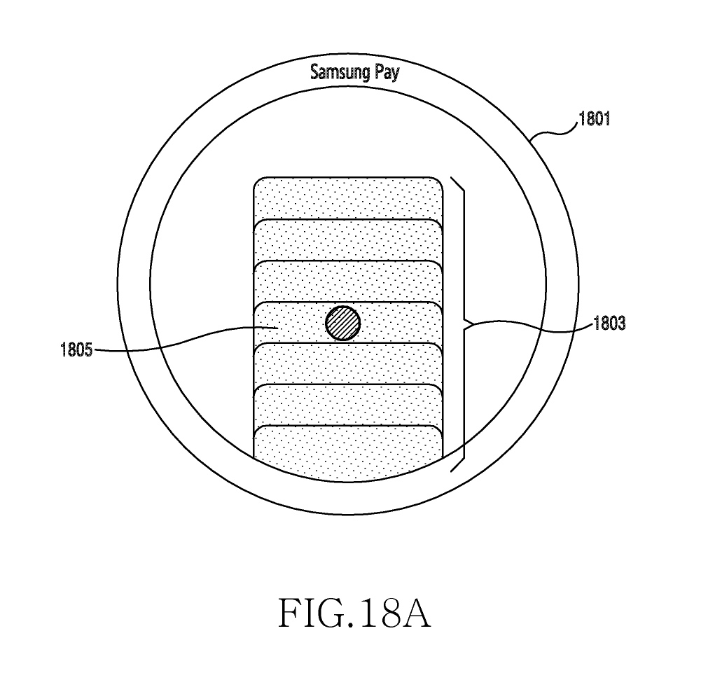

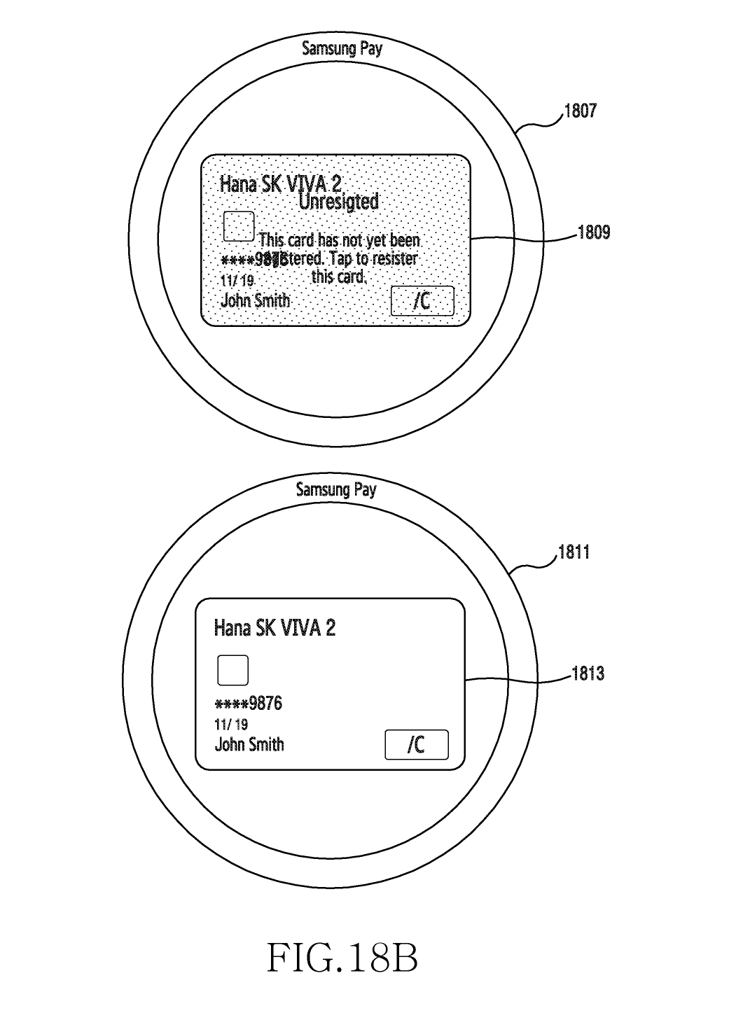

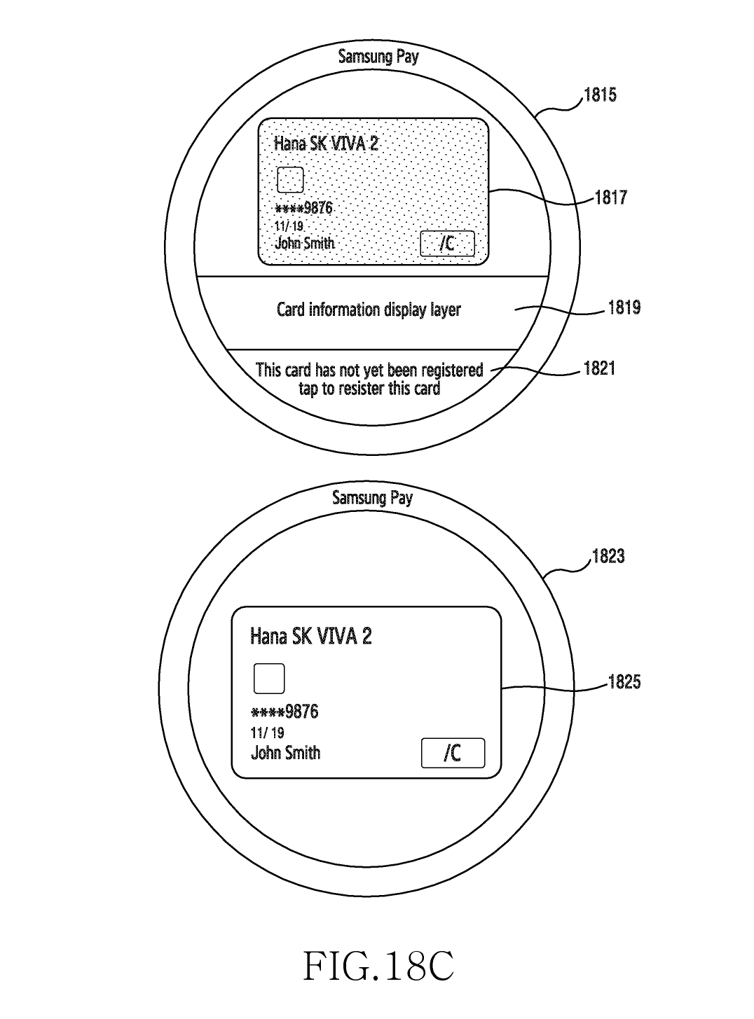

FIGS. 18A to 18C illustrate screen configurations for registering a card associated with a user account in an electronic device according to various embodiments. For example, the electronic device may be the wearable device 750 illustrated in FIG. 7.

According to an embodiment of the present disclosure, when a payment application is executed, the wearable device 750 may display card information. For example, as soon as the reception and storage of the card information is completed, the wearable device 750 may automatically execute the payment application and display the card information. As another example, when there is a first request for execution of the payment application by the user after the wearable device 750 stores the card information, the wearable device 750 may execute the payment application and display the card information.

Referring to FIG. 18A, for example, the wearable device 750 may display a plurality of overlapping card images 1803 included in multiple pieces of card information as shown in a screen 1801 of FIG. 18A. For example, in order to express that a plurality of cards have not been registered yet, the wearable device 750 may display a plurality of card images 1803 in a particular color (e.g., gray color) or display the images to have at least one of a different color, a different transparency, a different size, and a different text from those of a registered card.

Referring to FIG. 18B, for example, when one card image 1805 is selected from a plurality of card images 1803 by a user, the wearable device 750 may display card information associated with the selected card image. For example, as shown in a screen 1807 of FIG. 18B, the wearable device 750 may display related card information on a selected card image 1809.

Referring to FIG. 18C, as another example, as shown in a screen 1815 of FIG. 18C, the wearable device 750 may display a particular window 1819 including related card information, separately from a selected card image 1817.

Referring to FIG. 18B, according to an embodiment of the present disclosure, when the user selects a card to be registered, the wearable device 750 may proceed with a card registration procedure, based on card information associated with the selected card. For example, as shown in the screen 1807 of FIG. 18B, when the card image 1809 has been tapped by the user, the wearable device 750 may determine a card corresponding to the card image 1809 as the card to be registered, and may perform a card registration process based on card information corresponding to the card image 1809.

Referring to FIG. 18C, as another example, as shown in the screen 1815 of FIG. 18C, when a card registration menu 1821 has been tapped by the user, the wearable device 750 may determine a card corresponding to the card image 1817 as the card to be registered, and may perform a card registration process based on card information corresponding to the card image 1817.

According to an embodiment of the present disclosure, when the card registration has been completed, the wearable device 750 may display an image of the registered card. For example, in order to express that a card has been registered in the wearable device 750, the wearable device 750 may display an image of the registered card in a particular color (e.g., a color different from that of unregistered cards) or display the image to have at least one of a different transparency, a different size, and a different text from those of the unregistered card.

For example, when the card registration has been completed, the wearable device 750 may display an image 1813 or 1825 of the registered card in the same color as that of the real card, as shown in a screen 1811 of FIG. 18B or a screen 1823 of FIG. 18C.

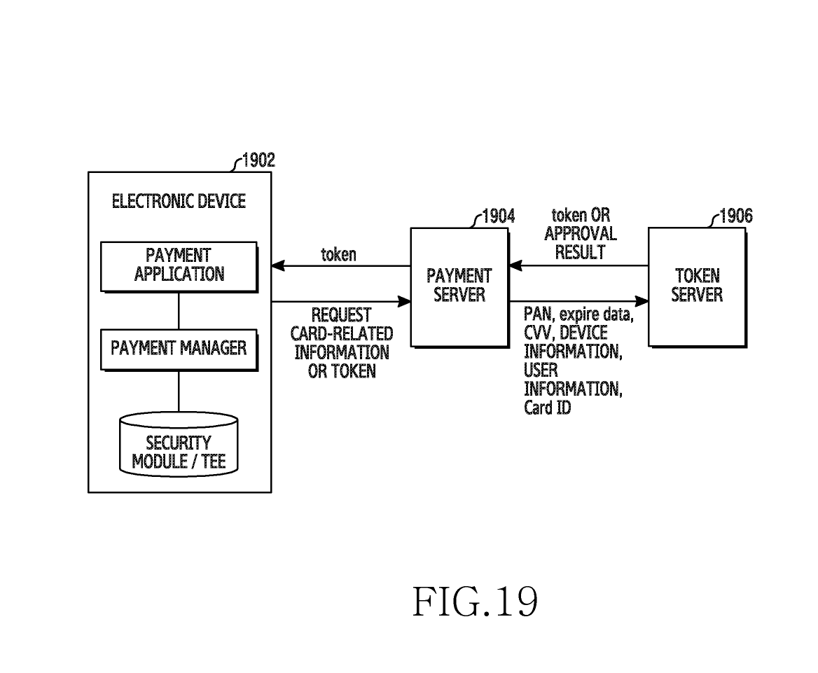

FIG. 19 illustrates a signal flow diagram illustrating a token issuance operation in an electronic device according to various embodiments of the present disclosure.

According to an embodiment of the present disclosure, the token issuance operation may be changed according to the country. For example, the token issuance operation may be changed based on the United States of America, Europe, or Republic of Korea.

Referring to FIG. 19, the payment system may include an electronic device 1902, a payment server 1904, or a token server 1906. The electronic device 1902 may include, for example, at least one of a payment application, a payment manager, a security module, and a TEE.

According to an embodiment of the present disclosure, the electronic device 1902 may acquire card-related information through a sensor functionally connected to the electronic device 1902. The card-related information may be used in, for example, a card registration operation. The sensor may include, for example, an OCR function. The card-related information may include, for example, at least one among PAN, valid period, name, and CVV. The sensor may be operated using, for example, the electronic device 1902 or the payment application included in the electronic device 1902.

According to various embodiments of the present disclosure, the payment application included in the electronic device 1902 may transfer the card-related information to the payment server 1904. The payment server 1904 may include, for example, a payment service server or token requester server, and the card-related information may be transferred between the payment service server and the token requester server.

According to an embodiment of the present disclosure, the payment server (e.g., the token requester server) 1904 may transfer the card-related information and/or information (e.g., device information or user information) related to the electronic device 1902 to the token server 1906. The information related to the electronic device 1902 may include, for example, information of a device having requested the token issuance operation.

According to an embodiment of the present disclosure, the token server 1906 may transfer a token based on the information received from the payment server 1904. The token server 1906 may transfer the token to, for example, the token requester server included in the payment server 1904.

According to an embodiment of the present disclosure, the payment server 1904 may transfer the token to the electronic device 1902. The payment server 1904 may transfer a token through, for example, the token requester server included in the payment server 1904, to the electronic device 1902.

According to an embodiment of the present disclosure, the electronic device 1902 may store, in the security module or the TEE, the token received from the payment server 1904. For example, the electronic device 1902 may store the token in the security module or the TEE, which is a security area, to control access from the outside.

According to an embodiment of the present disclosure, the electronic device 1902 may store, in the general memory (e.g., memory included in the REE), the token received from the payment server 1904.

According to an embodiment of the present disclosure, the token may be issued (generated) based on a payment method (e.g., OTP or call center) performed by the electronic device 1902.

According to an embodiment of the present disclosure, the token may be issued (generated) corresponding to the electronic device 1902. For example, a first token may be included in the first electronic device while a second token is included in the second electronic device, and the first and second tokens may be different from each other.

According to an embodiment of the present disclosure, the token may be activated based on an authentication operation (e.g., ID&V). For example, the token may be stored in the electronic device 1902 and activated based on the authentication operation. The authentication operation may include, for example, an identification. The identification may be conducted by, for example, a financial server and through various methods.

According to an embodiment of the present disclosure, the payment server 1904 may transfer the card-related information to the security service management server included in the payment server 1904. The security service management server may be included and internally operate in, for example, the payment server 1904 or may operate separately from the payment server 1904. For example, the security service management server may be included in another device (e.g., an external device) different from the payment server 1904, and may be functionally connected to the payment server 1904 to transmit or receive the card-related information.

According to an embodiment of the present disclosure, the security service management server may transfer the card-related information and/or information (e.g., device information or user information) related to the electronic device 1902 to the token server 1906. According to an embodiment of the present disclosure, the token server 1906 may perform an authentication operation based on the information received from the payment server 1904. The token server 1906 may perform an authentication operation, for example, based on the card-related information and/or the information related to the electronic device 1902.

According to an embodiment of the present disclosure, the token server 1906 may transfer a result (e.g., success or failure) of the authentication operation to the security service management server included in the payment server 1904.

According to an embodiment of the present disclosure, the security service management server may issue (generate) a token based on the card-related information and/or the information related to the electronic device 1902.

According to an embodiment of the present disclosure, the security service management server may store the token in a security area (e.g., a security module) included in the electronic device 1902. For example, the security service management server may have an authority (e.g., security module access authority) for access to the security area of the electronic device 1902. Further, the security service management server may store the token in the security area of the electronic device 1902, using the access authority. Further, the token may be transferred from the security service managing server to the electronic device 1902.

According to an embodiment of the present disclosure, the electronic device 1902 may perform an authentication operation (e.g., ID&V). The authentication operation, for example, an identification, may be performed using the payment application.

According to an embodiment of the present disclosure, the electronic device 1902 may perform the card registration and/or the identification when performing the payment function. For example, the electronic device 1902 may perform the card registration and/or the identification in order to perform the payment function. For example, the card registration and the identification may refer to a standby (preparation) state for the payment function.

According to an embodiment of the present disclosure, the electronic device 1902, the payment server 1904, and the token server 1906 may share information associated with the card registration and the identification. For example, the electronic device 1902, the payment server 1904, and the token server 1906 may share at least one type of information among PAN, valid term, CVV, device information, and user information.

According to an embodiment of the present disclosure, a token associated with the token issuance operation may be issued (generated) when payment is performed using the payment function.

According to an embodiment of the present disclosure, the payment application included in the electronic device 1902 may perform user authentication in order to perform the payment function. For example, the user authentication may include secret code authentication, pattern authentication, or biometric information (e.g., fingerprint or iris) authentication.

According to an embodiment of the present disclosure, when the user authentication is successful (e.g., authentication completion), the payment application may perform the token issuance operation with respect to the payment server 1904. The token issuance operation may include, for example, a token request.

According to an embodiment of the present disclosure, based on the token request, the payment server 1904 may transfer card information (e.g., card Identifier) and/or user information to the token server 1906. The information related to the electronic device 1902 may include, for example, information on a device having requested the token issuance operation.

According to an embodiment of the present disclosure, the token server 1906 may issue (generate) a token based on the information received from the payment server 1904.

According to an embodiment of the present disclosure, the electronic device 1902 may store, in the general memory (e.g., memory included in the REE), the token received from the payment server 1904.

According to an embodiment of the present disclosure, the electronic device 1902 may not store, in the storage area (e.g., memory) included in the electronic device 1902, the token received from the payment server 1904. For example, the electronic device 1902 may use the token in the payment function instead of storing the token in the storage area.

According to an embodiment of the present disclosure, the storage area of the token may be changed based on a payment method (e.g., OTP or call center) performed by the electronic device 1902. For example, the token may be stored in the security module or the TEE when the payment method is OTP, and may not be stored in the electronic device 1902 when the payment method is call center.

According to an embodiment of the present disclosure, the token may include use time or valid time. For example, use of the token may be restricted when a certain time (e.g., three hours or one day) has passed from the issuance (generation) of the token.

According to an embodiment of the present disclosure, the token may include card information. For example, the token may include disposable card information (OTC, one time card).

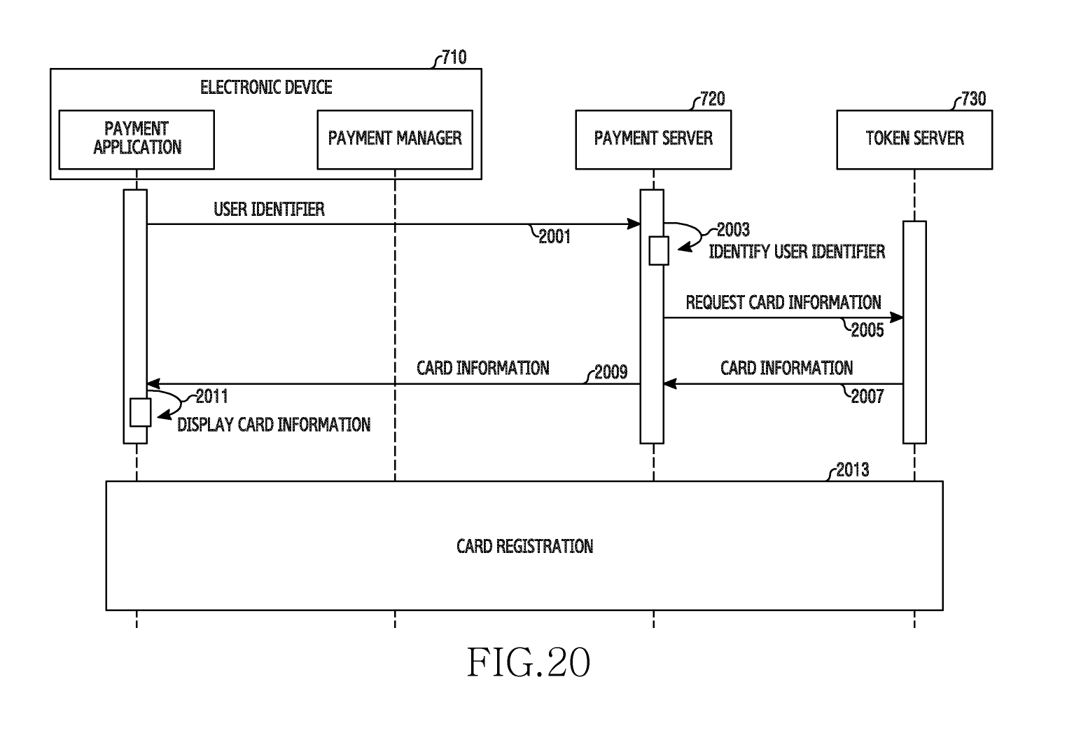

FIG. 20 illustrates a signal flow diagram illustrating a process of registering a card relating to a user account in a payment system according to various embodiments of the present disclosure.

Referring to FIG. 20, the payment system may include an electronic device (e.g., the electronic device 710), a payment server (e.g., the payment server 720), or a token server (e.g., the token server 730). The electronic device 710 may include, for example, a payment application and/or a payment manager.

In operation 2001, the electronic device 710 may receive a user account (e.g., a user identifier) through a payment application and transmit the received user account to the payment server 720. For example, the user identifier may include an ID and password previously stored in the payment server 720. As another example, the user identifier may include at least one of the user's fingerprint and iris.

According to an embodiment of the present disclosure, when a user attempts to initially register a card in the electronic device 710, the electronic device 710 may transmit an input user account to the payment server 720. For example, the attempt of the initial card registration may refer to an attempt of registration of a card in the electronic device 710 in a state where no card has been stored therein. For example, when there is no card registered in a payment application (e.g., Samsung Pay™), the electronic device 710 may display an image 1603 as shown in screen 1601 of FIG. 16A. For example, the image 1603 may include a message 1603 reading “No card has been registered in the payment application yet. Please tap the image 1603 in order to register a new card”. When the image 1603 is tapped by the user, the electronic device 710 may determine that the user is attempting to register a new card, and may transmit an input user account to the payment server 720.

In operation 2003, the payment server 720 may identify at least one card identifier (e.g., card reference ID) associated with the user account. For example, the card identifier may be an identifier of a card previously registered in the payment server 720 by the user, using another electronic device.

According to an embodiment of the present disclosure, the payment server 720 may receive a user account from the electronic device 710 and identity all card identifiers corresponding to the received user account in a database. For example, the database may store a list of one or more card identifiers for each user account.

In operation 2005, the payment server 720 may request the token server 730 to provide information of at least one card corresponding to at least one identified card identifier. For example, the card information may include at least one among a card issuance company, a card name, a PAN, a card expiration date, a CVV, an actual card image, and a card reference ID.

According to an embodiment of the present disclosure, the payment server 720 may generate a card information request message including at least one identified card identifier and transmit the generated card information request message to the token server 730.

In operation 2007, the token server 730 may transmit information of at least one card associated with at least one card identifier to the payment server 720, as a response to the card information request. According to an embodiment of the present disclosure, the token server 730 may receive the card information request message, and identify, in the database, information of at least one card corresponding to at least one card identifier included in the received card information request message. The token server 730 may generate a card information response message including the identified information of the at least one card and transmit the generated card information response message to the payment server 720.

In operation 2009, the payment server 720 may transmit information of at least one card associated with the user account to the electronic device 710. According to an embodiment of the present disclosure, the payment server 720 may receive the card information response message from the token server 730 and transmit the received card information response message to the electronic device 710.

In operation 2011, the electronic device 710 may display information of at least one card associated with the user account.

According to an embodiment of the present disclosure, the electronic device 710 may receive and store the card information response message from the payment server 720, and display information of at least one card included in the stored card information response message through the payment application.

For example, the electronic device 710 may display a plurality of overlapping card images 1607 included in multiple pieces of card information as shown in the screen 1605 of FIG. 16A. For example, in order to express that a plurality of cards have not been registered yet, the electronic device 710 may display a plurality of card images in a particular color (e.g., gray color).

For example, when one card image 1609 is selected from a plurality of card images 1607 by a user, the electronic device 710 may display card information associated with the selected card image. For example, as shown in the screen 1611 of FIG. 16B, the electronic device 710 may display related card information on the selected card image 1613. As another example, as shown in the screen 1621 of FIG. 16C, the electronic device 710 may display a particular window 1625 including related card information, separately from the selected card image 1623.

In operation 2013, the electronic device 710 may perform a card registration process, using the displayed card information.

According to an embodiment of the present disclosure, when the user selects a card to be registered, the electronic device 710 may proceed with a card registration procedure, based on card information associated with the selected card. For example, when the card information does not include all information required for card registration, the electronic device 710 may perform a card registration process after manually receiving corresponding information from a user through the payment application. As another example, when the card information includes all information required for card registration, the electronic device 710 may automatically perform a card registration process based on the card information.

For example, as shown in the screen 1611 of FIG. 16B, when the card image 1613 has been tapped by the user, the electronic device 710 may determine a card corresponding to the card image 1613 as the card to be registered, and may perform a card registration process based on card information corresponding to the card image 1613. As another example, as shown in the screen 1621 of FIG. 16C, when the card registration menu 1627 has been tapped by the user, the electronic device 710 may determine a card corresponding to the card image 1623 as the card to be registered, and may perform a card registration process based on card information corresponding to the card image 1623.

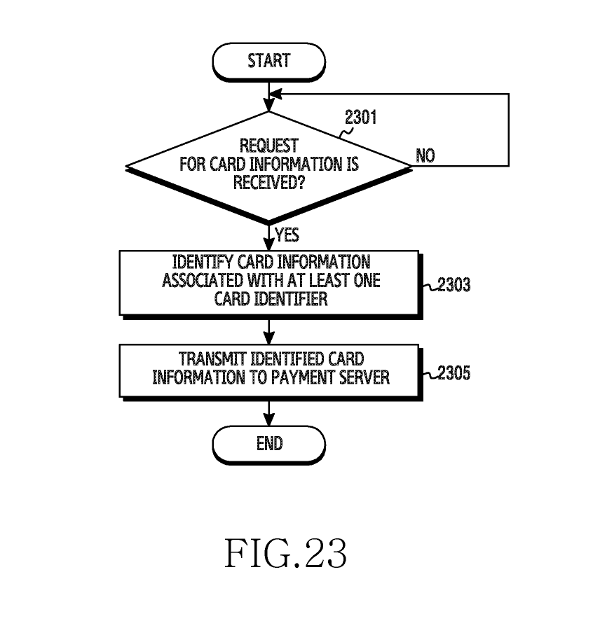

The card registration process in operation 2013 will be described below with reference to FIGS. 23 to 25.

According to an embodiment of the present disclosure, the payment server 720 may store card information at the time of initial card registration. In this event, without requesting the card information from the token server 730, the payment server 720 may identify information of at least one card associated with the user account in the stored card information and transmit the identified information to the electronic device 710.

According to an embodiment of the present disclosure, a plurality of card identifiers may be associated with a plurality of different token servers. In this instance, the payment server 720 may request card information from each token server and may receive card information from the plurality of token servers. The payment server 720 may integrate the received card information and transmit the integrated information to the electronic device 710.

According to an embodiment of the present disclosure, the token server 730 may directly transmit information of at least one card to the electronic device 710 without passing through the payment server 720.

According to an embodiment of the present disclosure, the token server 730 may temporarily store the information of the at least one card in the payment server 720, and the payment server 720 may delete the temporarily stored information of the at least one card after transmitting the information.

Through the operation described above, the electronic device 710 can simplify the card registration process of the user by displaying card information corresponding to a card already registered in another electronic device. The payment server 720 may acquire card information corresponding to the card registered in another electronic device from the token server 730 and transmit the acquired information to the electronic device 710, which can simplify the card registration process of the user.

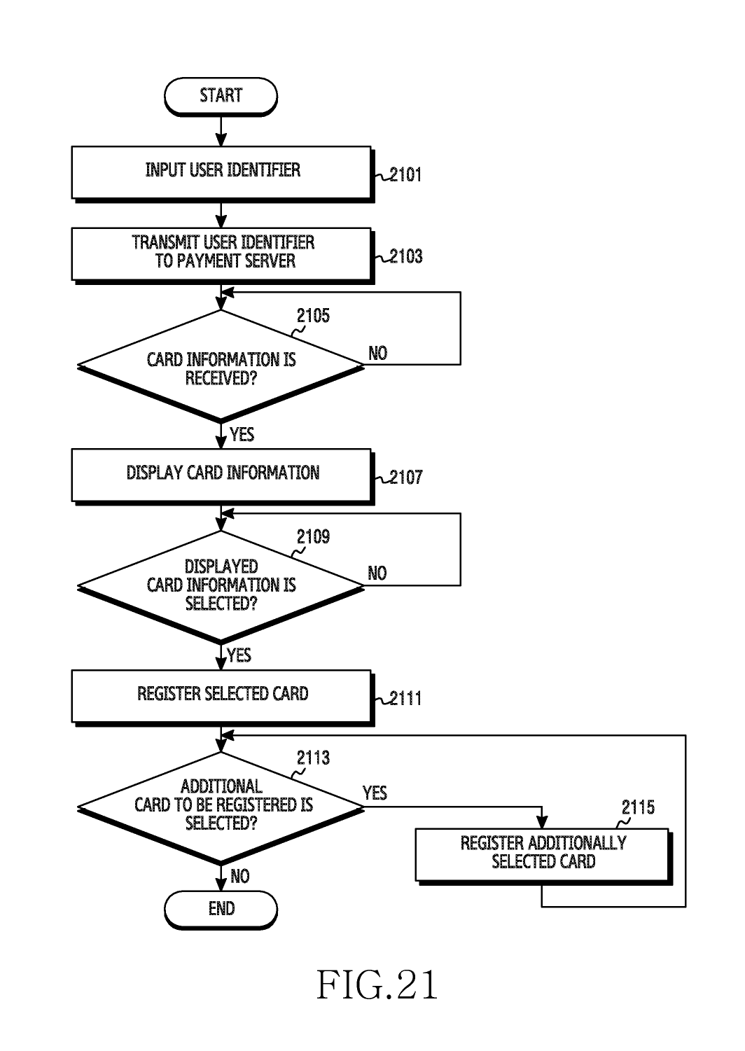

FIG. 21 is a flowchart illustrating a process of registering a card relating to a user account by an electronic device according to various embodiments of the present disclosure. For example, the electronic device may be the electronic device 710 illustrated in FIG. 7.

Referring to FIG. 21, in operation 2101, the electronic device 710 (e.g., processor 210) may receive an input of a user account (e.g., a user identifier). For example, the electronic device 710 may receive a user account input through a payment application (e.g., Samsung Pay™).

In operation 2103, the processor 210 may transmit the input user account to the payment server (e.g., the payment server 720).

According to an embodiment of the present disclosure, when a user attempts to initially register a card in the electronic device 710, the electronic device 710 may transmit an input user account to the payment server 720 in order to receive card information corresponding to a card previously registered in another electronic device. For example, the card information may include at least one among a card issuance company, a card name, a PAN, a card expiration date, a CVV, an actual card image, and a card reference ID.

In operation 2105, the processor 210 may determine whether information of at least one card associated with the user account is received from the payment server 720. For example, the information of at least one card associated with the user account may be information of at least one card corresponding to at least one card identifier associated with the user account.

As a result of the determination, when the card information is received, the processor 210 proceeds to operation 2107. Otherwise, the processor 210 may repeatedly perform operation 2105.

In operation 2107, the processor 210 may display the card information. According to an embodiment of the present disclosure the processor 210 may store card information of at least one card and display at least one card image included in the stored card information of the at least one card on a display (e.g., display 160). When one card image is selected from the at least one displayed card images by a user, the processor 210 may display card information corresponding to the selected card image.

For example, the processor 210 may display card information on a card image. For example, the processor 210 may display card information in a window separate from the card image.

In operation 2109, the processor 210 may determine whether a card to be registered is selected. For example, when a card image including card information is touched (e.g., tapping) by a user, the processor 210 may determine that a card corresponding to the card information has been selected as the card to be registered. As another example, when a card registration menu displayed together with the displayed card information is touched (e.g., tapping) by a user, the processor 210 may determine that a card corresponding to the displayed card information has been selected as the card to be registered.

As a result of the determination, when a card to be registered is selected, the processor 210 proceeds to operation 2111. Otherwise, the processor 210 may repeatedly perform operation 2109.

In operation 2111, the processor 210 may perform a card registration process, based on card information corresponding to the selected card. According to an embodiment of the present disclosure, when the user selects a card to be registered, the processor 210 may proceed with a card registration procedure, based on card information associated with the selected card.

For example, when the card information does not include all information required for card registration, the processor 210 may perform a card registration process after manually receiving corresponding information from a user through the payment application. As another example, when the card information includes all information required for card registration, the processor 210 may automatically perform a card registration process based on the card information.

In operation 2113, the processor 210 may determine whether a card to be registered is additionally selected. According to an embodiment of the present disclosure, when registration of the selected card is completed, the processor 210 may display at least one card image corresponding to at least one card to be registered excluding the already-registered cards. According to an embodiment of the present disclosure, when one card image is selected from at least one displayed card images by a user, the processor 210 may display card information corresponding to the selected card image.

According to an embodiment of the present disclosure, when a card image including card information is touched (e.g., tapping) by a user, the processor 210 may determine that a card corresponding to the card information has been additionally selected as the card to be registered.

According to an embodiment of the present disclosure, when a card registration menu displayed together with the displayed card information is touched (e.g., tapping) by a user, the processor 210 may determine that a card corresponding to the displayed card information has been additionally selected as the card to be registered.

As a result of the determination, when a card to be registered is additionally selected, the processor 210 proceeds to operation 2115. Otherwise, the processor 210 may terminate the card registration process.

In operation 2115, the processor 210 may perform a card registration process, based on card information corresponding to the additionally selected card.

According to an embodiment of the present disclosure, when the user additionally selects a card to be registered, the processor 210 may additionally perform a card registration process based on card information associated with the additionally selected card.

According to an embodiment of the present disclosure, when the additional card registration process has been completed, the processor 210 may proceed to operation 2113 and determine whether a card to be registered is additionally selected.

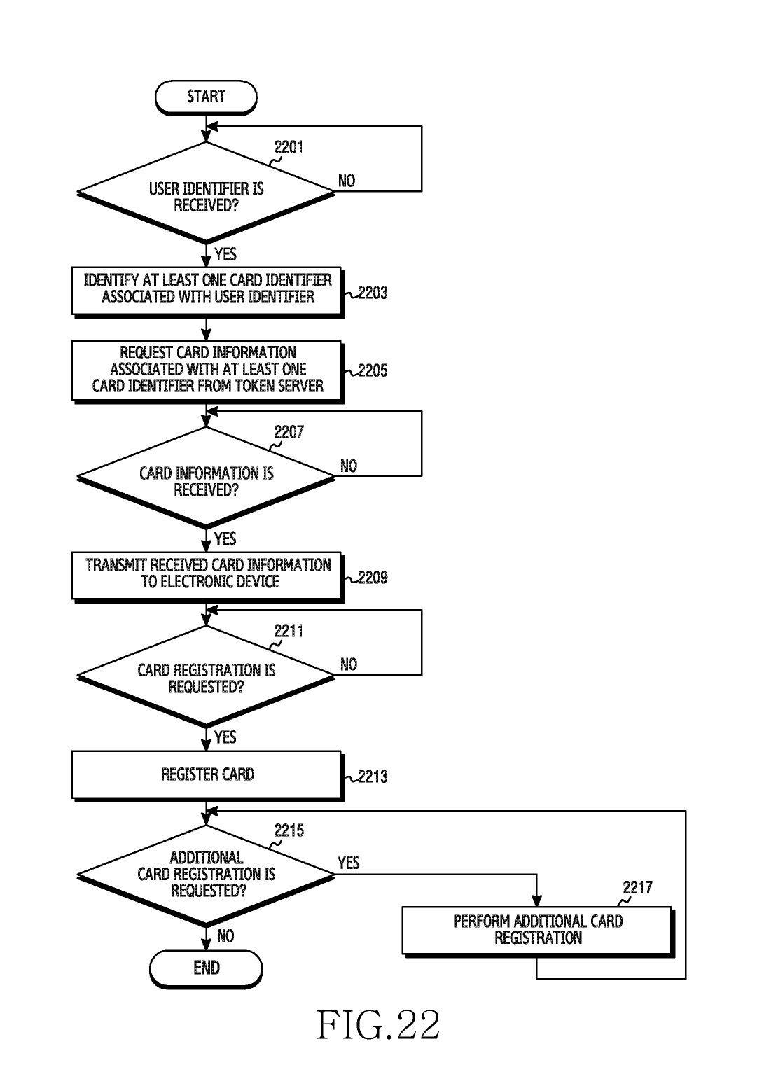

FIG. 22 is a flowchart illustrating a process of registering a card relating to a user account by a payment server according to various embodiments of the present disclosure. For example, the payment server may be the payment server 720 illustrated in FIG. 7.

Referring to FIG. 22, in operation 2201, the payment server 720 may determine whether a user account (e.g., a user identifier) is received from an electronic device (e.g., the electronic device 710). As a result of the determination, when a user account is received, the payment server 720 proceeds to operation 2203. Otherwise, the payment server may repeatedly perform operation 2201.

In operation 2203, the payment server 720 may identify at least one card identifier (e.g., a card reference ID) associated with the user account.

According to an embodiment of the present disclosure, the payment server 720 may detect at least one card identifier corresponding to the user account in a database.

In operation 2205, the payment server 720 may request a token server (e.g., the token server 730) to provide information of at least one card corresponding to at least one identified card identifier. According to an embodiment of the present disclosure, the payment server 720 may generate a card information request message including at least one identified card identifier and transmit the generated card information request message to the token server 730.

In operation 2207, the payment server 720 may determine whether information of at least one card corresponding to at least one identifier is received from the token server 730. According to an embodiment of the present disclosure, the payment server 720 may receive a card information response message including information of at least one card from the token server 730.

As a result of the determination, when information of at least one card is received, the payment server 720 proceeds to operation 2209. Otherwise, the payment server may repeatedly perform operation 2207.

In operation 2209, the payment server 720 may transmit the received information of at least one card to the electronic device 710.

According to an embodiment of the present disclosure, the payment server 720 may transmit a card information response message including information of at least one card to the electronic device 710.

In operation 2211, the payment server 720 may determine whether there is a request for card registration from the electronic device 710. For example, when receiving a card registration request message (e.g., POST/tokens) from the electronic device 710, the payment server 720 may determine that the card registration has been requested. For example, the card registration request message may include at least a part of card information.

As a result of the determination, when there is a request for card registration, the payment server 720 proceeds to operation 2213. Otherwise, the payment server 720 may repeatedly perform operation 2211.

In operation 2213, the payment server 720 may perform a card registration process, based on information included in the card registration request message. For example, the payment server 720 may perform a card registration process in cooperation with the electronic device 710 and the token server 730.

In operation 2215, the payment server 720 may determine whether there is a request for additional card registration from the electronic device 710. For example, when additionally receiving a card registration request message (e.g., POST/tokens) from the electronic device 710, the payment server 720 may determine that the card registration has been additionally requested.

As a result of the determination, when card registration is additionally requested, the payment server 720 proceeds to operation 2217. Otherwise, the payment server may terminate the card registration process.

In operation 2217, the payment server 720 may additionally perform a card registration process, based on information included in the card registration request message.

FIG. 23 is a flowchart illustrating a process of registering a card relating to a user account by a token server according to various embodiments of the present disclosure. For example, the token server may be the token server 730 illustrated in FIG. 7.

Referring to FIG. 23, in operation 2301, the token server 730 may determine whether a card information request is received from a payment server (e.g., the payment server 720).

According to an embodiment of the present disclosure, the token server 730 may receive a card information request message including at least one card identifier.

As a result of the determination, when a card information request is received, the token server 730 proceeds to operation 2303. Otherwise, the token server may repeatedly perform operation 2301.

In operation 2303, the token server 730 may identify information of at least one card corresponding to at least one card identifier.

According to an embodiment of the present disclosure, the token server 730 may detect, in the database, information of at least one card corresponding to at least one card identifier included in the card information request message.

In operation 2305, the token server 730 may transmit the detected information of at least one card to the payment server 720.

According to an embodiment of the present disclosure, the token server 730 may generate a card information response message including the identified information of the at least one card and transmit the generated card information response message to the payment server 720.

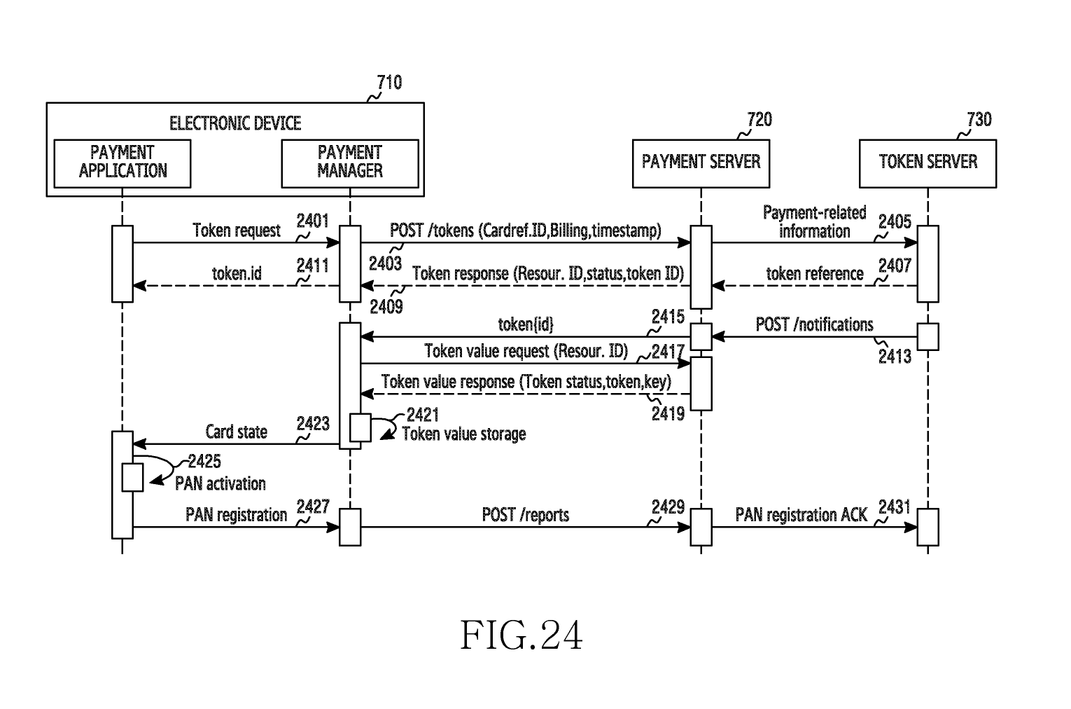

FIGS. 24 to 26 are signal flow diagrams illustrating a process of registering a card in a payment system according to various embodiments of the present disclosure.

The signal flow diagram of FIG. 24 illustrates a process of registering a card without an identification process of an electronic device (e.g., the electronic device 710).

Referring to FIG. 24, the solid line indicates a request (e.g., request or call) command and the dotted line indicates a response (e.g., response or return) command.

According to an embodiment of the present disclosure, the payment system may include the electronic device 710, the payment server 720, and the token server 730. The electronic device 710 may include, for example, a payment application and/or a payment manager.

In operation 2401, the payment application of the electronic device 710 may transmit a command requesting a token for card registration to the payment manager of the electronic device 710.

In operation 2403, the payment manager may transfer information corresponding to the command requesting a token to the payment server. The information may include, for example, a certain command (e.g., POST/tokens). The information corresponding to the command requesting a token may be information associated with the time point at which the command request input is received.

For example, the POST/tokens may be used when a token is requested after a user's approval (e.g., accept) of the card registration in the operation of performing card registration to the payment server 720 by the payment manager. The parameters of POST/tokens may include, for example, at least one among a card reference ID, contract condition approval (e.g., T&C acceptance), and timestamp. The timestamp may include, for example, a time point at which a command approving the card registration is received from the user.

In operation 2405, the payment server 720 may transmit a command allowing card registration to the token server 730. For example, the payment server 720 may transmit information (e.g., T&C acceptance and/or timestamp) associated with payment to the token server 730. As another example, the payment server 720 may transmit information relating to payment to the token server 730 and request the token server 730 to configure a token.

In operation 2407, the token server 730 may transmit the information associated with a token to be generated, to the payment server 720. For example, the information associated with the token may include a random value (e.g., token reference) generated by the token server 730 in order to distinguish the token. As another example, the information relating to the token may include a token ID. According to an embodiment of the present disclosure, the token reference and the token ID may be distinguished from each other.

In operation 2409, based on the token reference received from the token server 730, the payment server 720 may allocate a logical or physical space for the token reference in the payment server 720. For example, the payment server 720 may generate an ID (e.g., resource ID) identifying the logical or physical space. The resource ID may include an identifier of the registered (enrolled) resource, which may be configured in the form of uniform resource locator (URL). Further, the resource ID may include, for example, reference information including information related to a token ID and may include an address at which the token ID is stored in the payment server 720.

Further, as a response to a request (e.g., POST/tokens) from the payment manager, the payment server 720 may transmit a token response to the payment manager. For example, the token response may include at least one among a resource ID, a token status, and a token ID. For example, the token status may include, for example, a state (e.g., active, suspended, resume, or dispose) of the token.

In operation 2411, the payment manager may transmit at least a part of the information received from the payment server 720 to the payment application. For example, the information transmitted to the payment application may include a token ID.

In operation 2413, the token server 730 may transfer a notification message (e.g., POST/notification) requiring progress of issuance of a token to the payment server 720. For example, the notification message may include at least one among a token reference, a token ID, a token value, and a key for generation of a cryptogram. Further, the notification message may include an indication (e.g., op:Provision) which implies that the message is a message for issuance of a token.

In operation 2415, the payment server 720 may transmit at least a part of information included in the notification message received from the token server 730 to the payment manager. For example, the message transmitted to the payment manager may include at least one among a token ID, a resource ID, and an indication for issuance of a token.

In operation 2417, after receiving the message from the payment server 720, the payment manager may transmit a token value request message (e.g., GET/token/{id}) requesting a token value to the payment server 720. For example, the token value request message may include a resource ID.

In operation 2419, as a response to the token value request message (e.g., GET/token/{id}), the payment server 720 may transmit a token value response message to the payment manager. For example, the token value response message may include at least one among a token ID, a token state, a token value, and a key.

According to an embodiment of the present disclosure, at least one among the token ID, the token state, the token value, and the key may be encrypted.

In operation 2421, the payment manager may store a token value response message received from the payment server 720 in a trust zone. The trust zone may be included in, for example, the TEE. The payment manager may store, for example, at least one of the token ID, the token state, the token value, and the key in a security application included in the electronic device 710.

In operation 2423, the payment manager may transmit a result of storage of the token value response message (e.g., token ID, token value, and key) received from the payment server 720 in the trust zone, to the payment application. For example, the payment manager may transmit a command (e.g., active) associated with token activation to the payment application. For example, the payment manager may transmit, to the payment application, information reporting that the state of the card related to the payment function is an active state.

In operation 2425, the payment application may change the state of the PAN recognized by the electronic device 710. For example, the payment application may change (e.g., enable) the state of the PAN to enable payment using the PAN.

In operation 2427, the payment application may transmit the changed state of the PAN to the payment manager. For example, the payment application may transmit information (e.g., PAN enrolled) indicating registration of the PAN to the payment manager.

In operation 2429, the payment manager may transmit the changed state of the PAN to the payment server 720. For example, the payment manager may transfer, to the payment server 720, information that the PAN is in a payable state (e.g., enable), using a certain command (e.g., POST/reports). The payment manager may perform, for example, state synchronization with the payment server 720.

In operation 2431, the payment server 720 may transmit the changed state of the PAN to the token server 730. For example, the payment server 720 may transmit a response message (e.g., an acknowledgement or an ack PAN enrolled (PAN registration ACK)) to the token server 730.

According to an embodiment of the present disclosure, the payment communication system may omit at least a part of operations 2401 to 2431. For example, in operation 2407, when information associated with the token is received from the token server 730, the payment server 720 may directly perform operation 2419 without performing operations 2409 to 2417, which can reduce a time required for registration of a new card.

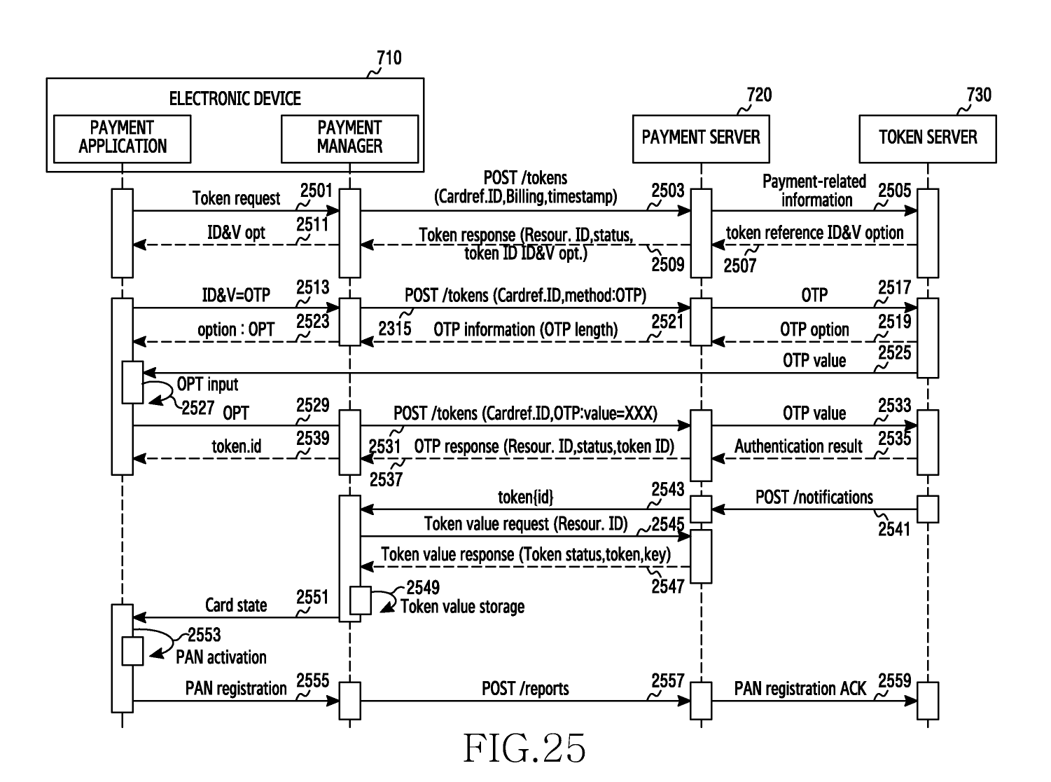

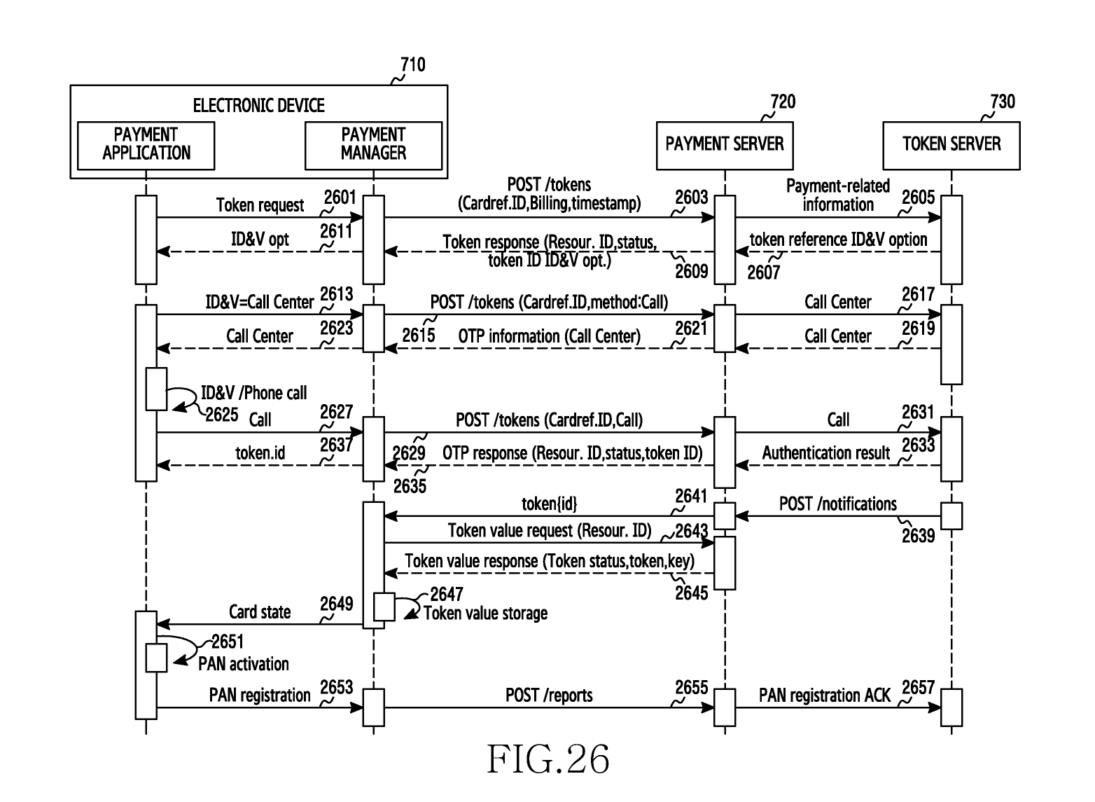

The signal flow diagrams of FIGS. 25 and 26 illustrate a process of registering a card including an identification process of an electronic device (e.g., the electronic device 710).

Referring to FIGS. 25 and 26, the solid line may indicate a request (e.g., request or call) command and the dotted line may indicate a response (e.g., response or return) command.

According to an embodiment of the present disclosure, the payment system may include the electronic device 710, the payment server 720, and the token server 730. The electronic device 710 may include, for example, a payment application and/or a payment manager.

The signal flow diagram of FIG. 25 illustrates a signal flow of a token issuance operation using OTP in an identification process of an electronic device.

In operation 2501, the payment application of the electronic device 710 may transmit a command requesting a token for card registration to the payment manager of the electronic device 710.

In operation 2503, the payment manager may transfer information corresponding to the command requesting a token to the payment server. The information may include, for example, a certain command (e.g., POST/tokens). The information corresponding to the command requesting a token may be information associated with the time point at which the command request input is received.

For example, the POST/tokens may be used when a token is requested after user's approval (e.g., accept) of the card registration in the operation of performing card registration to the payment server 720 by the payment manager. The parameters of POST/tokens may include, for example, at least one among a card reference ID, contract condition approval (e.g., T&C acceptance), timestamp, and billing address. The timestamp may include, for example, a time point at which a command approving the card registration is received from the user.

In operation 2505, the payment server 720 may transmit a command allowing card registration to the token server 730. For example, the payment server 720 may transmit information (e.g., T&C acceptance and/or timestamp) associated with payment to the token server 730. As another example, the payment server 720 may transmit information relating to payment to the token server 730 and request the token server 730 to configure a token.

In operation 2507, the token server 730 may transfer the information associated with a token to be generated, to the payment server. For example, the information relating to a token may include a random value (e.g., token reference) generated by the token server in order to distinguish the token. As another example, the information relating to the token may include a token ID. For example, the token reference and the token ID may be distinguished from each other. As another example, the information relating to the token may include information relating to an identification item (e.g., option).

For example, the token ID may include index information related to a token. For example, the identification item may include at least one method among call, SMS, OTP, and App-to-App method. The identification item may be determined by, for example, the token server 730, and the token server may determine at least one identification item. The determining of at least one identification item may include, for example, at least two methods related to authentication. As another example, the determining of at least one identification item may be performed based on a policy.

At least two identification items or methods may be used according to an embodiment of the present disclosure. For example, an additional identification item or method may be used as well as the OTP method described above as an identification item or method. A plurality of identification items or methods may be used, for example, simultaneously or sequentially in the payment system.

When using at least two identification items or methods according to an embodiment of the present disclosure, a user may optionally select at least one item or method among the at least two identification items or methods. For example, when the token server 730 does not limit the identification item, the user may use at least one among the identification items available in the electronic device 710.

In operation 2509, based on the token reference received from the token server 730, the payment server 720 may allocate a logical or physical space for the token reference in the payment server 720. For example, the payment server 720 may generate an ID (e.g., resource ID) identifying the logical or physical space. The resource ID may include an identifier of the registered (enrollment) resource, which may be configured in the form of URL. Further, the resource ID may include, for example, reference information including information related to a token ID and may include an address at which the token ID is stored in the payment server 720.

According to an embodiment of the present disclosure, based on the information received from the token server 730, the payment server 720 may transfer at least one among a token ID, a resource ID, a token state, and an identification item to the payment manager. For example, in response to the request (e.g., POST/tokens) from the payment manager, the payment server 720 may transfer at least one of the token ID, the resource ID, the token state, and the identification item. The at least one of the token ID, the resource ID, the token state, and the identification item may be, for example, transmitted after being encrypted. The payment server 720 may include a status or identification method in the transmitted at least one of the token ID, the resource ID, the token state, and the identification item. The status may include, for example, a state (e.g., active, suspended, resume, or dispose) of the token. The identification method may include, for example, an activation method for the token, and the type of the identification method may include, for example, at least one among CODE, CALL, APP, and LINK.

In operation 2511, the payment manager may transmit the information (e.g., the token ID, the resource ID, the token state, or the identification item) received from the payment server 720 to the payment application. For example, the payment manager may transmit a command (e.g., pending) associated with token to the payment application. For example, the payment manager may transfer, to the payment application, information reporting that the state of the card related to the payment function is a standby (pending) state.

According to an embodiment of the present disclosure, the payment manager may transfer the identification item received from the token requester server to the payment application to provide an interface so that a user can select the identification item. The payment manager may provide, for example, an interface to enable the token requester server included in the payment server 720 to use at least one item or method as the identification item. The electronic device 710 may perform the identification using, for example, a plurality of identification items or methods.

In operation 2513, the payment application may use an OTP method as the identification item or method. For example, the payment application may receive the OTP method as the identification item or method and may transmit the received OTP method to the payment manager.

In operation 2515, the payment manager may transmit the received or acquired identification item or method to the payment server 720. For example, the payment manager may transmit the identification item or method to the payment server 720, using a certain command (e.g., POST/tokens or POST/tokens, OTP). Further, the payment manager may transmit, for example, a card reference ID and the identification method to the payment server 720. For example, the identification method may include the OTP method received from the user.

In operation 2517, the payment server 720 may transmit the received or acquired identification item or method to the token server 730. For example, the payment server 720 may transfer the OTP method, which is an identification item or method received or acquired from the user, to the token server 730.

In operation 2519, the token server 730 may generate an OTP corresponding to the OTP method received from the payment server 720. For example, the token server 730 may generate the OTP based on a pre-configured rule or algorithm. The OTP may include, for example, numbers, letters, or certain information (e.g., pattern or picture).

According to an embodiment of the present disclosure, the token server 730 may transmit information (e.g., OTP option) on the OTP to the payment server 720.

In operation 2521, the payment server 720 may transmit information (e.g., OTP option) on the OTP to the payment manager. The information on the OTP may include, for example, the length of the OTP. The length of the OTP may include, for example, digits used in the OTP method. The digits may include, for example, four digits or six digits.

In operation 2523, the payment manager may transmit the information (e.g., OTP option) on the OTP to the payment application. The information on the OTP may include, for example, format information of the OTP.

In operation 2525, the token server 730 may transmit the numerical value or value of the OTP to the payment application. For example, the token server 730 may transmit an OTP numerical value or value through a communication channel. The communication channel may include, for example, an SMS or e-mail.

In operation 2527, the payment application may provide an interface displaying information relating to the OTP value or numerical value. For example, the payment application may provide the OTP value or numerical value, unit numbers, letters, or certain information (e.g., pattern or picture).

According to an embodiment of the present disclosure, the payment application may acquire data, from the user, using an interface displaying information relating to the OTP value or numerical value. For example, the payment application may acquire the OTP value or numerical value through an external device functionally connected to the payment application or a user input (e.g., touch). The payment application may change the interface displaying the information relating to the OTP value or numerical value, based on the digits received from the payment server 720.

In operation 2529, the payment application may transmit the OTP value or numerical value acquired through a user input or from an external device to the payment manager. For example, the OTP value or numerical value acquired through a user input or from an external device may be used in a user authentication operation.

In operation 2531, the payment application may transmit the OTP value or numerical value acquired through a user input or from an external device to the payment server 720. The payment manager may transfer the OTP value or numerical value acquired from external device or a user input to the payment server 720, using a certain command (e.g., POST/tokens {OTP:value=data).

In operation 2533, the payment server 720 may transmit the OTP value or numerical value acquired through a user input or from an external device to the token server 730.

In operation 2535, the token server 730 may determine the validity of the OTP value or numerical value received from the payment server 720. For example, the token server 730 may determine the validity of the identification item (method) acquired from the user and information (data) associated with the identification item. For example, the token server 730 may determine whether the identification items and data generated by the token server 730 are identical or similar to information (e.g., OTP method and the OTP value or numerical value) received from the payment server 720. For example, when the identification items and data generated by the token server 730 are identical or similar to information received from the payment server 720, the token server 730 may determine that the identification items and data generated by the token server are valid.

According to an embodiment of the present disclosure, when it is determined that the identification items and data are valid, the token server 730 may change the token suspension (token pending) indicating the state of the token. For example, the token server 730 may change the state of the token suspension to an activation state.

According to an embodiment of the present disclosure, the token server 730 may transmit an authentication result including a result of the determination to the payment server 720.

In operation 2537, when receiving the authentication result, the payment server 720 may transmit information associated with the authentication result to the payment manager. For example, the information associated with the authentication result may include at least one among a resource ID, status, and a token ID.

In operation 2539, the payment manager may transmit a token ID to the payment application.

In operation 2541, the token server 730 may transfer a notification message (e.g., POST/notification) requiring progress of issuance of a token to the payment server 720. For example, the notification message may include at least one among a token reference, a token ID, a token value, and a key for generation of a cryptogram. Further, the notification message may include an indication (e.g., op:Provision) which implies that the message is a message for issuance of a token.

In operation 2543, the payment server 720 may transmit at least a part of information included in the notification message received from the token server 730 to the payment manager. For example, the message transmitted to the payment manager may include at least one among a token ID, a resource ID, and an indication for issuance of a token.

In operation 2545, after receiving the message from the payment server 720, the payment manager may transmit a token value request message (e.g., GET/token/{id}) requesting a token value to the payment server 720. For example, the token value request message may include a resource ID.

In operation 2547, as a response to the token value request message (e.g., GET/token/{id}), the payment server 720 may transmit a token value response message to the payment manager. For example, the token value response message may include at least one among a token ID, a token state, a token value, and a key. The at least one of the token ID, the token state, the token value, and the key may be, for example, encrypted.

In operation 2549, the payment manager may store a token value response message received from the payment server 720 in a trust zone. The trust zone may be included in, for example, the TEE. The payment manager may store, for example, at least one of the token ID, the token state, the token value, and the key in a security application included in the electronic device 710.

In operation 2551, the payment manager may transmit a result of storage of the token value response message (e.g., token ID, token value, and key) received from the payment server 720 in the trust zone, to the payment application. For example, the payment manager may transmit a command (e.g., active) associated with token activation to the payment application. For example, the payment manager may transmit, to the payment application, information reporting that the state of the card related to the payment function is an active state.

In operation 2553, the payment application may change the state of the PAN recognized by the electronic device 710. For example, the payment application may change (e.g., enable) the state of the PAN to enable payment using the PAN.

In operation 2555, the payment application may transmit the changed state of the PAN to the payment manager. For example, the payment application may transmit information (e.g., PAN enrolled) indicating registration of the PAN to the payment manager.

In operation 2557, the payment manager may transmit the changed state of the PAN to the payment server 720. For example, the payment manager may transfer, to the payment server 720, information that the PAN is in a payable state (e.g., enable), using a certain command (e.g., POST/reports). The payment manager may perform, for example, state synchronization with the payment server 720.

In operation 2559, the payment server 720 may transmit the changed state of the PAN to the token server 730. For example, the payment server 720 may transmit a response messages (e.g., an acknowledgement or an ack PAN enrolled (PAN registration ACK)) to the token server 730.

The signal flow diagram of FIG. 26 illustrates a signal flow of a token issuance operation using a call center in an identification process of the electronic device 710.

In operation 2601, the payment application of the electronic device 710 may transmit a command requesting a token for card registration to the payment manager of the electronic device 710.

In operation 2603, the payment manager may transfer information corresponding to the command requesting a token to the payment server. The information may include, for example, a certain command (e.g., POST/tokens). For example, the information corresponding to the command requesting a token may be information associated with the time point at which the command request input is received.

For example, the POST/tokens may be used when a token is requested after a user's approval (e.g., accept) of the card registration in the operation of performing card registration to the payment server 720 by the payment manager. The parameters of POST/tokens may include, for example, at least one among a card reference ID, contract condition approval (e.g., T&C acceptance), timestamp, and billing address. The timestamp may include, for example, a time point at which a command approving the card registration is received from the user.

In operation 2605, the payment server 720 may transmit a command allowing card registration to the token server 730. For example, the payment server 720 may transmit information (e.g., T&C acceptance and/or timestamp) associated with payment to the token server 730. As another example, the payment server 720 may transmit information relating to payment to the token server 730 and request the token server 730 to configure a token.

In operation 2607, the token server 730 may transfer the information associated with a token to be generated, to the payment server. For example, the information relating to a token may include a random value (e.g., token reference) generated by the token server in order to distinguish the token. As another example, the information relating to the token may include a token ID. For example, the token reference and the token ID may be distinguished from each other. As another example, the information relating to the token may include information relating to an identification item (e.g., option).

For example, the token ID may include index information related to a token. For example, the identification item may include at least one method among call, SMS, OTP, and App-to-App method. The identification item may be determined by, for example, the token server 730, and the token server may determine at least one identification item. The determining of at least one identification item may include, for example, at least two methods related to authentication. As another example, the determining of at least one identification item may be performed based on the policy.

At least two identification items or methods may be used according to an embodiment of the present disclosure. For example, an additional identification item or method may be used as well as the OTP method described above as an identification item or method. A plurality of identification items or methods may be used, for example, simultaneously or sequentially in the payment system.

When using at least two identification items or methods according to an embodiment of the present disclosure, a user may optionally select at least one item or method among the at least two identification items or methods. For example, when the token server 730 does not limit the identification item, the user may use at least one among the identification items available in the electronic device 710.

In operation 2609, based on the token reference received from the token server 730, the payment server 720 may allocate a logical or physical space for the token reference in the payment server 720. For example, the payment server 720 may generate an ID (e.g., resource ID) identifying the logical or physical space. The resource ID may include an identifier of the registered (enrollment) resource, which may be configured in the form of URL. Further, the resource ID may include, for example, reference information including information related to a token ID and may include an address at which the token ID is stored in the payment server 720.

According to an embodiment of the present disclosure, based on the information received from the token server 730, the payment server 720 may transfer at least one among a token ID, a resource ID, a token state, and an identification item to the payment manager. For example, in response to the request (e.g., POST/tokens) from the payment manager, the payment server 720 may transfer at least one of the token ID, the resource ID, the token state, and the identification item. The at least one of the token ID, the resource ID, the token state, and the identification item may be, for example, transmitted after being encrypted. The payment server 720 may include a status or identification method in the transmitted at least one of the token ID, the resource ID, the token state, and the identification item. The status may include, for example, a state (e.g., active, suspended, resume, or dispose) of the token. The identification method may include, for example, an activation method for the token, and the type of the identification method may include, for example, at least one among CODE, CALL, APP, and LINK.

In operation 2611, the payment manager may transmit the information (e.g., the token ID, the resource ID, the token state, or the identification item) received from the payment server 720 to the payment application. For example, the payment manager may transmit a command (e.g., pending) associated with token to the payment application. For example, the payment manager may transfer, to the payment application, information reporting that the state of the card related to the payment function is a standby (pending) state.

According to an embodiment of the present disclosure, the payment manager may transfer the identification item received from the token requester server to the payment application to provide an interface so that a user can select the identification item. The payment manager may provide, for example, an interface to enable the token requester server included in the payment server 720 to use at least one item or method as the identification item. The electronic device 710 may perform the identification using, for example, a plurality of identification items or methods.

In operation 2613, the payment application may use a call center method as the identification item or method. For example, the payment application may receive, from the user, the call center method as the identification item or method and may transmit the received call center method to the payment manager.

In operation 2615, the payment manager may transmit the received or acquired identification item or method to the payment server 720. For example, the payment manager may transmit the identification item or method to the payment server 720, using a certain command (e.g., POST/tokens or tokens, Call). Further, the payment manager may transfer, for example, a card reference ID and the identification method to the payment server 720. For example, the identification method may include the call center method (e.g., POST/tokens, CALL) received from the user.

In operation 2617, the payment server 720 may transmit the received or acquired identification item or method to the token server 730. For example, the payment server 720 may transmit the call center method, which is an identification item or method received or acquired from the user, to the token server 730.

In operation 2619, the token server 730 may prepare a call connection (counselling call) corresponding to the call center method received from the payment server 720. For example, the token server 730 may use an electronic device 710 associated with the call center method received from the user and a number (e.g., a phone number) of the electronic device 710. The token server 730 may receive, for example, the electronic device 710 or the number of the electronic device 710 through at least one among the payment application, the payment manager, and the payment server 720, or may receive it using a payment network.

According to an embodiment of the present disclosure, the token server 730 may transmit information associated with the call center method to the payment server 720. The notification associated with the call center method may include, for example, the electronic device 710 or the number of the electronic device 710.

In operation 2621, the payment server 720 may transmit a notification associated with the call center method to the payment manager. The notification associated with the call center method may include, for example, the electronic device 710 or the number of the electronic device 710.

In operation 2623, the payment manager may transmit a notification associated with the call center method to the payment application. The notification associated with the call center method may include, for example, the electronic device 710 or the number of the electronic device 710.

In operation 2625, the payment application may provide an interface displaying information relating to the call center method. For example, the payment application may use an application (e.g., a phone application) included in the electronic device 710 in order to perform the communication connection.

According to an embodiment of the present disclosure, the payment application may perform an authentication operation, using an interface displaying information relating to the call center method from the user. For example, the payment application may perform the authentication operation, using an external device functionally connected to the payment application or a user input (e.g., a touch). Further, the payment application may perform the authentication operation, based on the communication connection. For example, the payment application may transfer, through the communication connection, information that the authentication operation (e.g., ID&V operation) has succeeded or has been completed. The result (e.g., success or completion of authentication) of the authentication operation may be shared through synchronization with, for example, the token server.

In operations 2627 to 2631, the payment application may perform a communication connection (e.g., phone connection) associated with the call center method, with at least one of the token server 730 or the payment server 720. For example, at least one among the token server 730 and the payment server 720 may use a communication network (e.g., 2G, 3G, 4G, or LTE communication networks) in order to perform the communication connection.

In operation 2627, the payment application may transmit a value acquired through a user input or from an external device during call to the payment manager. In operation 2629, the payment manager may transmit a value acquired through a user input or from an external device during call to the payment server 720. The payment manager may transfer the value acquired from the external device or through the user input during call to the payment server 720, using a certain command (e.g., POST/tokens{OTP:value=data}). As another example, the payment manager may transfer a command identifying a result of authentication performed during a call to the payment server 720, using a certain command (e.g., POST/tokens{Call}).

In operation 2631, the payment server 720 may transmit a message for identification of a result of authentication performed during the call to the token server 730. For example, the payment manager 720 may transmit a value acquired through a user input or from an external device during call to the token server 730.

In operation 2633, the token server 730 may identify the authentication operation for the call center method performed in the payment application. For example, the token server 730 may identify the result of the authentication (e.g., the identification operation) through the communication connection with the electronic device 710.

According to an embodiment of the present disclosure, the token server 730 may change the state of the token when the result of the authentication operation is success or authentication completion. For example, the token server 730 may change the state of the token to an activation state.

According to an embodiment of the present disclosure, the token server 730 may determine the validity of a user input received from the payment server 720 or a value acquired from an external device. For example, the token server 730 may determine the validity of the identification item (method) acquired from the user and information (data) associated with the identification item. For example, the token server 730 may determine whether the identification items and data generated by the token server 730 are identical or similar to information (e.g., call method and input value) received from the payment server 720.

According to an embodiment of the present disclosure, the token server 730 may identify the result of authentication performed in the call center. For example, the token server 730 may determine the validity of the identification item (method) and information (data) associated with the identification item, which have been received from the payment server 720 based on a result through the call center performed with the user. For example, the token server 730 may determine, based on the information received from the call center, whether to transmit data from the token server 730 to the electronic device 710.

According to an embodiment of the present disclosure, when the identification items and data generated by the token server 730 are identical or similar to information received from the payment server 720, the token server 730 may determine that the identification items and data generated by the token server are valid. According to various embodiments of the present disclosure, when receiving, from the call center, a result reporting that the identification items and data are valid, the token server 730 may determine the identification items and data as valid.

According to an embodiment of the present disclosure, when it is determined that the identification items and data are valid, the token server 730 may change the token suspension (token pending) indicating the state of the token. For example, the token server 730 may change the state of the token suspension to an activation state.

In operation 2639, the token server 730 may transfer a notification message (e.g., POST/notification) requiring progress of issuance of a token to the payment server 720. For example, the notification message may include at least one among a token reference, a token ID, a token value, and a key for generation of a cryptogram. Further, the notification message may include an indication (e.g., op:Provision) which implies that the message is a message for issuance of a token.

In operation 2641, the payment server 720 may transmit at least a part of information included in the notification message received from the token server 730 to the payment manager. For example, the message transmitted to the payment manager may include at least one among a token ID, a resource ID, and an indication for issuance of a token.

In operation 2643, after receiving the message from the payment server 720, the payment manager may transmit a token value request message (e.g., GET/token/{id}) requesting a token value to the payment server 720. For example, the token value request message may include a resource ID.

In operation 2645, as a response to the token value request message (e.g., GET/token/{id}), the payment server 720 may transmit a token value response message to the payment manager. For example, the token value response message may include at least one among a token ID, a token state, a token value, and a key. The at least one of the token ID, the token state, the token value, and the key may be, for example, encrypted.

In operation 2647, the payment manager may store a token value response message received from the payment server 720 in a trust zone. The trust zone may be included in, for example, the TEE. The payment manager may store, for example, at least one of the token ID, the token state, the token value, and the key in a security application included in the electronic device 710.

In operation 2649, the payment manager may transmit a result of storage of the token value response message (e.g., token ID, token value, and key) received from the payment server 720 in the trust zone, to the payment application. For example, the payment manager may transmit a command (e.g., active) associated with token activation to the payment application. For example, the payment manager may transmit, to the payment application, information reporting that the state of the card related to the payment function is an active state.

In operation 2651, the payment application may change the state of the PAN recognized by the electronic device 710. For example, the payment application may change (e.g., enable) the state of the PAN to enable payment using the PAN.

In operation 2653, the payment application may transmit the changed state of the PAN to the payment manager. For example, the payment application may transmit information (e.g., PAN enrolled) indicating registration of the PAN to the payment manager.

In operation 2655, the payment manager may transmit the changed state of the PAN to the payment server 720. For example, the payment manager may transfer, to the payment server 720, information that the PAN is in a payable state (e.g., enable), using a certain command (e.g., POST/reports). The payment manager may perform, for example, state synchronization with the payment server 720.

In operation 2657, the payment server 720 may transmit the changed state of the PAN to the token server 730. For example, the payment server 720 may transmit a response messages (e.g., acknowledgement or ack PAN enrolled (PAN registration ACK)) to the token server 730.

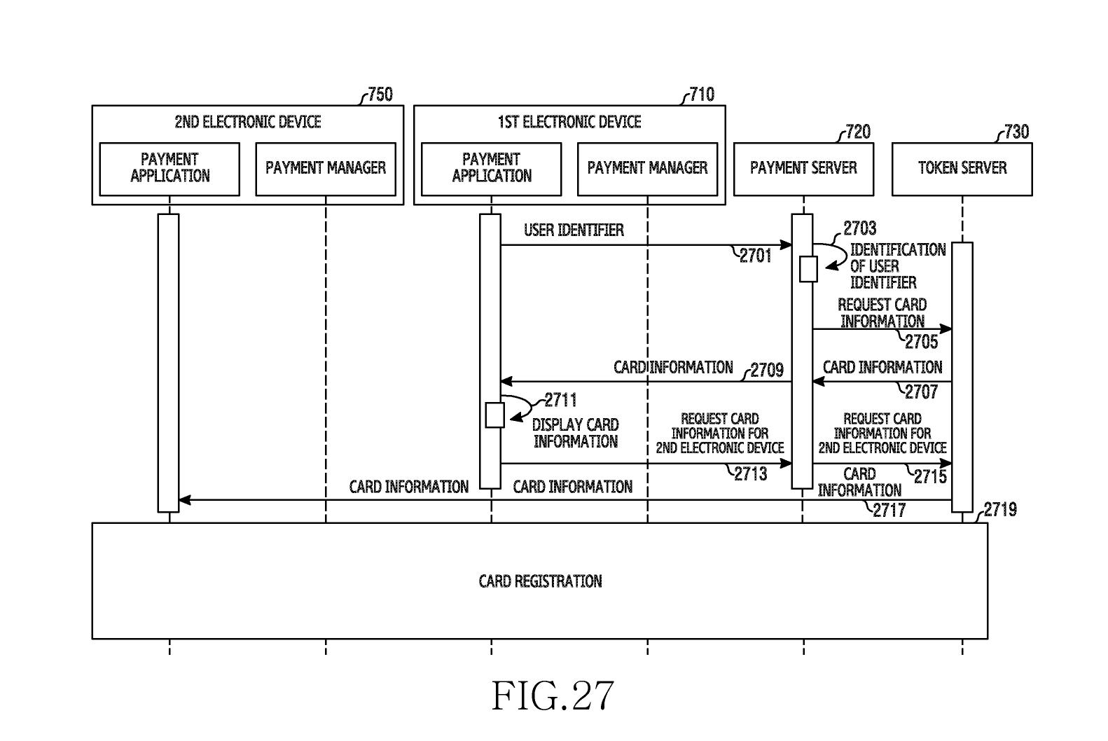

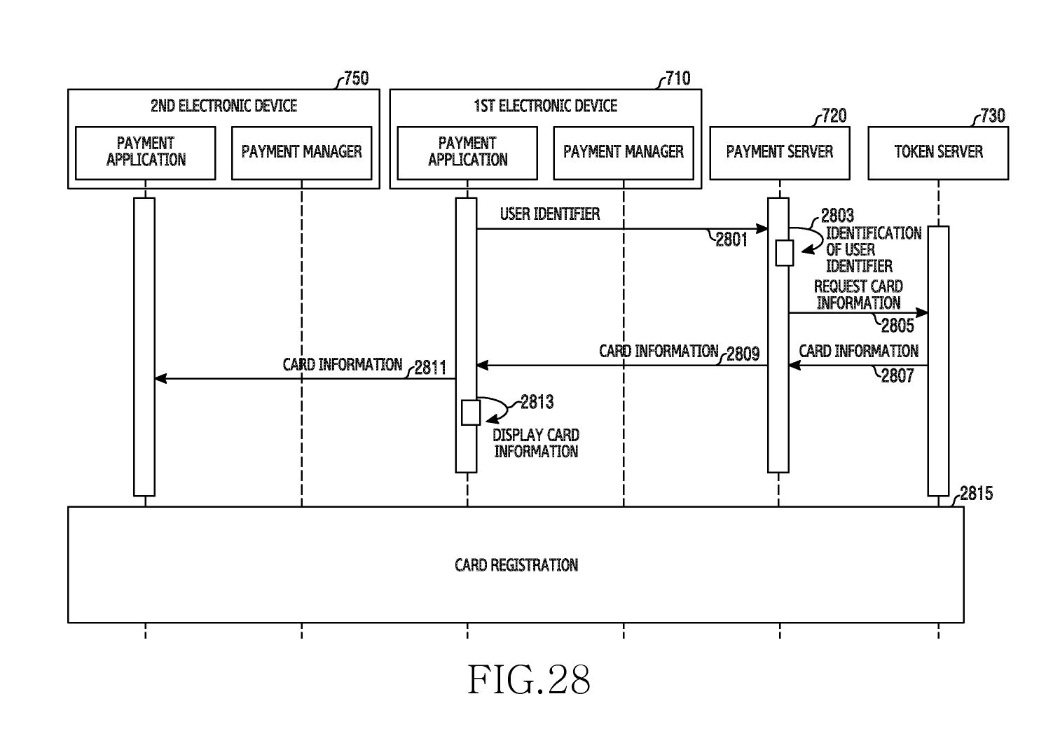

FIGS. 27 and 28 are signal flow diagrams illustrating a process of registering a card relating to a user account in a payment system according to various embodiments of the present disclosure.

Referring to FIGS. 27 and 28, the payment system may include a first electronic device (e.g., the electronic device 710), a payment server (e.g., the payment server 720), a token server (e.g., the token server 730), and a second electronic device (e.g., the electronic device 750). The first electronic device 710 may include, for example, a payment application and/or a payment manager. The second electronic device 750 may include, for example, a payment application and/or a payment manager.

According to an embodiment of the present disclosure, the user may use a plurality of electronic devices (e.g., the first electronic device 710 and second electronic devices 750). The plurality of electronic devices may be managed and used by a user through an identical user ID. The plurality of electronic devices may have been paired or connected with each other wiredly or wirelessly through BT, BLE, Wi-Fi, ZIGBEE, USB, IEE1394, and the like.

Referring to FIG. 27, operations 2701 to 2711 of FIG. 27 correspond to operations 2001 to 2011 of FIG. 20, so a detailed description thereof is omitted here, and operations thereafter will be described hereinafter.

In operation 2713, the payment application of the first electronic device 710 may request the payment server 720 to provide card information for the second electronic device 750. At this time, the first electronic device 710 may be connected through communication with or paired wiredly or wirelessly with the second electronic device 750. When storing a payment application and a payment manager, the first electronic device 710 may request card information for the second electronic device 750.

As another embodiment of the present disclosure, in operation 2713, the second electronic device 750 other than the first electronic device 710 may directly or indirectly request card information from the payment server 720.

According to an embodiment of the present disclosure, the card information request 2713 may be progressed before the card information display 2711.

In operation 2715, the payment server 720 may request the token server 730 to provide card information for the second electronic device 750.

In operation 2717, the token server 730 may transmit the card information to the payment application of the second electronic device 750. For example, the token server 730 may indirectly transmit the card information to the second electronic device 750 through the first electronic device 710. For example, the first electronic device 710 may encrypt the card information and transmit the information to the second electronic device 750.

As another example, the token server 730 may transmit the card information to the payment server 720 and the payment server 720 may transmit the received card information to the second electronic device 750. As another example, the token server 730 may directly transmit the card information to the second electronic device 750. For example, the token server 730 may directly transmit the card information through a communication network (e.g., 2G, 3G, 4G, or LTE).

In operation 2719, the first electronic device 710 may perform a card registration process, using the displayed card information.

According to an embodiment of the present disclosure, when the user selects a card to be registered, the first electronic device 710 may proceed with a card registration procedure, based on card information associated with the selected card.

Referring to FIG. 28, operations 2801 to 2809 of FIG. 28 correspond to operations 2001 to 2009 of FIG. 20, so a detailed description thereof is omitted here, and operations thereafter will be described hereinafter.

In operation 2811, the first electronic device 710 may transmit the card information received from the payment server 720 to the second electronic device 750. For example, the first electronic device 710 may transmit the card information to the payment application of the second electronic device 750. For example, the first electronic device 710 may encrypt the card information and transmit the information to the second electronic device 750. For example, the first electronic device 710 may directly transmit the card information to the second electronic device 750 through a short-range communication (e.g., BT, BLE, Wi-Fi, or ZIGBEE).

According to an embodiment of the present disclosure, the first electronic device 710 may transmit the card information according to a user's request or a request from the second electronic device 750. For example, when the card information is received, the first electronic device 710 may display a message inquiring whether to transmit the received card information to the second electronic device 750. For example, when approval of the transmission of the card information is received from the user through a message, the first electronic device 710 may directly transmit the received card information to the second electronic device 750.

As another example, when denial of the transmission of the card information is received from the user through a message, the first electronic device 710 may perform a following operation (display of card information) without transmitting the received card information to the second electronic device 750.

In operation 2813, the first electronic device 710 may display information of at least one card associated with the user account. In operation 2813, the first electronic device 710 may display information of at least one card that can be registered.

In operation 2815, the first electronic device 710 may perform a card registration process, using the displayed card information.

According to an embodiment of the present disclosure, when the user selects a card to be registered, the first electronic device 710 may proceed with a card registration procedure, based on card information associated with the selected card.

According to another embodiment of the present disclosure, operation 2811 may be performed after operation 2813. For example, the first electronic device 710 may transmit card information of at least one card to the second electronic device 750 after displaying the card information.

According to an embodiment of the present disclosure, when a plurality of electronic devices are communicating with each other, a card is not inevitably required to be registered in only one electronic device but can be simultaneously registered in a plurality of electronic devices. When card information is input through a payment application in one electronic device, user's identification or automatic determination of the payment application allows transmission of card information to a payment application of another electronic device.

Therefore, without needing to newly input the card information, the same process of card registration (e.g., token provisioning) can be progressed through the payment server 720 and the token server 730.

According to an embodiment of the present disclosure, in a token provisioning process, a plurality of electronic devices are managed by one user, are paired with each other, or connected with each other through communication. Therefore, authentication through biometric information, such as recognition of user's fingerprint, is allowed to be progressed in only one device or be partially omitted.

According to an embodiment of the present disclosure, after a card is normally issued through a token provisioning process, a server may transmit a notification for the card registration to an electronic device. For example, after normal card registration of the first electronic device 710, the token server 730 may progress card registration with the second electronic device 750 after transmitting a card registration notification to the second electronic device 750.

According to an embodiment of the present disclosure, when the wired or wireless connection between the first electronic device 710 and the second electronic device 750 is interrupted, the first electronic device 710 or the second electronic device 750 may cancel or suspend the transmission or reception of the card information and issuance of the token. When the wired or wireless connection is re-established, the transmission or reception of the card information and issuance of the token may be restarted.

According to an embodiment of the present disclosure, the second electronic device 750 may receive card information from the first electronic device 710 or the token server 730 after completion of the card issuance (or registration) of the first electronic device 710.

According to an embodiment of the present disclosure, a method of operating an electronic device includes transmitting a user identifier to a server, receiving information of at least one card associated with the user identifier from the server and displaying the received information on a display, selecting one piece of card information from the displayed information of the at least one card, and requesting the server to issue a token for payment, using at least a part of the selected card information.

According to an embodiment of the present disclosure, the method may further include starting to register a card corresponding to the selected card information.

According to an embodiment of the present disclosure, the card information may include at least one among a card issuance company, a card name, a PAN, a card expiration date, a CVV, an actual card image, and a card reference ID.

According to an embodiment of the present disclosure, the receiving of the information of at least one card associated with the user identifier and displaying of the received information on the display may include displaying the information of the at least one card through one or more card images.

According to an embodiment of the present disclosure, the displaying of the information of the at least one card through the one or more card images may include displaying the one or more card images to have at least one among a different color, a different transparency, a different size, and a different text from those of a registered card image.

According to an embodiment of the present disclosure, the transmitting of the user identifier to the server may include transmitting the user identifier to the server when there is an attempt to register the card in a state where there is no card registered in the electronic device.

According to an embodiment of the present disclosure, a method of operating a plurality of electronic devices may include, performing management or establishing a wired or wireless connection through a user identifier by the plurality of electronic devices, transmitting the user identifier to a server by a first electronic device among the plurality of electronic devices, receiving information of at least one card associated with the user identifier from the server by a second electronic device among the plurality of electronic devices, and requesting, by the second electronic device, the server to issue a token for payment, using at least a part of the received information of the at least one card.

According to an embodiment of the present disclosure, the method may further include starting to register a card corresponding to the at least a part of the received information of the at least one card.

According to an embodiment of the present disclosure, the requesting to issue the token may include omitting a user authentication process for the second electronic device.

According to an embodiment of the present disclosure, the method may include, when the wired or wireless connection is interrupted, canceling or suspending transmission or reception of the card information and issuance of the token.

According to an embodiment of the present disclosure, the receiving of the information of the at least one card from the server may be performed after card registration by the first electronic device is completed.

According to an embodiment of the present disclosure, the requesting, by the second electronic device, the server to issue the token for payment, using the at least a part of the received information of the at least one card, includes displaying the received information of the at least one card on a display, selecting one piece of card information from the displayed information of the at least one card, and requesting the server to issue the token for payment, using at least a part of the selected card information.

According to an embodiment of the present disclosure, the method may further include starting to register a card corresponding to the selected card information.

According to an embodiment of the present disclosure, a method of operating a plurality of electronic devices includes performing management or establishing a wired or wireless connection through a user identifier by the plurality of electronic devices, receiving information of at least one card from a first electronic device among the plurality of electronic devices by a second electronic device among the plurality of electronic devices, and requesting, by the second electronic device, a server to issue a token for payment, using at least a part of the received information of the at least one card.

According to an embodiment of the present disclosure, the method may further include starting to register a card corresponding to the at least a part of the received information of the at least one card.

According to an embodiment of the present disclosure, the receiving of the information of the at least one card from the first electronic device may be performed after card registration by the first electronic device is completed.

According to an embodiment of the present disclosure, an electronic device may include at least one non-transitory computer-readable recording medium having a program for executing operations recorded therein, the operations including transmitting a user identifier to a server, receiving information of at least one card associated with the user identifier from the server and displaying the received information on a display, selecting one piece of card information from the displayed information of the at least one card, and requesting the server to issue a token for payment, using at least a part of the selected card information.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific integrated circuit (ASIC) chip, a field-programmable gate arrays (FPGAs), and a programmable-logic device for performing operations which has been known or are to be developed hereinafter.

At least some of the devices (e.g., modules or functions thereof) or the method (e.g., operations) according to various embodiments may be implemented by, for example, a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of operating an electronic device, the method comprising:
transmitting a user identifier to a server;
receiving information of at least one card associated with the user identifier from the server and displaying the received information on a display;
selecting one piece of card information from the displayed information of the at least one card; and
requesting the server to issue a token for payment, using at least a part of the selected card information.

2. The method of claim 1, further comprising starting to register a card corresponding to the selected card information.

3. The method of claim 1, wherein the card information comprises at least one among a card issuance company, a card name, a primary account number (PAN), a card expiration date, a card verification value (CVV), an actual card image, and a card reference identifier (ID).

4. The method of claim 1, wherein the receiving of the information of at least one card associated with the user identifier from the server and displaying of the received information on the display comprise displaying the information of the at least one card through one or more card images.

5. The method of claim 4, wherein the displaying of the information of the at least one card through the one or more card images comprises displaying the one or more card images to have at least one among a different color, a different transparency, a different size, and a different text from those of a registered card image.

6. The method of claim 1, wherein the transmitting of the user identifier to the server comprises transmitting the user identifier to the server when there is an attempt to register a card in a state where there is no card registered in the electronic device.

7. A method of operating a plurality of electronic devices, the method comprising:
establishing a wireless connection through a user identifier by the plurality of electronic devices;
transmitting the user identifier to a server by a first electronic device among the plurality of electronic devices;
receiving information of at least one card associated with the user identifier from the server by a second electronic device among the plurality of electronic devices; and
requesting, by the second electronic device, the server to issue a token for payment, using at least a part of the received information of the at least one card.

8. The method of claim 7, further comprising starting to register a card corresponding to the at least a part of the received information of the at least one card.

9. The method of claim 7, wherein the requesting to issue the token comprises omitting a user authentication process for the second electronic device.

10. The method of claim 7, further comprising, when the wireless connection is interrupted, canceling or suspending transmission or reception of the card information and issuance of the token.

11. The method of claim 7, wherein the receiving of the information of the at least one card from the server is performed after card registration by the first electronic device is completed.

12. The method of claim 7, wherein the requesting, by the second electronic device, the server to issue the token for payment, using the at least a part of the received information of the at least one card, comprises:
displaying the received information of the at least one card on a display;
selecting one piece of card information from the displayed information of the at least one card; and
requesting the server to issue the token for payment, using at least a part of the selected card information.

13. The method of claim 12, further comprising starting to register a card corresponding to the selected card information.

14. The method of claim 7, wherein the server comprises a payment server.

15. An electronic device comprising:
a display;
a communication interface; and
a processor,
wherein the processor is configured to:
transmit a user identifier to a server through the communication interface,
receive information of at least one card associated with the user identifier from the server through the communication interface and display the received information on a display,
select one piece of card information from the displayed information of the at least one card, and
request, through the communication interface, the server to issue a token for payment, using at least a part of the selected card information.

16. The electronic device of claim 15, wherein the processor is further configured to start to register a card corresponding to the selected card information.

17. The electronic device of claim 15, wherein the card information comprises at least one among a card issuance company, a card name, a primary account number (PAN), a card expiration date, a card verification value (CVV), an actual card image, and a card reference identifier (ID).

18. The electronic device of claim 15, wherein the processor is further configured to display the information of at least one card through one or more card images.

19. The electronic device of claim 18, wherein the processor is further configured to display the one or more card images to have at least one among a different color, a different transparency, a different size, and a different text from those of a registered card image.

20. The electronic device of claim 15, wherein the processor is further configured to transmit the user identifier to the server when there is an attempt to register a card in a state where there is no card registered in the electronic device.
